(19) United States
(12) Patent Application Publication
(10) Pub. No.: US 2026/0275766 A1
(43) Pub. Date: Sep. 17, 2026

(54) ELECTRONIC ACCESS CONTROL

(71) Applicant: LockFOB, LLC

(72) Inventor: Gregory Paul Kirkjan, Palm Desert, CA (US)

(21) Appl. No.: 19/060,549

(22) Filed: Feb. 21, 2025

Related U.S. Application Data
(63) Continuation of application No. PCT/US2023/031086, filed on Aug. 24, 2023.
(60) Provisional application No. 63/373,481, filed on Aug. 25, 2022.
(60) Provisional application No. 63/507,688, filed on Jun. 12, 2023.

(51) Int. Cl. E05B 47/00; E05B 67/22

(52) U.S. Cl. CPC E05B 47/0012; E05B 67/22; E05B 2047/0017; E05B 2047/0094

(57) ABSTRACT

Embodiment of a smart lock that can be wirelessly powered and controlled using an electronic access device include: a smart lock that includes a lock clutch cylinder having a motor-controlled barrier that can control the state of the smart lock from locked to unlocked by blocking or unblocking a locking pin, a smart lock that includes a lock cylinder having a motor-controlled barrier or worm access slider that can control the state of the smart lock from access to no access by blocking or unblocking a locking pin, or a smart lock includes a motor-controlled worm access slider that can control the state of the smart lock from access to no access by blocking or unblocking a locking element. The electronic access device wirelessly powers and controls a motor to change a position of the barrier or the worm access slider and thereby change the state of the smart lock.

### PRIORITY CLAIM

This application is a continuation of International Patent Application No. PCT/US2023/031086, filed on Aug. 24, 2023, entitled “ELECTRONIC ACCESS CONTROL” which claims priority benefit of U.S. provisional patent application 63/373,481, entitled “ELECTRONIC ACCESS CONTROL SYSTEM”, filed Aug. 25, 2022, and U.S. provisional patent application 63/507,688, entitled “ELECTRONIC ACCESS CONTROL SYSTEM”, filed Jun. 12, 2023. Each of the above-noted applications is incorporated herein by reference in its entirety.

### BACKGROUND

### Field

This disclosure relates to the field of electronic access control and, more particularly, to electronic access control systems and methods that provide for improved energy efficiency, contactless wireless electronic charging, and access control.

### Description of Related Art

Lock and key sets are used in a variety of applications, such as in securing file cabinets, facilities, safes, equipment, and the like. Some traditional mechanical lock and key sets can be operated without the use of electrical energy. However, mechanical access control systems and methods can be costly and cumbersome to administer. For example, an administrator of a mechanical access control system may need to physically replace several locks and keys in a system if one or more keys cannot be accounted for.

Electronic lock and key systems have also been used for several years, and some have proven to be reliable mechanisms for access control. Electronic access control systems can include an electronic key that is configured to connect to a locking mechanism via a key interface. In at least some electronic access control systems, the electronic key can be used to operate the locking mechanism via the key interface.

Existing electronic access control systems suffer from various drawbacks. For example, electronic lock systems can be rendered inoperable when a power source is disconnected. If the electronic access control systems use batteries or an external power source, the systems can stop operating at inopportune times, making it impossible to unlock or lock doors without dismantling the electronic access control systems.

Another drawback in electronic lock systems is the use of an application (“app”) to unlock and lock using a smart phone. A user needs to “unlock” a smart phone, open an app and press an app button to “lock” or “unlock”.

### SUMMARY

In an embodiment of an electronic lock, the electronic lock is capable of operating based on power received from an electronic access apparatus, such as an electronic key. In some embodiments, the electronic access apparatus includes a housing having a processor configured to communicate with a lock microcontroller associated with an electronic lock. The apparatus can also include a memory device storing a key identifier, a rechargeable battery configured to supply energy to components of the apparatus and an electromagnetic radiation source. The electromagnetic radiation source configured to transmit a wireless digital data signal to an electromagnetic radiation receiver, and transmit a wireless power signal to the electronic lock to provide power to the electronic lock sufficient to actuate a lock mechanism within the electronic lock. The electromagnetic radiation source is configured to transmit the key identifier to the lock microcontroller via the digital data signal. The electronic access apparatus is capable of actuating the electronic lock without any electrical conductor power connection to the electronic lock, and the apparatus and/or optical light incident on the electronic lock are the only sources of electric power for the electronic lock.

An object of some aspects is to provide for easier administration of an electronic access control system. An object of some aspects is to provide an electronic access system that provides for simplified electronic lock operation by using program logic to evaluate one or more criteria, conditions, or events. Some aspects enable an access control system administrator to replace existing locks in doors, padlocks, or locks in remote locations with electronic locks that do not require a wired electrical connection in order for the lock to be powered. Some aspects enable a single electronic key to replace multiple mechanical keys.

Some aspects provide a rechargeable electronic key for use with an electronic lock. The electronic key includes a memory device; a private key identifier for the electronic key stored in the memory device, the private key identifier being accessible to the electronic lock but not readily accessible to a user of the electronic key; a key controller configured to electrically connect to a lock controller associated with the electronic lock; a power management circuit configured to electrically connect to a power source; and a rechargeable battery. The power management circuit is configured to supply energy from the rechargeable battery to other components of the electronic key, to supply energy from the rechargeable battery to the electronic lock when the electronic key is engaged with the electronic lock, and to recharge the rechargeable battery when the power management circuit is connected to the power source.

In another aspect, an electronic access control system is provided. The electronic access control system includes an electronic lock and an electronic key. The electronic lock includes a bolt; a lock memory; key access information stored in the lock memory; a key connector; and a piezoelectric latch configured to secure the bolt in a fixed position when the piezoelectric latch is in a first state and to allow the bolt to move between a locked position and an unlocked position when the piezoelectric latch is in a second state. The electronic key includes a key memory; a private key identifier stored in the key memory, the private key identifier being accessible to the electronic lock but not readily accessible to a user of the electronic access control system; a lock connector disposed on the key housing, the lock connector being configured to electrically connect to the key connector of the electronic lock; and a battery. The battery is configured to provide energy to actuate the piezoelectric latch between the first state and the second state when the lock connector of the electronic key is inserted into the key connector of the electronic lock, if it is determined that the private key identifier, or the public and private key identifiers, is present in the key access information stored in the lock memory.

In some other aspects, an electronic access control system having switchable power states is provided. The electronic access control system includes an electronic key. The electronic key includes a key housing; a first connector disposed on the key housing, the connector having a key power supply pin and a key ground pin, and the first connector being configured to electrically connect to a digital bus associated with the electronic lock; a microcontroller; a battery; and a switching device connected between the battery and the power supply pin of the first connector and configured to allow energy to flow from the battery to the power supply pin of the first connector when the electric potential on the first connector side of switching device is less than the electric potential on the battery side of the switching device. In some embodiments, the electronic access control system includes an electronic lock. The electronic lock can include a lock chassis; a lock controller; and a second connector having a lock ground pin. The lock ground pin is electrically connected to the lock chassis, and the second connector is configured to electrically connect to the first connector. The key ground pin is isolated from ground when the first connector is not connected to the second connector. The key ground pin connects to the lock chassis, and the battery of the electronic key supplies electrical energy to the electronic access control system, when the first connector is connected to the second connector.

In yet other aspects, an electronic access control system is provided. The electronic access control system includes an electronic lock and an electronic key. The electronic lock includes a lock chassis; a lock controller with nonvolatile memory; and a lock USB connector having a lock ground pin and a lock power supply pin. The lock ground pin is connected to the lock chassis. The electronic key includes a key controller; a key memory; a public key identifier stored in the key memory, the public key identifier being readily accessible to a user of the electronic access control system; a private key identifier stored in the key memory, the private key identifier being accessible to the electronic lock but not readily accessible to a user of the electronic access control system; a key USB connector disposed on the key housing, the key USB connector having a key power supply pin and a key ground pin, and the key USB connector being configured to electrically connect to the lock USB connector of the electronic lock; and a circuit comprising a battery and a diode connected between the battery and the key power supply pin. The key ground pin is isolated from the key USB connector such that, when the key USB connector is inserted into the lock USB connector, the key ground pin connects to the lock USB chassis and the battery of the electronic key supplies energy to the electronic access control system.

In some other aspects, the lock connection interface includes one or more rails and one or more notches. The one or more rails allow the lock connection interface to be inserted into an opening of the electronic lock. The one or more notches prevent decoupling of the lock connection interface from the electronic lock. The lock connection interface can be inserted into the opening of the electronic lock when in a first orientation, and the lock connection interface is prevented from decoupling from the electronic lock when in a second orientation.

Further aspects provide an electronic lock that generates electrical energy for the electronic lock and an electronic key. The electronic lock includes a lock memory; key access information stored in the lock memory; a key connector having a power supply pin; a generator configured to be driven by movement of the electronic key when the electronic key is used in the key connector; a lock circuit; and a latch electrically connected to the lock circuit, the latch being configured to actuate between a locked state and an unlocked state when an identifier associated with the electronic key is present in the key access information stored in the lock memory. The generator is configured to at least partially power the lock circuit and the electronic key.

In further aspects, an electronic key for use with an electronic lock and for storing digital files is provided. The electronic key includes a key memory; a private key identifier for the electronic key, the private key identifier being accessible to the electronic lock but not readily accessible to the user of the electronic key; a digital bus connector, the digital bus connector being configured to electrically connect to a digital bus associated with the electronic lock, and the digital bus connector being configured to electrically connect to a digital bus associated with a computer system having a microprocessor, a main memory, and an operating system; and a microcontroller configured to allow the computer system to access the key memory as a mass storage device.

Additional aspects provide an electronic key for use with an electronic lock. The electronic key includes a socket for a solid state non-volatile memory device; a microcontroller having a non-volatile memory; a public key identifier for the electronic key stored in the non-volatile memory of the microcontroller, the public key identifier being readily accessible to a user of the electronic key; a private key identifier for the electronic key stored in the non-volatile memory of the microcontroller, the private key identifier being accessible to the electronic lock but not readily accessible to the user of the electronic key; and a digital bus connector disposed on the key housing, the digital bus connector being configured to electrically connect to a digital bus associated with the electronic lock.

In some aspects, an electronic access control system with a streamlined user interface is provided. The electronic access control system includes an electronic lock, a first electronic key, and a second electronic key. The electronic lock includes a lock memory configured to store key access information; a lock identifier; a lock controller comprising program code for comparing a key identifier to the key access information stored in the lock memory; and a lock bus connector. The first electronic key includes a first memory device; a lock configuration file comprising key access information for configuring the electronic lock; a first private key identifier for the first electronic key, the first private key identifier being accessible to the lock controller but not readily accessible to a user of the first electronic key; a first key controller comprising program code for providing key access information to the electronic lock when first predetermined criteria are met, program code for accessing the electronic lock when second predetermined criteria are met, and program code for erasing the electronic lock when third predetermined criteria are met; and a first digital bus connector configured to electrically connect to the lock bus connector. The second electronic key includes a second memory device; a second private key identifier for the second electronic key, the second private key identifier being accessible to the lock controller but not readily accessible to a user of the second electronic key; a second key controller comprising program code for accessing the electronic lock without user input when fourth predetermined criteria are met; and a second digital bus connector configured to electrically connect to the lock bus connector.

Additional aspects provide an electronic key for use with an electronic lock. The electronic key includes a gripping portion including a housing. The housing includes a processor and an electronic storage unit. The electronic key includes a data transfer portion connected to the gripping portion. The data transfer portion includes an electronic data communications interface, one or more rails, and one or more notches formed and positioned between a pair of rails of the one or more rails. The data transfer portion moves between a first orientation and a second orientation. When the data transfer portion is in the first configuration, the one or more rails allow the data transfer portion to be inserted into the opening of the electronic lock. When the data transfer portion is in the second configuration, the one or more notches prevent decoupling of the data transfer portion from the electronic lock.

For purposes of summarizing the invention, certain aspects, advantages and novel features have been described herein. Of course, it is to be understood that not necessarily all such aspects, advantages or features will be embodied in any particular embodiment. Moreover, it is to be understood that not necessarily all such advantages or benefits may be achieved in accordance with any particular embodiment of the invention. Thus, for example, those skilled in the art will recognize that the invention may be embodied or carried out in a manner that achieves one advantage or group of advantages as taught herein without necessarily achieving other advantages or benefits as may be taught or suggested herein.

An object of some embodiments of the invention is an electronic lock that is capable of operating based on power received from an electronic access apparatus, such as an electronic key. In some embodiments, the electronic access apparatus includes a housing having a processor configured to communicate with a lock microcontroller associated with an electronic lock. The apparatus can also include a memory device storing a key identifier, a rechargeable battery configured to supply energy to components of the apparatus and an electromagnetic radiation source. The electromagnetic radiation source configured to transmit a wireless digital data signal to an electromagnetic radiation receiver, and transmit a wireless power signal to the electronic lock to provide power to the electronic lock sufficient to actuate a lock mechanism within the electronic lock. The electromagnetic radiation source is configured to transmit the key identifier to the lock microcontroller via the digital data signal. The electronic access apparatus is capable of actuating the electronic lock without any electrical conductor power connection to the electronic lock, and the apparatus and/or optical light incident on the electronic lock are the only sources of electric power for the electronic lock.

In some embodiments, the electromagnetic radiation source is an optical light source. The electromagnetic radiation source can be configured to transmit power via the optical light source. The electromagnetic radiation source can be configured to transmit the digital data signal via the optical light source. The electromagnetic radiation source configured to transmit the wireless digital data signal and the wireless power signal can be the same source.

In some embodiments the key identifier further includes one or more private identifiers that are not readily accessible to a user of the apparatus, and one or more public identifiers that are readily accessible to a user of the apparatus. The electronic access apparatus can be configured to transmit at least one private identifier and at least one public identifier to the electronic lock.

In some embodiments, the housing can include a display, the display having a user interface having a visual indication of a status of the electronic lock, and one or more control elements configured to control the operation of the electronic lock. The processor can be configured to transmit a lock instruction to the electronic lock based on an input received from a user. The electronic access apparatus can be a cellular phone, a dedicated electronic key, or other electronic apparatus. In some embodiments, the apparatus does not have a mechanical configuration that is configured to match a mating mechanical configuration of the electronic lock.

In an embodiment of an electronic lock, the electronic lock includes a lock housing and a lock mechanism electrically connected to the lock controller. The lock mechanism can be configured to actuate between a locked state and an unlocked state. The lock also includes an electromagnetic radiation receiver configured to receive a wireless digital data signal from the electronic apparatus and receive a wireless power signal from the electronic apparatus. The lock can also include a memory device storing key access information, a lock microcontroller configured to control operation of the lock mechanism based on the digital data signal from the electronic apparatus, and a power management module configured to provide power to actuate the lock mechanism based on input received from the lock microcontroller and an electrical energy level contained in an electrical circuit of the electronic lock. The lock mechanism is capable of actuating between the locked state and the unlocked state without any electrical conductor power connection to the electronic lock, the electromagnetic radiation provided by an electronic apparatus and/or optical light incident on the electromagnetic radiation receiver are the only sources of electric power for the electronic lock.

In some embodiments, the digital data signal comprises a key identifier, and lock microcontroller can be configured to determine whether the key identifier matches the key access information stored in the memory device. The lock mechanism can be capable of actuating between the locked state and the unlocked state with less than or equal to about 10 milliwatts of electric power, and the electronic apparatus can be greater than 0.5 centimeters from the electronic lock when providing the electric power. In some embodiments the electronic lock does not have a mechanical configuration that is configured to match a mating mechanical configuration of the electronic apparatus.

In some embodiments, the power management module can be configured to actuate the lock after the electrical energy level of the electronic lock satisfies an electrical energy level threshold. The power management module can be configured to increase the voltage to actuate the lock. The power management module can include a voltage conversion circuit that is configured to increase a voltage value to operate within the minimum and maximum parameters of the lock mechanism that allow the lock mechanism to actuate. For example, in one embodiment, the voltage conversion circuit is configured to increase a voltage value that is not greater than 2.7 volts to a voltage value between 3.6 volts and 6.8 volts.

In some embodiments, the electromagnetic radiation receiver can have various configurations. For example, the electromagnetic radiation receiver can include a photovoltaic cell, configured to convert electromagnetic radiation to energy to power the lock microcontroller. The electromagnetic radiation receiver can include an electromagnetic radiation sensor, and a signal processing circuit, wherein the signal processing circuit is configured to process a digital data signal received from the electronic apparatus. The electromagnetic radiation can be optical light. The electromagnetic radiation receiver can include an antenna configured to receive radio frequency signals. The antenna can be configured to receive the digital data signal and the power signal from the electronic apparatus. The antenna can be configured to receive the power signal from the electronic apparatus via contactless inductive coupling.

In some embodiments, the lock mechanism can be configured to toggle between a locked state and an unlocked state based on a lock instruction received from the electronic apparatus. The lock mechanism can be configured to actuate from the locked state to the unlocked state for a defined time period before returning to the locked state, such as a defined time period of less than or equal to about five seconds. In some embodiments, the lock memory device and the lock microcontroller are contained on a single integrated circuit.

Some embodiments provide a method of controlling access to an electronic lock having no independent power supply. The method includes receiving, by an electromagnetic radiation receiver, electromagnetic radiation from an electronic apparatus including a power signal configured to provide power to the electronic lock. The method also includes booting a lock microcontroller after the electrical energy level satisfies a microcontroller electrical energy level threshold and receiving, by the electromagnetic radiation receiver, electromagnetic radiation comprising a digital data signal from the electronic apparatus including a key identifier. The method also includes determining, by the lock controller, whether the key identifier matches key access information stored in memory in the electronic lock and storing power received from the electronic apparatus in an electric circuit, such a reservoir capacitor, in the electronic lock. If the key identifier matches the key access information, actuating a lock mechanism when the stored power reaches an energy level threshold. The lock mechanism can be configured to actuate between a locked state and an unlocked state.

In some embodiments, the method also includes shutting down the lock microcontroller if the key identifier does not match the key access information. The electronic apparatus does not need to mechanically or physically make contact to the electronic lock to transfer the digital data signal and the power signal.

In an embodiment of an electronic lock capable of being locked and unlocked with a handheld electronic apparatus, the electronic lock can include a lock mechanism electrically connected to a lock microcontroller. The lock mechanism can be configured to actuate between a locked state and an unlocked state. The electronic lock can also include an electromagnetic radiation receiver configured to receive an electromagnetic wireless digital data signal from the electronic apparatus and receive an electromagnetic wireless power signal from the electronic apparatus. The receiver can be configured to output electric power at a first voltage. The lock microcontroller can be configured to control operation of the lock mechanism based on the digital data signal from the electronic apparatus. The electronic lock can also include at least one capacitor electrically connected to receive electric power from the electromagnetic radiation receiver. The electronic lock can also include a power management module can be configured to receive electric power from the at least one capacitor at the first voltage and output the electric power at a second voltage and supply the electric power to the lock mechanism over the actuation time period to actuate the lock mechanism based on input received from the lock microcontroller. The second voltage can vary over an actuation time period and the lock mechanism can actuate between the locked state and the unlocked state using only the electric power supplied by the wireless power signal.

In another embodiment of an electronic lock capable of being locked and unlocked with a handheld electronic apparatus, the electronic lock includes a lock mechanism electrically connected to a lock microcontroller. The lock mechanism can be configured to actuate between a locked state and an unlocked state. The electronic lock can also include an electromagnetic radiation receiver configured to receive an electromagnetic wireless digital data signal from the electronic apparatus, and receive an electromagnetic wireless power signal from the electronic apparatus. The lock microcontroller can be configured to control operation of the lock mechanism based on the digital data signal from the electronic apparatus. The electronic lock can also include at least one capacitor electrically connected to receive electric power from the electromagnetic radiation receiver. The electronic lock can also include a power management module configured to provide power to actuate the lock mechanism based on input received from the lock microcontroller and an electrical energy level of the capacitor. The voltage of the electric power supplied to the lock mechanism can vary during a period of time while the lock mechanism is actuated. The at least one capacitor, the lock microcontroller, the power management module, and the lock mechanism can be configured to use a combined total of electric energy less than or equal to 100 millijoules in order to actuate the lock mechanism between the locked state and the unlocked state.

In an embodiment of a method of locking or unlocking an electronic lock using a handheld electronic apparatus, the method including receiving, by an electromagnetic radiation receiver, electromagnetic radiation from the handheld electronic apparatus. The the electromagnetic radiation includes a power signal configured to provide electric power to the electronic lock. The method can also include booting a lock microcontroller after an electrical energy level satisfies an electrical energy level threshold, receiving, by the electromagnetic radiation receiver, electromagnetic radiation comprising a digital data signal from the electronic apparatus, and charging at least one capacitor in the electronic lock during a first period of time using the electric energy received from the electronic apparatus. The at least one capacitor can receive the electric energy from the electromagnetic radiation receiver at a first voltage. The method can also include receiving, by a power management module, electric power from the at least one capacitor based on a lock actuation instruction to actuate the lock mechanism received from the lock microcontroller. The power management module can receive the electric energy from the at least one capacitor at a first voltage. The method can also include supplying, by a power management module, the electric power to the lock mechanism at a second voltage to actuate the lock mechanism between a locked state and an unlocked state. The second voltage can be higher that first voltage for a second period of time, wherein the second voltage varies over the second period of time; and wherein the lock mechanism is configured to actuate using electric power received only from the power signal during transmission of the power signal.

In one aspect, a smart lock includes a lock clutch cylinder configured to be wirelessly controlled and wirelessly powered by an electronic access device. The lock clutch cylinder includes: a clutch rotatably coupled to a first knob, a pin movably coupled to the first knob and configured to translate a rotational motion of the first knob in a first rotational direction to a rotational motion of the clutch, when maintained at an unlock position, a barrier configured to move between a first position and a second position with respect to the pin and maintain the pin at the unlock position when moved to the second position. The smart lock further includes: an electric motor disposed inside the clutch and configured to control a position of the barrier with respect to the pin; and an electronic control circuit configured to receive an unlocking wireless signal from electronic access device and in response to receiving the unlocking wireless signal, activate the electric motor to move the barrier from the first position to the second position. The electronic control circuit in configured to be wirelessly powered by an electronic access device. The rotational motion of the clutch in the first rotational direction is decoupled from the rotational motion of the first knob (the external knob), when the barrier is in the first position. In some cases, the second knob 2804 (the internal knob) can rotate the clutch between independent of a position of the barrier (e.g., between a locked position and an unlocked position).

In another aspect, a padlock is configured to be wirelessly powered and wirelessly controlled by an electronic access device. The padlock includes: a housing, a shackle movably coupled to the housing, the shackle having a first end and a second end, a latching element movably coupled to the housing, the latching element configured to be latched to the shackle to prevent an outward movement of the shackle with respect to the housing, when maintained at a lock position, a barrier configured to move between a first position and a second position with respect to the latching element and maintain the latching element at the lock position when moved to the second position. The padlock further includes a motor configured to control a position of the barrier and an electronic control circuit configured to receive an unlocking wireless signal and in response to receiving the unlocking wireless signal, activate the motor to move the barrier from the second position to the first position. The electronic control circuit is configured to be wirelessly powered by the electronic access device. The inward movement of the shackle toward the housing, latches the shackle to the latching element and moves the barrier from the first position to the second position.

In another aspect a method of changing a locking state of a smart lock from an access state to a no access state. The smart lock includes a motor, a barrier rotationally controlled by the motor, a locking pin configured to prevent access when maintained at a no access position, and a position sensor configured detect a position of the barrier with respect to the locking pin. The method is performed by a processor of the smart lock and includes: receiving a wireless locking signal from an electronic access device, in response to receiving the wireless locking signal, activating the position sensor to determine a first position of the barrier and in response to determining that at the first position the barrier is not blocking the locking pin, rotating, using the motor, the barrier toward the locking pin by an initial rotation step. The method further includes activating the position sensor to determine a second position of the barrier after the initial rotation step, in response to determining that at the second position the barrier is not blocking the locking pin, rotating, using the motor, the barrier toward the locking pin by at least one small rotation step, activating the position sensor to determine a third position of the barrier, and in response to determining that at the third position the barrier blocks the locking pin, turning on an LED or transmitting a lock indicator wireless signal to the electronic access device.

In another aspect, a method of changing a locking state of a smart lock from an access state to a no access state. The smart lock includes a motor, a worm access slider transitionally controlled by the motor, the worm access slider configured to prevent access when maintained at a no access position, and a position sensor configured detect a position of the worm access slider with respect to a locking element. The method is performed by a processor of the smart lock and includes: receiving a wireless locking signal from an electronic access device, in response to receiving the wireless locking signal, activating the position sensor to determine a first position of the worm access slider, and in response to determining that at the first position the worm access slider is not blocking the locking element: moving, using the motor, worm access slider toward the locking element by an initial translation step. The method further includes: activating the position sensor to determine a second position of worm access slider after the initial translation step, in response to determining that at the second position the worm access slider is not blocking the locking element, moving, using the motor, the worm access slider toward the locking element by at least one small translation step, activating the position sensor to determine a third position of the worm access slider; and in response to determining that at the third position the worm access slider blocks the locking element, turning on an LED or transmitting a lock indicator wireless signal to the electronic access device.

In another aspect, a smart lock includes a locking cylinder configured to be wirelessly controlled and wirelessly powered by an electronic access device. The locking cylinder includes a pin movably coupled to the locking cylinder and configured to prevent rotation of the locking cylinder with respect to a frame when maintained at a no access position, a barrier rotatably coupled to the locking cylinder, the barrier configured to maintain a, when moved to a second position, and an electric motor placed inside the locking cylinder and configured to move the barrier between a first position and the second position to change a locking state of the locking cylinder between a no access state and an access state, respectively. The smart lock further includes: an electronic control circuit configured to receive a wireless control signal from an electronic access device and activate the electric motor in response to receiving the wireless control signal to change the locking state of the locking cylinder where the electronic control circuit in configured to be wirelessly powered by the electronic access device.

In another aspect, a smart lock includes a locking cylinder configured to be wirelessly controlled and wirelessly powered by an electronic access device. The locking cylinder includes: a worm access slider configured to prevent motion of a locking element, when moved to a no access position; an electric motor placed inside the locking cylinder and configured to move the worm access slider between a no access position and an access position to change a locking state of the locking cylinder between a no access state and an access state, respectively. The smart lock further includes, an electronic control circuit configured to receive a wireless control signal from an electronic access device and activate the electric motor in response to receiving the wireless control signal to change the locking state of the locking cylinder, where the electronic control circuit in configured to be wirelessly powered by an electronic access device.

For purposes of summarizing the invention, certain aspects, advantages and novel features have been described herein. Of course, it is to be understood that not necessarily all such aspects, advantages or features will be embodied in any particular embodiment. Moreover, it is to be understood that not necessarily all such advantages or benefits may be achieved in accordance with any particular embodiment of the invention. Thus, for example, those skilled in the art will recognize that the invention may be embodied or carried out in a manner that achieves one advantage or group of advantages as taught herein without necessarily achieving other advantages or benefits as may be taught or suggested herein.

### BRIEF DESCRIPTION OF THE DRAWINGS

A general architecture that implements the various features will now be described with reference to the drawings. The drawings and the associated descriptions are provided to illustrate embodiments of the invention and not to limit the scope of the invention. Throughout the drawings, reference numbers are reused to indicate correspondence between referenced elements.

FIG. 1 illustrates an example embodiment of an access control system subdivided into domains.

FIG. 2 is a flowchart of an embodiment of a method for configuring and operating an access control system.

FIG. 3A is a detailed block diagram of an embodiment of an electronic lock connected to an electronic key that includes a rechargeable battery.

FIG. 3B is a detailed block diagram of an embodiment of a computer connected to an electronic key that includes a rechargeable battery.

FIG. 4A is a block diagram of an embodiment of an electronic lock connected to an electronic key that uses a connector as a switch.

FIG. 4B is a block diagram of an embodiment of a computer connected to an electronic key that uses a connector as a switch.

FIG. 5 illustrates an embodiment of an electronic lock and key system configured to convert translational mechanical energy to electrical energy.

FIG. 6 illustrates another embodiment of an electronic lock and key system configured to convert rotational mechanical energy to electrical energy.

FIG. 7 is a block diagram of an embodiment of an electronic key configured to operate as a storage device for digital files.

FIG. 8 is a flowchart of an embodiment of a method of operation of an electronic access control system.

FIG. 9 is a flowchart of an embodiment of a method for configuring key access information in an access control system.

FIG. 10 illustrates an embodiment of an interface for configuring key access information.

FIG. 11 is a flowchart of an embodiment of another method of operation of an electronic access control system.

FIG. 12 is a flowchart of an embodiment of a method of transmitting information between a lock and a key of an electronic access control system.

FIGS. 13A and 13B illustrate an embodiment of an electronic access control system.

FIG. 14A is a flowchart of an embodiment of a method for granting access to an electronic lock.

FIG. 14B is a flow chart of an embodiment of a method for removing access to an electronic lock.

FIG. 15 illustrates example embodiments of graphical interfaces for editing a lock file and a master domain file.

FIGS. 16A and 16B illustrate perspective views of an embodiment of an electronic key.

FIG. 17 illustrates an example embodiment of an operating environment for an access control system.

FIG. 18 illustrates an example embodiment of an operating environment for an access control system in a distributed networking environment.

FIG. 19 is a detailed block diagram of an embodiment of an electronic lock and an electronic access apparatus.

FIG. 20 is a detailed block diagram of another embodiment of an electronic lock and an electronic access apparatus.

FIG. 21 is a detailed block diagram of yet another embodiment of an electronic lock and an electronic access apparatus.

FIG. 22 is a block diagram of an embodiment of a computer connected to an electronic access apparatus.

FIGS. 23A-23B illustrate an embodiment of an electronic lock and door handle.

FIG. 24A illustrates another embodiment of an electronic lock and door handle.

FIG. 24B illustrates an embodiment of an electronic padlock.

FIG. 25A is a flowchart of an embodiment of an electronic lock power management routine.

FIG. 25B is a flowchart of an embodiment of a lock access routine for an electronic access apparatus.

FIG. 26A illustrates an embodiment of plot illustrating voltage over time during an actuation of a lock mechanism.

FIG. 26B illustrates an embodiment of an electronic lock power management routine.

FIG. 27 illustrates an embodiment of an electronic lock that that includes a lock handle configured to actuate a lock mechanism using mechanical energy.

FIG. 28 illustrates a smart door lock assembly comprising a near field communication (NFC) lock clutch cylinder (also referred to as lock cylinder) configured to be wirelessly powered and controlled by an electronic access device

FIG. 29A illustrates an external knob and a lateral cross-section of a lock clutch cylinder attached to the external knob. The insets show the lock clutch cylinder and the spring loaded pin of the lock clutch cylinder.

FIG. 29B illustrates a longitudinal cross-section of a lock clutch cylinder. The inset shows the barrier of the lock clutch cylinder.

FIG. 29C shows a lateral cross-sectional view of the lock clutch cylinder in an unlocked state.

FIG. 29D shows a lateral cross-sectional view of the lock clutch cylinder in a locked state.

FIGS. 30A-30C illustrate a cross-sectional view of the lock clutch cylinder depicting selected rotational positions of the clutch with respect to the external knob when the internal knob is used to move the clutch from an unlocked position to a locked position. The cross-section is viewed from inside the room that is protected by the smart door lock assembly.

FIG. 30D illustrates the smart door lock assembly after the clutch has reached the locked position (corresponding to FIG. 30C).

FIG. 30E shows the rotational position of the clutch in the locked position when viewed from outside the room that is protected by the smart door lock assembly.

FIGS. 31A-31C illustrate a cross-sectional view of the lock clutch cylinder depicting selected rotational positions of the clutch with respect to the external knob when the internal knob is used to move the clutch from a locked position to an unlocked position. The cross-sectional is viewed from inside the room that is protected by the smart door lock assembly.

FIG. 31D illustrates the smart door lock assembly after the clutch has reached the unlocked position (corresponding to FIG. 31C).

FIG. 31E shows the rotational position of the clutch in the locked position when viewed from outside the room that is protected by the smart door lock assembly.

FIGS. 32A-32E illustrate a cross-sectional view of the lock clutch cylinder depicting selected rotational positions of the clutch and the pin with respect to the external knob, when the lock clutch cylinder is in the locked state (the barrier does not block the locking pin) and the external knob is used to move the clutch from the unlocked position to the locked position. The cross-section is viewed from inside the room that is protected by the smart door lock assembly.

FIGS. 33A-33F illustrate a cross-sectional view of the lock clutch cylinder depicting selected rotational positions of the clutch and the locking pin with respect to the external knob 2801, when the lock clutch cylinder is in the unlocked state (the barrier blocks the locking pin) and the external knob is used to move the clutch from the locked position to the unlocked position. The cross-section is viewed from inside the room that is protected by the smart door lock assembly.

FIGS. 34A-34F illustrate a cross-sectional view of the lock clutch cylinder depicting selected rotational positions of the clutch and the locking pin with respect to the external knob, when the lock clutch cylinder is in the locked state (the barrier does not block the locking pin) and the external knob is rotated in the counterclockwise direction but cannot move the clutch from the locked position to the unlocked position. The cross-section is viewed from inside the room that is protected by the smart door lock assembly.

FIG. 35A illustrates an example smart padlock that can be wirelessly powered and controlled.

FIG. 35B illustrates the locking system of the smart padlock shown in FIG. 35A.

FIGS. 36A-36F show cross-sectional views of the locking system of the smart padlock shown in FIG. 35A when the state of the locking system changes from a locked state (FIG. 36A) to an unlocked state (FIG. 36B-36E) and back to the locked state (FIG. 36F).

FIG. 37A illustrates another example smart padlock that can be wirelessly powered and controlled.

FIGS. 37B-37C illustrate the cross-sections and components of the locking system of the smart padlock shown in FIG. 37A.

FIGS. 38A-38C illustrate cross-sectional views of the locking system of the smart padlock during an unlocking process.

FIGS. 39A-39F illustrate cross-sectional views of the smart padlock shown in FIG. 37A during a locking process where, starting from a fully unlocked position (FIG. 38C), a user locks the smart padlock.

FIG. 40A illustrates an example smart lock that includes a wirelessly powered and controlled FOB cylinder comprising a position sensor.

FIG. 40B illustrates a closeup view of the backplate and the components of the FOB cylinder that are attached to it.

FIG. 41 illustrates an example compact FOB cylinder that is configured to be wirelessly powered and controlled using an electronic access device.

FIG. 42A illustrates another example of a compact FOB cylinder comprising a position sensor.

FIG. 42B illustrates a cross-sectional view of the FOB cylinder shown in FIG. 42A when a portion of the barrier moves through the position sensor.

FIGS. 43A-43C illustrate cross-sectional views of the FOB cylinder shown in FIG. 42 (viewed from the left side opposite to the optical position sensor) when the FOB cylinder is unlocked (part A and B) and when the FOB cylinder is locked (part C).

FIG. 43D illustrates a cross-sectional view of the FOB cylinder (viewed from the right side opposite to the motor) when the FOB cylinder is unlocked.

FIGS. 44A-44B illustrate a cross-sectional view of an example FOB cylinder having two magnets configured to rotate the barrier in sync with the FOB cylinder to maintain a relative rotational position of the barrier with respect to the cylinder body, when the FOB cylinder is rotated from a locked state (part A) to an unlocked state (part B).

FIGS. 45A-45B illustrate side cross-section views of a FOB cylinder configured to control the movement of the pin using a worm access slider, when the FOB cylinder is in an unlocked state (part A) and in a locked state (part B).

FIGS. 46A-46B illustrate side cross-sectional views of a FOB Worm Lock configured to control the movement of locking element of a lock.

FIG. 47A is a flow diagram illustrating an example process that may be used to change the state of a FOB locks (e.g., the FOB locks shown in FIGS. 40A, 41, 42A, and 45A) or the FOB worm lock shown in FIG. 46A.

FIG. 47B is an example temporal variation of the voltage provided to the position sensor and the motor during a locking process where the locking state of a FOB lock (e.g., the FOB locks shown in FIGS. 40A, 41, 42A, and 45A) or the FOB worm lock shown in FIG. 46A, is changed from access to no access.

FIG. 47C is an example temporal variation of the voltage provided to the position sensor and the motor during a locking process where the locking state of a FOB lock (e.g., the FOB locks shown in FIGS. 40A, 41, 42A, and 45A) or the FOB worm lock shown in FIG. 46A, is changed from no access to access.

### DETAILED DESCRIPTION

Systems and methods that represent various embodiments and example applications of the present disclosure will now be described with reference to the drawings.

For purposes of illustration, some embodiments are described in the context of access control systems and methods incorporating a wireless communication connection. The wireless connection can be configured to comply with one or more wireless standards, such as, for example, RFID, Near Field Communication (NFC), Bluetooth, Bluetooth Smart, IEEE 802.11 technical standards (“WiFi”), and so forth. In some embodiments, a Universal Serial Bus (USB) connection is used. The USB connection can be configured to comply with one or more USB specifications created by the USB Implementers Forum, such as, for example, USB 1.0, USB 1.1, USB 2.0, USB 3.0, USB On-The-Go, Inter-Chip USB, MicroUSB, USB Battery Charging Specification, and so forth. The embodiments disclosed herein are not limited by the type of connection employed by the systems and methods. At least some of the systems and methods may be used with other connections, such as, for example, an IEEE 1394 interface, a serial bus interface, a parallel bus interface, a magnetic interface, a radio frequency interface, a wireless interface, a custom interface, and so forth. The system may include a variety of uses, including but not limited to access control for buildings, equipment, file cabinets, safes, doors, suitcases, padlocks, etc. It is also recognized that in other embodiments, the systems and methods may be implemented as a single module and/or implemented in conjunction with a variety of other modules. The embodiments described herein are set forth in order to illustrate, and not to limit, the scope of the invention.

The access control system as contemplated by at least some embodiments generally includes an electronic lock and an electronic access apparatus. The electronic access apparatus can also be referred to as an electronic key or a smart phone. The electronic lock and the electronic access apparatus are configured to communicate with each other via a wireless interface without a mechanical interface. The electronic lock can include, for example, an electronic lock mechanism, such as a latch or motor, an electronic access interface or connector, a controller (e.g., a microcontroller), program modules, nonvolatile memory including lock configuration information, key access information, an access log, and other information stored thereon, other mechanical and/or electrical components. In some embodiments, the electronic lock mechanism can include, for example, a piezoelectric latch or another type of energy-efficient latch, motor, or actuator. The wireless interface can include, for example, antennas, sensors, photovoltaic cells, radio frequency identification (RFID) and near field communication (NFC) interface components, signal processing components (e.g., a signal processing circuit), and/or other wireless interface components. Functional components can be integrated into a single physical component. For example, the memory of the lock may be embedded on the same integrated circuit as the controller.

In some embodiments, the electronic access apparatus can include, for example, a wireless transceiver, an electromagnetic signal source (e.g., a light source or radio frequency generator), a key housing, a microcontroller, program modules, a lock interface or connector, a power source, a memory card slot, a memory device having one or more key identifiers, lock configuration files containing key access information for a lock, mechanical and/or other electrical components. Some embodiments of the electronic access apparatus can also include a battery, a battery charger, a digital bus connector, circuitry to detect when the electronic access apparatus is used with another device, memory integrated with the microcontroller, a storage device controller, a file system, operation system, and/or program logic for determining what actions to perform in response to conditions or events. In some embodiments the electronic access apparatus can be a general purpose computing device, such as, for example, a cellular phone, a smart phone, a tablet computer, a laptop, or other computing device. In some embodiments, the electronic access apparatus can be a dedicated electronic access device, where the primary purpose of the device is to provide access to one or more electronic access systems.

In some embodiments, the access control system includes an application program for managing access between electronic locks and electronic keys. The access control system can operate on one or more computing systems. In some embodiments, the access control system can be configured to operate in a distributed network environment. The access control system can be used to create domains and/or lock configuration files. The files can be stored on electronic keys, and or other computing devices. In some embodiments, the access control system can manage a plurality of domains so that key access information for groups of electronic locks and keys to be managed more efficiently. For example, a domain can include access control information for a plurality of locks and keys, while an individual lock configuration file may contain access control information for a single lock in the domain.

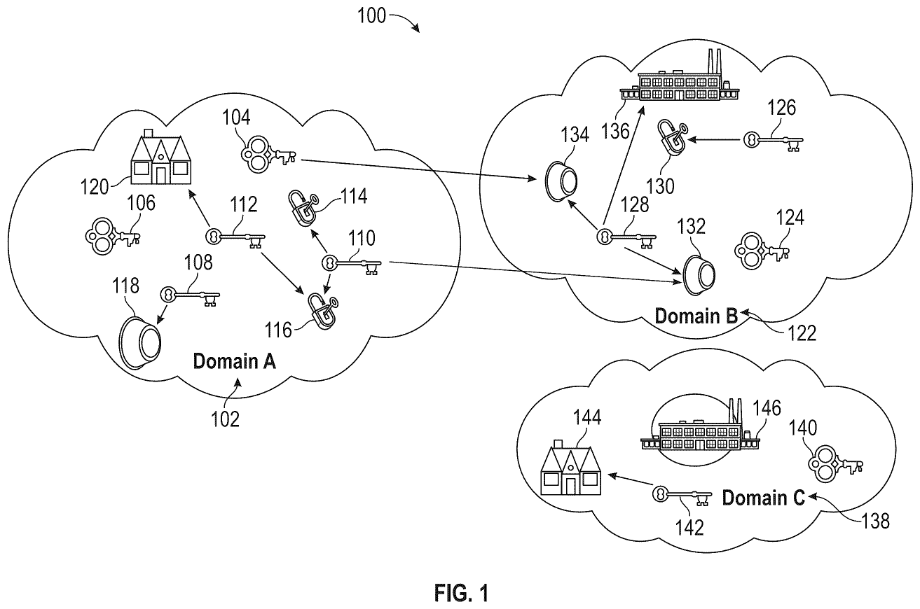

FIG. 1 illustrates an example embodiment of an access control system 100 subdivided into three domains 102, 122, 138. A first domain 102 of the access control system 100 includes locks 114, 116, 118, 120 associated with a first controlled access environment, such as, for example, a residence. The locks 114, 116, 118, 120 can include, for example, padlocks, door locks, cabinet locks, equipment locks, or other types of locks. In the embodiment shown in FIG. 1, the first domain 102 includes master keys 104, 106. Master keys have privileges to perform administrative functions on the locks in a domain. For example, in some embodiments, master keys can access, erase, program, or reprogram locks in a domain. Thus, the master keys 104, 106 in the first domain 102 are able to perform any of the master key functions on the locks 114, 116, 118, 120 in the first domain 102. Master keys can also have privileges to access locks in other domains. For example, a master key 104 in the first domain 102 can access a lock 134 in the second domain 122. However, in the embodiment shown in FIG. 1, the master key 104 does not have administrative privileges in the second domain 122 and cannot erase, program, or reprogram the lock 134 in the second domain 122.

In the embodiment shown in FIG. 1, the first domain 102 also includes slave keys 108, 110, 112. Slave keys can have privileges to access one or more locks in a domain but do not have privileges to perform some or all of the administrative functions that master keys can perform. In some embodiments, an access control system administrator can set up a domain such that slave keys have access to only a portion of the locks in a domain. A slave key 110 can also have access privileges to locks 114, 116, 132 in multiple domains 102, 122.

In some cases, a domain 102 may include a single lock or may be defined by the lock. Further, in some cases, a master key may be capable of accessing one lock or multiple locks. In other cases, a relationship may exist or be established between the master key and the lock, or multiple locks independent of a domain. Similarly, a relationship may exist or be established between the slave key and the lock, or multiple locks independent of a domain. In some implementations, a master key is configured to lock and/or unlock a lock, and is capable of enabling other keys (e.g., slave keys) to lock and/or unlock the lock. In contrast, a slave key may lock and/or unlock a lock, but may not be capable of enabling other keys to lock and/or unlock the lock. In some cases, a master key may enable a slave key to lock and/or unlock a lock a certain number of times (e.g., once or twice, etc.) or for a certain period of time (e.g., 1 minute, 5 minutes, 1 hour, etc.).

A second domain 122 of the access control system 100 includes locks 130, 132, 134, 136 associated with a second controlled access environment, such as, for example, a workplace. The second domain 122 includes a master key 124 that has administrative privileges for all of the locks 130, 132, 134, 136 in the second domain 122. The second domain 122 also includes slave keys 126, 128 that have access privileges to some of the locks. Keys in the access control system 100 illustrated in FIG. 1 can belong to more than one domain. A third domain 138 includes a master key 140 that has administrative privileges for locks 144, 146 in the domain. The third domain 138 also includes a slave key 142 that has access privileges for a lock 144 in the domain 138. The third domain 138 is an example of a domain in which the master key 140 and the slave key 142 have no access or administrative privileges outside the domain 138.

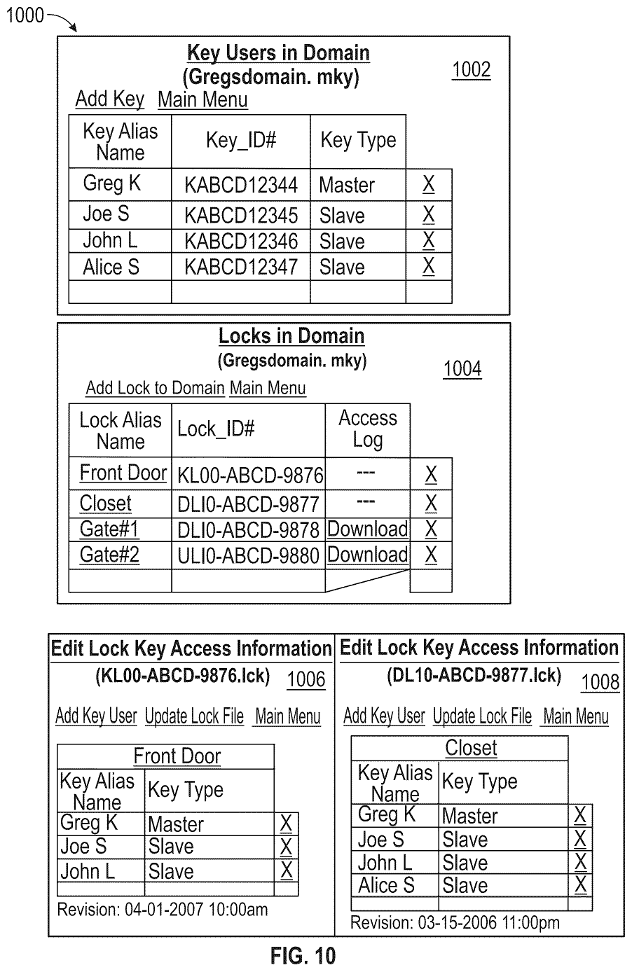

In some embodiments, each of the domains 102, 122, 138 is associated with a domain file. The domain file can contain information associated with a domain of the access control system 100, including, for example, key users and locks in a domain. One or more lock configuration files can also be associated with each domain. In some embodiments, a lock configuration file contains key access information associated with an electronic lock. An example interface 1000 for modifying such information is shown in FIG. 10. The domain file can be created or modified by an access control administration application program (an “admin application”). In some embodiments, the domain file can be stored on a master key, on a computer, or on both. In some embodiments, master keys have administrative privileges only in the domains in which they are assigned. Master keys and slave keys can have access privileges for locks in any domain. A domain file can be password protected to increase the security of an access control system. In some embodiments, a person possessing a master key is allowed to use the admin application to modify the domain file and lock configuration files on the master key. For example, the person could reconfigure the domain file and lock configuration files to remove other master keys from the domain. However, in some embodiments, a person must also know a domain password in order to be able to modify the domain file and lock configuration files.

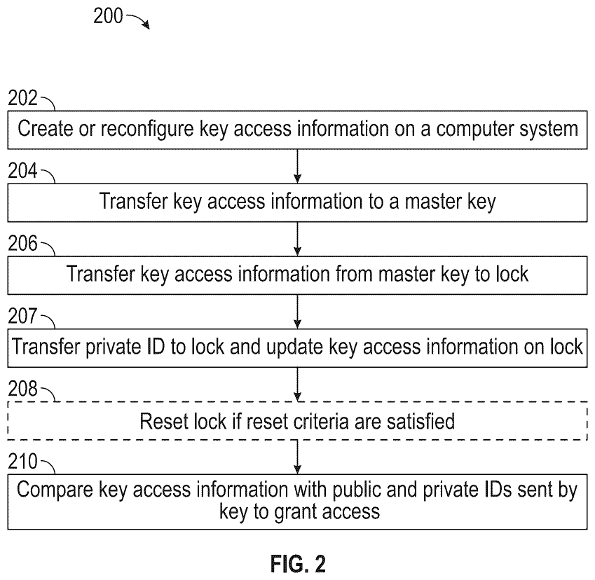

The flowchart in FIG. 2 shows an embodiment of a method 200 for configuring and operating an access control system. The method 200 includes creating or reconfiguring key access information (202). In some embodiments, an administrator uses an admin application on a computer to create or reconfigure a domain with one or more master key public key identifiers, slave key public key identifiers, and lock identifiers. The public key identifier of a lock or key can be readily available to a person. For example, the public key identifier can be printed on the lock or key, or it may be visible in some other way. The key access information for a lock can be stored, for example, in a lock configuration file. In some embodiments, a domain file links the lock configuration file to a lock (for example, to an alias of the lock) and associates one or more keys with a user name or alias. The admin application can be configured to translate or interpret lock aliases and key aliases into identifiers associated with the locks and keys, respectively. The name of the domain file may correspond with the name of the domain. In some embodiments, the name of the domain can be changed by renaming the domain file.

In the embodiment shown in FIG. 2, a newly created or reconfigured lock configuration file is transferred to a master key (204). In some embodiments, a user connects the master key to a computer, and the user causes the computer to copy one or more lock configuration files containing the key access information for the domain to a memory on the master key or keys associated with the domain. In alternative embodiments, the copying process can be handled by the admin application. In some embodiments, a user of the computer can also copy other files to the memory of the key while it is connected to the computer. For example, the user may copy her digital music collection, digital photos, digital videos, or digital documents onto the key.

After the lock configuration files containing key access information are transferred to the master key, the master key can be used to program locks in the domain of the master key (206). For example, in some embodiments, the master key can be configured to program or reprogram a lock when a public key identifier and a private key identifier of the master key match identifiers contained in the key access information stored on the lock, when a lock identifier matches the file name of a lock configuration file on the master key, and when a connector on the master key is inserted into the lock. A private key identifier of the master key can also be copied to the lock at the time that the lock is programmed or at some earlier time. The private key identifier is not visible to a person and is not available to the admin application. In some embodiments, when a slave key with a public key identifier present in the key access information of a lock is inserted into, or otherwise communicates (e.g., wirelessly) with, the lock after the lock has been programmed, the slave key copies a private key identifier for the slave key to the lock (207). The lock adds the private key identifiers of the keys that have access privileges to the key access information stored in the lock when the keys are first inserted into, or first communicate with, the lock, after the lock is programmed or reprogrammed.

In some embodiments, a lock in a domain can be configured to update its key access information when a master key for the domain is inserted into, or otherwise communicates with, the lock and when the master key has a more recent revision of the key access information contained in the lock configuration file. For example, if a first master key in a domain is updated by the admin application but a second master key in the domain does not, then the first master key will update locks with new key access information while the second master key will not be allowed to reprogram the locks in the domain with the old key access information until the second master key is updated with newer key access information.

In some embodiments, a master key may be allowed to include key access information for more than one domain. In some embodiments, the admin application is configured such that it does not allow a lock to be present in different domains on the same master key.

In some embodiments, the lock is optionally configured to reset when certain criteria (such as, for example, predetermined criteria) are satisfied (208). In some embodiments, master keys in a domain have lock erase privileges for locks in the domain. In some embodiments, a master key can be configured to erase key access information from a lock when the master key is inserted into the lock after key access information is deleted using the admin application from the lock configuration file on the master key. In some embodiments, an administrator can use the admin application to remove all key access privileges from a lock configuration file. In some embodiments, if the lock configuration file associated with a lock is deleted from a master key, then the lock treats the master key as a slave key. As long as the lock configuration file is missing, the lock grants the master key access privileges only. This can reduce the risk of unintentionally erasing a lock if files are erased mistakenly.

In the embodiment shown in FIG. 2, after collecting private key identifiers from the keys in the domain, the lock is set up to provide access when one of the master or slave keys is inserted into, or otherwise communicates with, the lock (210). For example, the public key identifier in the key access information on the lock can be compared with the public key identifier sent by the key. In some embodiments, the lock determines whether the private key identifier of a key is present in key access information stored in the memory of the lock. In some embodiments, if the private key identifier is present in the lock memory, the lock actuates an electronic latch to provide access. In some embodiments, an administrator of the access control system accesses the locks in a domain with each of the keys in the domain after reconfiguring or creating a domain file and the lock configuration files.

In some embodiments, locks are programmed during manufacturing with an identifier (such as, for example, a public key identifier). Master keys and slave keys can be programmed during manufacturing with a public key identifier and a private key identifier. The private key identifier can be configured to be inaccessible to the admin application and to persons in order to increase the security of the access control system.

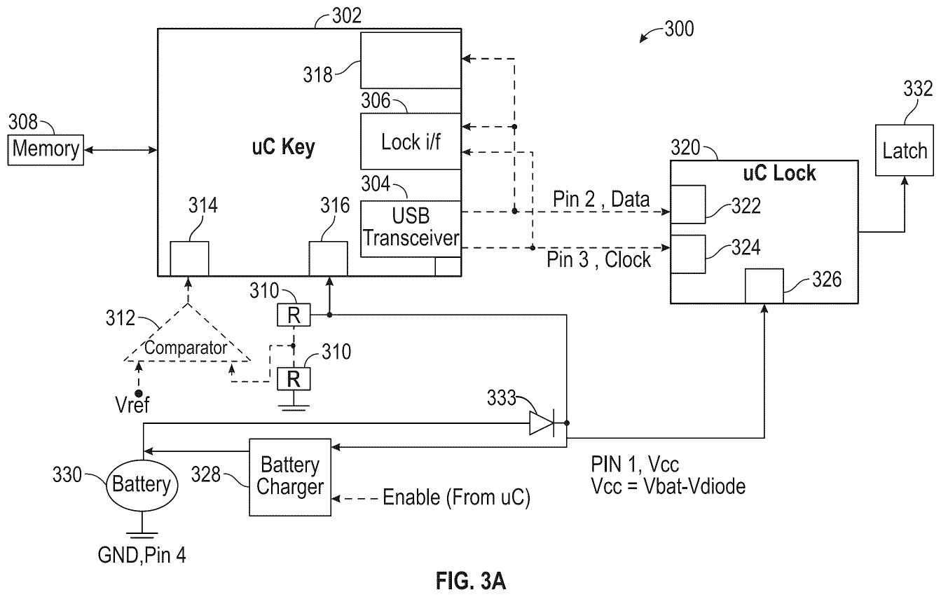

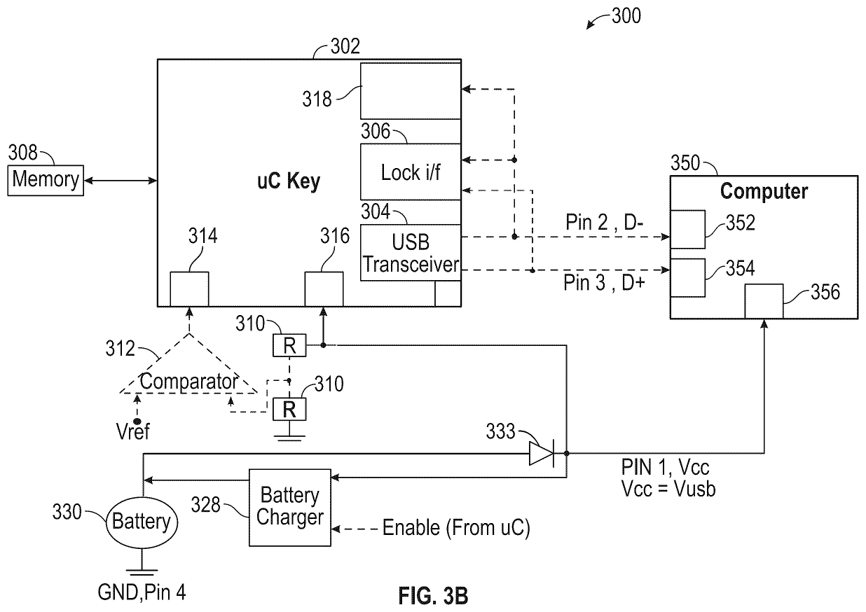

FIG. 3A is a detailed block diagram of an embodiment of an electronic lock and key system 300 having a rechargeable battery 330. In some embodiments, at least some of the electronic key components shown in FIGS. 3A and 3B are powered even when the key is not connected to a computer or an electronic lock. The electronic key can include a key microcontroller 302 that is connected to a memory 308. The microcontroller 302 can include any suitable design, including a design that integrates a USB transceiver, a comparator, a voltage reference, and/or a voltage regulator. For example, a microcontroller selected from the SiLabs C8051F34X family of microcontrollers, available from Silicon Laboratories of Austin, TX, may be used. The microcontroller 302 may be a processor that may execute instructions stored in a memory device of an electronic key. The memory 308 can be a nonvolatile memory device, such as NAND flash memory. The memory 308 can also include a memory card or other removable solid state media such as, for example, a Secure Digital card, a micro Secure Digital card, etc. The microcontroller 302 can also have an optional integrated memory (not shown).

In the embodiment shown in FIG. 3A, the microcontroller 302 includes a USB transceiver 304, a lock interface 306, interrupts 314, 318, and an electrical input 316. The microcontroller 302 forms part of a circuit that can include a comparator 312, a diode 333, a battery charger 328, a battery 330, and other circuit components such as resistors 310, a ground plane, pathways of a lock connector, and other pathways. In some embodiments, the lock connector has four pathways or pins: a power supply pin (Pin 1), a data pin (Pin 2), a clock pin (Pin 3), and a ground pin (Pin 4). In lock mode, there can be separate clock and data signals; however, the clock and data can also share the pins on the connector when a four pin connector is used.

The battery 330 can be any suitable rechargeable battery, such as, for example, a lithium-ion battery, and can be configured to provide a suitable electric potential, such as, for example, 3.7 volts. The battery 330 is placed between a ground, such as Pin 4 of the USB connector, and a diode 333. The electronic key can also include a detection circuit. For example, a reference integrated circuit or a Zener diode derived from the power bus feeding 316 (or Pin 1) can be provided to a reference input for comparator 312. The diode 333 can be, for example, a Schottky diode, an energy efficient diode, or another type of diode. In some embodiments, another type of switching device can be used in place of the diode 333. The diode 333 is oriented to allow current to flow from the battery 330 to Pin 1 of the USB connector. Pin 1 of the USB connector is also connected to the electrical input 316 of the microcontroller 302, an input of the comparator 312 (for example, through a voltage splitter circuit including resistors 310 and a connection to ground), and the battery charger 328. The output of the detection circuit (for example, the output of the comparator 312) can be connected to a computer mode interrupt or reset 314 of the key microcontroller.

In the embodiment shown in FIG. 3A, the electronic key is connected to an electronic lock via an external lock connector, such as, for example, a physical connector that is compatible with a USB connector. The electronic lock includes a lock microcontroller 320 and an electronic latch 332. The microcontroller 320 includes a data interface 322, a clock interface 324, and an electrical power interface 326. The data interface 322 connects to Pin 2 of the USB connector, which is connected to the USB transceiver, the lock interface 306, and a lock mode interrupt 318 when the key connector is inserted into the lock connector. In some embodiments, a data signal on Pin 2 sent by lock microcontroller 320 via data interface 322 will trigger the lock mode interrupt or reset 318 of the key microcontroller 302, causing the microcontroller to enter a lock connection mode. When in the lock connection mode, the key microcontroller 302 can communicate with the lock microcontroller 320 via the lock interface 306, and the USB transceiver 304 can be inactive or disabled. When certain criteria are satisfied, the lock microcontroller 320 can perform various operations, such as, for example, erasing a lock memory (not shown), replacing the key access information stored in the lock memory, or opening the lock by causing the latch 332 to actuate. In some embodiments, the latch 332 is a piezoelectric latch or another style of latch or actuator that permits a relatively small amount of energy to actuate the latch. For example, the latch 332 may include a Servocell AL1a actuator available from Servocell Ltd. of Harlow, Essex, UK, an energy efficient latch that consumes less than about 1.2 mW, or another suitable variety of latch or actuator.

When the USB connector on the key is plugged into a lock, Pin 1 of the USB connector attaches to the electrical power interface 326 of the lock. In this state, the electric potential on Pin 1 is substantially equal to the electric potential of a terminal of the battery 330 less any voltage drop across the diode 333, and the diode 333 is closed or “on.” The battery 330 provides power to both the electronic key and the electronic lock. Pin 3 of the USB connector attaches to the clock signal generated by the lock microcontroller 320 and/or clock interface 324. The clock signal is routed from a pin on a lock interface 306, for example, to assist in data communications between the lock and key. In some embodiments, when the electronic key is connected to a lock, a USB transceiver 304 is disabled on the key microcontroller 302. However, the USB transceiver 304 can share data and/or clock pins with the lock interface module to decrease connector pin count and to allow a USB connector to be used for both connections.

In some implementations, the key may be a wireless device, such as a smartphone, tablet, or key fob. In some such implementations, the key microcontroller 302 may be a processor or microcontroller included in the wireless device. Alternatively, or in addition, a central processing unit or other general-purpose processor of the wireless device may perform the functionality of the key microcontroller 302 rendering the key microcontroller 302 optional. Further, in some such implementations, the wireless device may communicate wirelessly with the lock that includes the lock microcontroller 320.

FIG. 3B shows a detailed block diagram of an embodiment of a computer 350 connected to an electronic key that includes a rechargeable battery 330. The computer 350 can be, for example, a device containing a host USB interface, a desktop computer, a notebook computer, a handheld computer, a mobile phone, or another type of computing device. When Pin 1 of the USB connector is connected to a powered USB pin 356 (for example, on a computer 350 or on a USB charging device, not shown), the electric potential on Pin 1 is higher than the electric potential at the battery 330 terminal, the output of the comparator 312 changes, and the diode 333 is open or “off.” In this state, the electric potential on Pin 1 is substantially equal to the electric potential supplied by a powered USB bus when the USB connector is plugged into a computer. The output change of comparator 312 will trigger the computer mode interrupt or reset 314 of the key microcontroller 302. The microcontroller 302 will enter a computer connection mode.

In computer connection mode, the USB transceiver 304 can be enabled and the lock interface 306 can be inactive or disabled. In some embodiments, the USB connector has four pathways or pins: a power supply pin (Pin 1), a data with clock recovery pin (Pin 2), a data and clock pin (Pin 3), and a ground pin (Pin 4). The D− pin (Pin 2) and D+ pin (Pin 3) are used to transmit differential data signals with encoding that the USB transceivers use to recover a clock. The computer can supply USB data with clock recovery encoding via pins 352, 354 of the computer's USB interface. The USB transceiver 304 can assist in communications between the key and the computer 350. In some embodiments, the microcontroller 302 provides instructions to the battery charger 328 for charging the battery 330 while in the computer connection mode. For example, the battery charger 328 can be a Linear Tech LTC4065L from Linear Technology of Milpitas, CA, a battery charger for a lithium ion battery, or another suitable battery charger.

Just as the key may communicate wirelessly with the lock, in some implementations, the key may communicate wirelessly with the computer 350. For example, the key may communicate using Bluetooth® or Zigbee® with the computer 350. Alternatively, the key may communicate over a wired or wireless LAN connection with the computer 350.

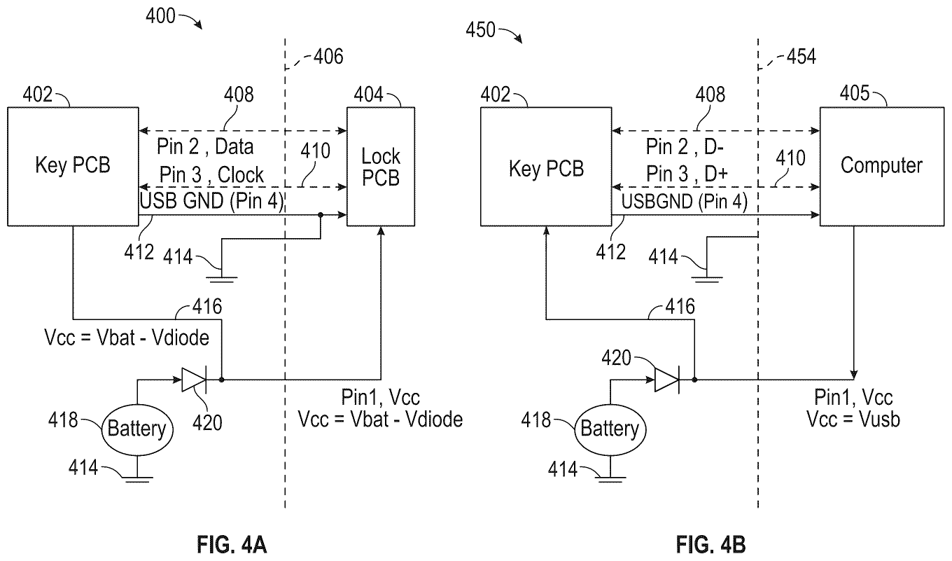

FIG. 4A is a block diagram of an embodiment of an electronic lock and key system 400 in which the electronic key 402 uses a connection 406 between a lock 404 and the key 402 as a switch. The embodiment shown in FIG. 4A can be implemented in combination with features of the embodiments shown in FIGS. 3A and 3B. In some embodiments, Pin 4 of the USB connector of the key 402 is isolated from a ground, while Pin 4 of the USB connector of the lock 404 is connected to a chassis of the connector. Isolating Pin 4 from ground allows the connector of the key to act like a switch when it is plugged in to the connector of the lock. When the key connector is inserted into the lock connector, the chassis of the key and the chassis of the lock form an electrical connection 412. The electrical connection 412 provides a ground 414 to the circuit, enabling the battery 418 to power the lock and key system 400. In some embodiments, the ground loop connection is completed by a trace on a circuit board of the lock that connects the ground pin 412 of the USB connector to the chassis of the connector. A diode 420 allows electrical energy to flow from the battery 418 to the key 402 and the lock 404. A data pin 408 and a clock pin 410 provide for communication between the key 402 and the lock 404. The lock 404 may receive power from the key system 400 to operate (e.g., lock and unlock). The key system 400 may be buttonless so that users are not required to actuate a button to lock or unlock the lock 404. For example, the lock 404 may automatically perform an authentication process and actuate a lock upon connection or communication with the key system 400. Similarly, the lock 404 may automatically lock or relock after a connection or communication with the key system 400 is lost, or after a particular period of time. In cases where a button for interacting with the key system 400 and/or lock 404 is included, the button may be a physical button or a touch-sensitive button on a computer screen. In some embodiments, the lock 404 can include one or more rechargeable batteries. The coupling between the lock 404 and the key system 400 can recharge the rechargeable batteries of the key system 400.

FIG. 4B is a block diagram of an embodiment of an electronic key and computer system 450 that uses a connector as a switch. In the embodiment shown in FIG. 4B, an electronic key 402 has the same structure as the electronic key 402 described with respect to FIG. 4A. However, when the key 402 is connected to a powered USB port of a computer 405, electrical energy and a ground connection are supplied by the computer 405 to the key 402 because the diode 420 is open or “off”. Power from the battery 418 is not used because the battery 418 is isolated from the rest of the circuit by the diode 420. In some embodiments, when the electronic key is not plugged into anything, the negative terminal of the battery 418 has no path to ground because the chassis of the USB connector of the key is isolated from the ground pin 412. Consequently, energy from the battery 418 is not used when the key 402 is not plugged in to the lock 404.

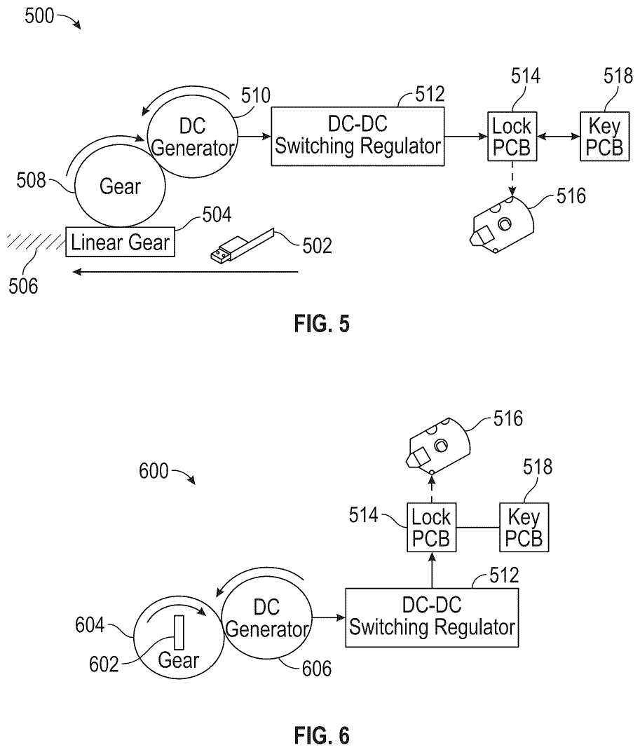

FIG. 5 illustrates an example embodiment of an electronic lock and key system 500 configured to convert translational movement into electrical energy. In the embodiment shown in FIG. 5, a key 502 pushes a linear gear 504 disposed in a lock in order to turn a generator 510. In some embodiments, the gear 504 incorporates a mechanical linkage 508 to the generator 510 that includes a reciprocating linear gear. The generator 510 can be any suitable generator for producing electrical energy, such as a DC generator. In some embodiments, the generator 510 can be an AC generator or an AC generator coupled to a rectifying circuit. The linear gear 504 can be connected to a spring 506 that exerts a force that causes translational movement of the linear gear when the spring is moved out of an equilibrium state. In some embodiments, a switching regulator 512 is disposed between the generator 510 and a printed circuit board (PCB) of the lock PCB 514. The switching regulator 512 can be, for example, a DC-DC buck boost switching regulator with a suitably large capacitor or another type of switching regulator suitable to convert the generator 510 output into a form usable by the lock PCB 514. The lock PCB 514 can include electrical connections to provide power to a latch 516 and/or to a key PCB 518. The latch 516 can include a low power piezoelectric actuator or another style of actuator capable of operating with a relatively small level of energy input.

FIG. 6 illustrates another embodiment of an electronic lock and key system 600 configured to convert rotational mechanical energy to electrical energy. In the embodiment shown in FIG. 6, a key aperture 602 (for example, a key hole) is situated substantially coaxially with respect to a gear 604 with a lock. The key aperture 602 can be disposed on a door knob, for example. When an electronic key is inserted into the aperture 602, rotation of the key (for example, when torque is applied to the key by a user) causes the gear 604 to turn a generator 606. As described previously, a switching regulator 512 is disposed between the generator 606 and the lock PCB 514. The generator 606 and/or switching regulator 512 can include one of the configurations described with respect to FIG. 5 or another suitable configuration. Furthermore, the mechanical configuration described with respect to FIG. 5 can be combined with the features shown in FIG. 6 to create a lock capable of converting both translational movement and rotational movement of the key into electrical energy.

In some embodiments, the electronic lock and key system does not use mechanical movement to generate power. Instead, the electronic lock and key system may be powered via a battery. If the battery of the electronic lock is depleted, the battery may be charged or the electronic lock may be powered by a power source (e.g., a battery) within the electronic key upon the electronic key being connected to the electronic lock. Further, in some cases, the electronic lock may not include a battery. In some such cases, the electronic lock is powered by the electronic key upon the electronic key connecting to the electronic lock. For example, upon the electronic key being inserted into the electronic lock, power may be transferred from the electronic key to the electronic lock enabling the electronic lock to operate.

The lock PCB 514 and/or the key PCB 518 shown in FIGS. 5 and 6 can be configured to include at least some of the components or features of the circuits shown in FIGS. 3A, 3B, 4A, and 4B. Thus, the access control systems that include a lock with a generator can also include, for example, a key with a rechargeable battery and/or a connector that serves as a switch. In some embodiments, an access control system 400 includes a battery 418 that supplies power to the system when the electric potential generated by a lock 404 is less than the difference between the electric potential of the battery 418 and the voltage drop across a diode 420 (FIG. 4A). If the electric potential (for example, the voltage) generated by the lock 404 increases, then the battery 418 in the key can automatically shut off. In some embodiments, an access control system includes a power supply system in which both a battery and an electric generator can contribute to powering at least some components of the access control system. In some embodiments, an access control system includes a power supply system in which the generator 606 can provide enough energy to operate the system 600 if the battery 418 in the key is dead. In some embodiments, the generator 606 can increase the probability that the access control system can be powered and operated in emergency situations.

As previously described, in some cases the key may communicate wirelessly with the lock. In some such cases, the key may transfer power wirelessly to the lock to enable the lock to actuate. For example, the key may use electromagnetic, inductive or capacitive power transfer to power the lock. Alternatively, the lock may include a power source, such as a battery or a connection to mains to power the lock. It should be understood that when the lock is not powered, it will typically remain in a locked configuration.

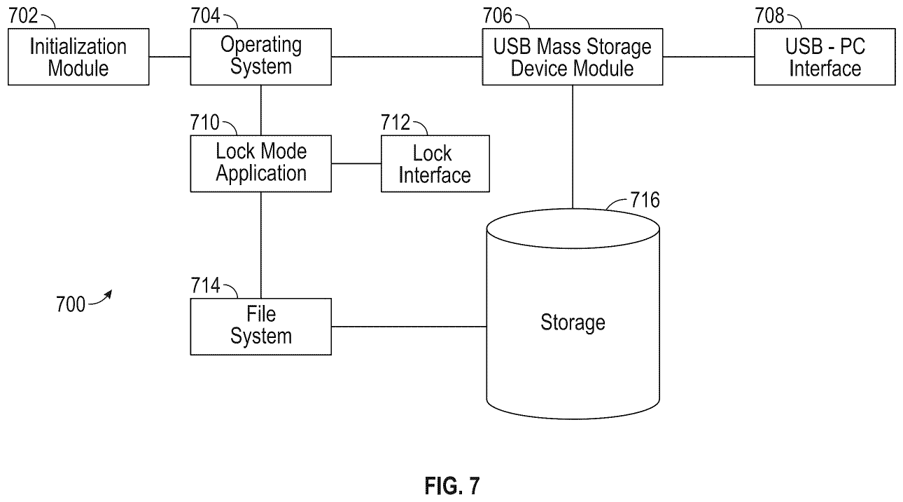

FIG. 7 is a block diagram of an embodiment of an electronic key 700 configured to operate as a storage device for digital files. In some embodiments, the modules and program logic shown in FIG. 7 may be embedded as firmware on, for example, the microcontroller of the key. The key 700 includes an initialization module 702 that contains program logic for booting up the key and preparing the hardware of the key to run an operating system 704. In some embodiments, the operating system 704 is a custom operating system that includes program logic for determining when the key is plugged into an electronic lock or a powered USB port of, for example, a computer system.

If it is determined that the key is plugged into or otherwise in communication (e.g., wireless communication) with a lock, the operating system 704 runs a lock mode application 710. The lock mode application includes program logic for handling communications with a lock interface 712 and with a file system 714. For example, if the lock mode application 710 determines, via the lock interface 712, that a lock includes outdated key access information, the lock mode application 710 can use the file system 714 to obtain updated key access information from a storage device 716. The file system 714 can implement, for example, FAT, FAT32, NTFS, UFS, Ext2, HFS, HFS Plus, or another suitable file system implementation. The lock mode application can also be configured to access information from a second key memory embedded in the microcontroller of the key, for example.

If it is determined that the key is plugged into or otherwise in communication (e.g., wireless communication) with a computer system, the operating system 704 loads a USB Mass Storage Device module 706 (a “USB storage module”). The USB Mass Storage Device protocol, created by the USB Implementers Forum, allows the storage device 716 to be accessed directly by an operating system on a computer. The operating system 704 communicates with a computer system via the USB storage module 706 and a USB-PC interface 708. The modules and program logic on the electronic key allow it to operate as both an access control device and as a USB storage device.

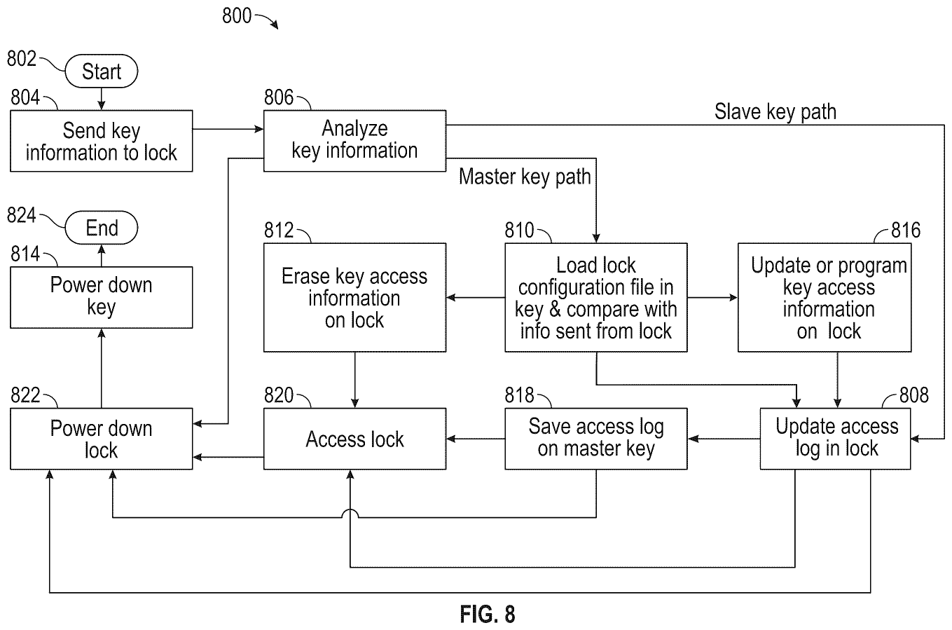

FIG. 8 illustrates an example embodiment of a method 800 for operating an electronic lock and key system. The method 800 begins by executing instructions to boot up the electronic key (802). During the boot up stage, the key can optionally perform a biometric read of a user of the key in order to confirm that the user is authorized. When the key is inserted into a lock, or otherwise communicates with the lock, the key sends key information to the lock (804). The key information can include, for example, a public key identifier, a private key identifier of the key. Next, the lock analyzes the key information in order to determine what action to perform (806). The analysis includes determining whether the key information matches key access information stored in the lock. For example, if the public and private key identifiers of the key are found in the lock's key access information, the lock proceeds to update an access log (808).

The analysis (806) can also include determining whether the lock's key access information is expired or if the key has administrative privileges. In some embodiments, if the key access information in the lock is expired and if the key has administrative privileges, the lock sends lock information (such as, for example, a lock identifier) to the key. In response, the key can load the lock's new key access information by using the lock identifier to search for the lock configuration file stored in the keys memory. For example, the name of the lock configuration file can include the lock identifier.

The key compares the lock's key access information revision date with a key access information revision date stored in the key's lock configuration file (810). By comparing the dates instead of comparing the key access information in the lock with the key access information in the lock configuration file, the key can save energy, hasten access to the lock, and hasten reprogramming. If the key access information needs to be updated, or if the lock does not have key access information, the key instructs the lock to update or program the key access information in the lock (816). The lock may also read and store the private key identifier of the key. After the key access information is updated or programmed, the lock proceeds to update an access log (808). If the key access information in the lock configuration file is not revised (for example, if the key access information in the lock configuration file matches the key access information stored in the lock's memory), the lock proceeds directly to update an access log (808). If the key does not have a lock configuration file for the lock it is plugged into or communicating with, the lock can be configured to treat the key as a slave key and update the access log (808) without making any updates to the lock's key access information (KAI).

If the master key loads the lock configuration file (810) and determines that the KAI in the lock configuration file has no key users (for example, if the file shows that no keys have access privileges), then the master key can send a signal to the lock to erase its KAI (812). The analysis (806) can also include determining whether a key is accessing the lock for the first time. If it is the first access for the key, then the lock updates the key's private key identifier in the lock memory's KAI. If the lock erases its key access information (812), then the lock proceeds to grant access (820) and then power down the lock (822).

In some embodiments, the lock and/or the key maintains an access log. If the lock does not have an access log, and if the key access information is successfully updated or programmed, then the lock proceeds to access the lock (820) by, for example, actuating a latch. If the lock does maintain an access log, then the lock can send an access log to the key for storage as an access log file (818) before proceeding to access the lock (820). If the key information does not match the key access information, or if the lock does not successfully update or program its key access information and there is no access log, or if the access log is not successfully updated, then the lock proceeds to power down (822) without granting access. The lock also powers down (822) after a successful access (820). After the lock powers down, the key powers down and leaves the lock mode (814). The process ends when the key is removed from the lock (824).

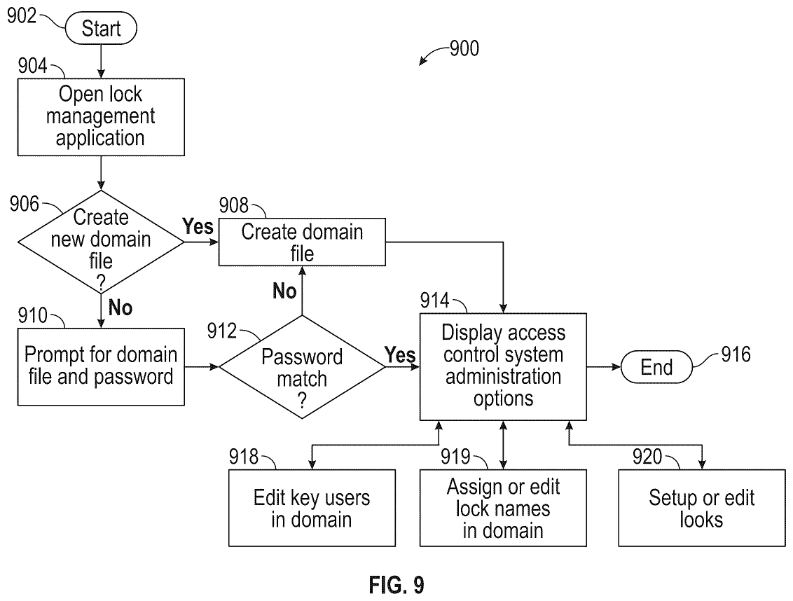

FIG. 9 is a flowchart of an embodiment of a method 900 for configuring key access information in an access control system. In some embodiments, the method 900 begins when a user inserts a key into a USB port of a computer system (902), or otherwise (e.g., via Near Field Communication (NFC) or wireless communication) causes the key to establish or initiate communication with the computer system. In some cases, the key may automatically establish or initiate communication with the computer system. For example, when the key is brought within a particular distance (e.g., Bluetooth® range) of the computer system, the key may initiate communication with the computer system. Next, an access control system management application (or admin application) is opened, either automatically upon insertion of the key, or other communication between the key and computer system, or upon an action of the user (904). The admin application determines whether a new domain file needs to be created (906). For example, the admin application may determine whether a domain file is stored on the key or may prompt the user to determine whether she will be creating a new domain. If a new domain file will be created, the admin application proceeds to create a new domain file (908). The domain file links lock configuration files, which contain key access information for individual locks, to alias names of the locks and links keys to alias key user names, which are interpreted by the admin application.

If a new domain file will not be created, the admin application attempts to open a domain file from the computer or from the key (910). In some embodiments, the admin application prompts the user to locate a domain file. The admin application may also search for one or more domain files in a location on the computer or on the key. The admin application may prompt the user to enter a password associated with the domain file, if any (912). If the password does not match, then the admin application can default to creating a new domain file (908). After creating a domain file or getting a password match, the admin application displays administration options for an access control system (914) and receives input from the user indicating what changes should be made to the domain file and/or lock configuration files. The changes can include, for example, assigning or editing locks in the domain (919), editing keys (such as, for example, slave keys or master keys) or key users in the domain (918) and other domain-specific key access information such as linking a public key identifier to a key user's alias name (918) and a lock identifier to a lock's alias name (919). In some embodiments, the domain file is a file that enables the admin application to manage and to link the lock configuration files for each lock (920). The lock configuration files contain key access information for each lock that determines what keys have access privileges for locks in the domain. Lock configuration files can also be used by the master key to program locks. In some embodiments, the access log is a separate file that can store the number of accesses, time of access, date of access, and optionally other access data. The access log can be stored in a memory of a lock and can be transferred to a file on a master key when the master key accesses the lock. Changes are written to the domain file and lock configuration files, and the process 900 ends when the domain file and/or lock configuration files are closed (916).

FIG. 10 illustrates an example embodiment of an interface 1000 for configuring key access information in a domain file. The interface 1000 includes a keys portion 1002 that shows a list of keys in a domain. A user can identify the keys by a key alias, by a public key identifier (Key_ID #), or by key type (master or slave). In some cases, the user may identify the keys by a lock alias and/or a key alias derived from a lock alias. The keys portion 1002 includes interface elements for adding keys to the domain, removing keys from the domain, changing the key type, and/or other functionality.

The interface 1000 also includes a locks portion 1004 that shows a list of locks in the domain. In some cases, there is no specific domain, and all locks accessible by a user may be shown for any domain. In other cases, locks may be shown for a set of one or more domains. A user can identify locks by a lock alias, by a lock identifier, or, optionally, by other lock properties. In some embodiments, the locks portion 1004 includes interface elements for viewing lock access logs, adding locks to the domain, removing locks from the domain, changing a lock alias, and/or other functionality.

The interface 1000 includes lock configuration file portions 1006, 1008 that show a list of keys that have access privileges for locks in the domain. The lock configuration file portions 1006, 1008 provide interface elements that allow a user to create and/or modify lock configuration files containing key access information for individual locks. The lock associated with each lock configuration file portion can be identified by lock identifier and/or lock alias. Each portion 1006, 1008 identifies keys that have access privileges for a lock by key alias, key type, other identifiers, and/or other lock configuration file properties. In some embodiments, the lock configuration file portions 1006, 1008 include interface elements for deleting key access privileges, adding key access privileges, updating a lock configuration file, and/or other functionality. Interface elements can include buttons, hyperlinked text, selection lists, pull-down menus, check boxes, text input boxes, radio buttons, etc.

In some embodiments, one or more applications, software, applets, or executable files may reside on a mass storage device of the electronic key described herein. This may advantageously allow users to have access to the lock configuration file and domain via a computing device (for example, a desktop or a laptop computer) without having a specific software application on the computing device. In some embodiments, the user interface application, software, applet or executable file may not reside on the mass storage device of the key.

In various embodiments, the lock configuration file can be a text file readable by common text editors or other applications, software, applet, or executable files that may be capable of editing texts, for example, a notepad software. Such applications, software, applets, or executable files may reside on user devices, for example, a laptop computer, a desktop computer, a mobile phone, a tablet, and the like, to allow users to view and edit the domain and lock files. The firmware in the electronic key described herein may read the lock file and update a key access database (KAD) in the lock with any changes associated with or identified in the lock file. Accordingly, locks may be configured without buttons and/or special application software.

In some embodiments, the lock configuration file may be stored in an electronic key. For example, as described herein, a master key may create and store a lock configuration file in its storage device. In some embodiments, when an electronic key (for example, a master electronic key) is connected to a computing device (for example, a desktop computer), the computer may receive the lock configuration file from the electronic key. Optionally or alternatively, the computer may access the lock configuration file, for example, from the electronic key and generate a copy of the lock configuration file and store it. Optionally, the computer may generate a file including information stored in the lock configuration file.

In some embodiments, an electronic lock may not be initialized. In some such cases, the electronic lock may not have provided access privileges to an electronic key. When an electronic key establishes communication with an electronic lock that has not been initialized, or that has not yet paired with or granted master key privileges to another electronic key, the electronic key may become the master key for the lock. As described herein, an electronic key may physically or wirelessly connect (via any suitable wireless communication protocol) to an electronic lock. In some embodiments, the electronic lock may provide its status (for example, not initialized) or lock public ID to the key. Upon receipt of the status or lock public ID, the key may generate a lock configuration file associated with the electronic lock (now initialized). If a subsequent electronic key that is not the master key accesses the electronic lock that is now initialized, the electronic lock may treat the subsequent electronic key as a slave key since the subsequent key does not have the lock configuration file associated with the electronic lock. In some embodiments, the lock configuration file may be named used a public ID of the electronic lock.

Once the lock configuration file has been created, it may be edited using, for example, a text-editing application or program. For example, the electronic key storing the lock configuration file may be connected to a computing device (for example, a desktop computer, a laptop computer, a tablet, a smartphone, a wearable computing device (e.g., a smartwatch or smart glasses), or the like). Once the electronic key is connected to the computing device, a user may use an application or a program to access and edit information stored in the lock configuration file. Such application or program may be a text-editing program as described herein, or a specially designed application configured to configure the electronic key and/or electronic lock. With such application or program, the user may be able to update or change the lock configuration file to edit (for example, add or remove) information associated with electronic keys granted access to the electronic lock.

In some embodiments, public key IDs (for example, storage volume name or serial number) may be accessed manually as described herein. For example, a user may connect an electronic key to a computing device to retrieve a public key ID (for example, a storage volume serial number). Once the public key ID has been retrieved, the user may edit the lock configuration file associated with an electronic lock (for example, one the user wishes to gain access to) to grant the electronic key an access privilege for accessing the electronic lock. Access privilege may be granted by adding a public key ID of an electronic key. In some examples, access privilege may be granted by adding a storage volume identifier or serial number instead. In some embodiments, the lock configuration file may be stored inside a storage unit of a master electronic key (for example, a master key of the electronic lock the user wishes to gain access to) as described herein and the master electronic key may be connected to a computing device for the user to access the lock configuration file. Once the lock configuration file is edited to add a public key ID of an electronic key, the electronic key may now have access to an electronic lock associated with the lock configuration file.

As discussed above, a lock of an electronic access system can share information to authenticate a key and provide access. As discussed herein, such information for authentication may be shared between the key and the lock via wireless communication or communication via physical connection between the key and the lock. However, such authenticating information may be intercepted and accessed by third-parties who may not be authorized to access the lock. Accordingly, it may be important to keep certain authenticating information (for example, private key ID) private from others to provide increased security. For example, when such authenticating information is transmitted wirelessly between the key and the lock, it may be possible that such authenticating information can be intercepted and gathered by a third party. In order to prevent such third party from having access to authenticating information stored in the key or the lock, it may be advantageous to provide a security scheme, method, or system to safeguard the authenticating information. In some examples, such security scheme, method, or system can utilize asymmetric or symmetric cryptography.

In some embodiments, the private key ID may be hashed, encrypted, or derived using various methods of cryptography. For example, a private key ID may not be stored within a storage unit of an electronic key. Instead, a private key ID may be generated for an electronic key per use. For example, when an electronic key is connected to an electronic lock or brought within a predetermined distance from the electronic lock, the electronic key may generate a private key ID. In some embodiments, the generated private key ID may be valid/stored/used for a single or multiple accesses/authentications. The private key ID may be generated based at least in part on a public key ID as described herein. The private key ID, in some examples, may be based on other information or parameters unique or not unique to the electronic key. For example, information such as, but not limited to, time (day, time, minutes, seconds, and the like) of access, time of manufacture, storage device serial number, and the like may be used in conjunction with the public key ID to generate the private key ID.

An electronic key can be an electronic device that includes a connection interface, a controller, a power source, and a storage device. In some embodiments, the controller may be a microcontroller that may include a storage device. The connection interface can any type of electronic, physical interface that allows transmission of data between the electronic key and another electronic device having a corresponding connection interface. Additionally or alternatively, the connection interface can allow transmission of power between the electronic key and another electronic device.

The connection interface can be or can include different types of interfaces including, but not limited to, USB 2.0, USB 3.0, Thunderbolt, Micro, Mini, Firewire 800, Firewire 400, SATA 1, SATA 2, SATA 3, eSATA, and the like. The connection interface can be formed on a housing of the electronic key. The connection interface of the electronic key can mate with a corresponding connection interface of an electronic lock to establish communication between the electronic key and the electronic lock. The connection interface of the electronic key can be dimensioned, shaped, or oriented to require the connection interface to be in a certain orientation to mate with the corresponding connection interface of the electronic lock or other electronic devices. For example, the connection interface can be coupled to a corresponding connection interface of a mobile device or a portable computer such as a tablet or a laptop computer.

In some embodiments, the connection interface can be a wireless transmitter that can establish communication with another wireless transmitter via different types of wireless communication protocols. For example, the wireless transmitter of the electronic key can utilize a near-field communication (NFC) or Bluetooth® to establish communication with the wireless transmitter of the electronic lock or other electronic devices.

The controller of the electronic key can communicate with the connection interface to receive data or power via the connection interface. The power source can include a battery that is coupled to the controller. The battery can be disposable or rechargeable. The power source can receive power received via the connection interface of the electronic key.

The storage device can be a physical device housed within the electronic key. In some examples, the storage device is an electronic server located at a remote location from the electronic key. The electronic key can include a storage device controller that can implement a file system to store data within the storage device. The storage device controller may be a separate controller or may be the same as the controller of the electronic key. Different file systems can be utilized for the storage device of the electronic key, including, but not limited to, NTFS, HFS+, APFS, FAT32, exFAT, EXT 2, EXT 3, EXT 4, and the like. By using a file system, the storage device controller can organize data on the storage device in a format compatible with an operating software of the electronic key, the electronic lock, or both. The file system can also be used to access information in files, such as the lock files, for example, lock configuration files stored in a storage device within, for example, an electronic key or an electronic lock.

In some embodiments, an electronic lock may have an operating system with a file system that can store, access, or retrieve information stored within a storage device within the electronic lock. In some embodiments, the lock does not have an operating system and a respective, corresponding file system.

The storage device can store different types of information specific to the electronic key, including, but not limited to, a public key identifier (public key ID), a private key identifier (private key ID), an alias of the lock, and/or an alias of the key. The storage unit of the electronic key can be a non-volatile memory. The storage unit can also be integrated in the key controller.

In some embodiments, the public key ID can be an identifier or a serial number generated and provided to the key during a manufacturing process and is typically not modifiable. Additionally or alternatively, any information, data, or identifier that publicly identifies the key can be used as a public key ID for the key. The public key ID may be user-generated. Alternatively, the public key ID may be automatically and randomly generated by the controller of the electronic key per each use. The public key ID may be stored within the storage device of the electronic key or in a secured, remote server at a remote location. The public key ID may be strings of alphanumeric characters. In some aspects, the public key ID may be generated from a private key ID using a one-way hashing algorithm or other algorithm that prevents the public key ID from being used to determine the private key ID.

Additionally, or alternatively, the public key ID can be used to publicly identify the key. For example, the public key ID can be a name of a volume or a partition of a storage device within the key. The name of the volume or the partition can be modified by a user. A user may connect the electronic key to another electronic device (for example, a desktop computer or a mobile telecommunication device) and communicate with a storage device controller of the electronic key to modify names of different volumes or partitions within the storage. This can advantageously allow users to access and modify the public key ID without having to download any software or applications.

In some instances, a public key ID of a slave electronic key may be changed over time. Nevertheless, in some such cases, the slave electronic key may retain its access privileges (that is, be able to access the same electronic locks after the change as the slave electronic key could access prior to the change of public key ID) even after changing its public key ID. For example, an electronic key (for example, electronic key A) may have a private key ID (“A87DJ3KR63”) and a public key ID (“JOHN1234”). The public key ID of the electronic key A may be provided to a master key (for example, master key X) to provide access privileges for electronic key A for an electronic lock (for example, electronic lock A). However, as discussed herein, the public key ID may be changed at a later time. For example, the public key ID of electronic key A may change from “JOHN1234” to “JOHN5678.”

In some cases, the change of the public key ID of electronic key A may not affect or change electronic key A's access privileges for electronic lock A. For example, when electronic key A is used to access the electronic lock A, electronic lock A may grant access to electronic key A based on electronic key A's private key ID (“A87DJ3KR63”), regardless of electronic key A's public key ID. Therefore, a change in electronic key A's public key ID may not affect the access privilege of electronic key A.

In some cases, public key IDs may be used for different functions. For example, a first electronic key ID may be used for authentication while a second electronic key ID may be used for adding or removing electronic keys. The shared key between electronic key A and electronic lock A may be based at least in part on the first electronic key ID (for example, electronic key A's serial number) which may not change, while adding and/or removing electronic keys, for example, from a lock file, may be based at least in part on the second electronic key ID (for example, electronic key A's storage volume number/name) which may change, for example, by a user input. As such, changing a volume name/number of an electronic key may not affect the master key's ability to change access privilege for accessing an electronic lock.

Optionally or additionally, a change of the public key ID of the electronic key (for example, electronic key A) may not affect the master key's (for example, master key X) ability to add or remove an electronic key (for example, electronic key A) from the master key's (for example, master key X's), for example, lock configuration file or domain file as described herein. For example, Master key X may store electronic key A's public key ID (“JOHN1234”) for identification purposes. Electronic key A's public key ID may be associated with electronic key A. In some examples, the public key ID of electronic key A may be associated with any subsequent public key IDs (for example, “JOHN5678”) of electronic key A. Accordingly, even if the public key ID of electronic key A is changed from “JOHN1234” to “JOHN5678,” master key X may still identify the electronic key A using the public key ID information, for example, “JOHN1234,” it has for the electronic key A. As such, master key X may be able to add or remove electronic key A from its lock configuration file or domain file.

While the public key ID may publicly identify the electronic key, the private key ID may remain unknown to others. Additionally or alternatively, the private key ID may be unknown to a user of the electronic key. In order to keep the private key ID private, the private key ID may not be accessible or modifiable. As such, the private key ID may remain unique and secret. This can advantageously prevent unauthorized users from accessing and modifying the private key ID of an electronic key to gain access to electronic locks without being authorized or being added as one of authorized users as described herein. The private key ID may be stored within the storage device of the electronic key or in a secure, remote server at a remote location. The private key ID may be strings of alphanumeric characters. In some cases, the private key ID may include non-alphanumeric characters or symbols.

In some embodiments, a private key ID may never be stored within an electronic key. A private key ID, for example, may be generated or determined when an electronic key is coupled to an electronic lock requesting access. This may advantageously prevent others from accessing the private key ID since it is not stored anywhere. The generated private key ID may be used to grant access (for example, unlock the electronic lock). In some embodiments, the generated private key ID may be used (for example, decrypted) to determine an identifier that may uniquely identify the electronic key. As such, the electronic lock may use such unique identifier to grant or deny access. In the above example, a private key ID may be generated using various information unique to the electronic key or the electronic lock, such as lock serial number, key serial number, key volume number, etc.

The public key ID and the private key ID can be stored within a specific location of the storage device of the electronic key. The public key ID can include a portion indicating a location within the storage device where the public key ID is stored. Such portion can be a location identifier. The private key ID can include a location identifier that can identify where it is stored. In some embodiments, however, the private key ID may not have such portion indicating a location with the storage device. This can advantageously prevent others, including unauthorized users, from accessing, modifying, or copying the private key ID. The private key ID may be stored in a secure location of the storage device that is not useable for general storage or for storage of other data. In some cases, the private key ID may be stored in a separate secure storage device or register that is separate from the storage device within the key that may be used to store the public key ID or other data. In some embodiments, the private key ID can be stored within a randomized location of the storage device of the electronic key. After each use of the electronic key, the location of the private key ID can be changed to a random location of the storage device. This can advantageously prevent unauthorized users from accessing, modifying, or copying the private key ID.

Additionally, the electronic lock can include a public lock ID and a private lock ID. The public lock ID can publicly identify the electronic lock. The public lock ID may be generated by a manufacturer or by a user. The public lock ID can be modifiable. The public lock ID can be used as the file name of a lock configuration file 1006. Alternatively, or in addition, the public lock ID may be a serial number unique to the electronic lock. In some embodiments, the electronic lock can include a storage device that can have a number of volumes or partitions. As described herein, names of volumes or partitions in such storage device can be used as a public ID for the electronic lock. Such a public lock ID may be modified by coupling the electronic lock to a computing device (e.g., a desktop or laptop computer, a mobile communication device, a tablet, or the like) and communicating with a storage device controller that can rename the names of the volumes or the partitions. The private lock ID can uniquely identify the electronic lock. In some embodiments, the private lock ID, similar to the private key ID, is not accessible or modifiable. The private lock ID can remain unknown to the user of the electronic lock. The public lock ID and the private lock ID may be strings of alphanumeric characters.

The electronic lock can include a storage unit that can store the public lock ID and the private lock ID. The storage unit of the electronic lock can be a non-volatile memory. The public lock ID can include a device information portion that can be used to identify the electronic lock and a location identifier can be used by a controller of the electronic lock to locate the device information. The private lock ID can include a device information portion that uniquely identifies the private lock. In some examples, the private lock ID can additionally include a location identifier used to locate the private ID within the storage device. Such location identifier of the private lock ID may remain private and unknown to prevent unauthorized users from accessing the device information of the electronic lock.

In a non-limiting example, the electronic key may couple with the electronic lock and transmit the private key ID to the electronic lock. Once the private lock receives the private key ID, it can compare the private key ID to a list of key identifiers associated with electronic keys authenticated to access the electronic lock. The list of key identifiers can be stored within a storage device in the key access database of the lock housed within the electronic lock or stored in a remote, secure server. The list of key identifiers associated with authenticated electronic keys may be encrypted using information known only to the electronic lock. Such information can be a private lock ID. Once the electronic lock finds a match between the private key ID and the list of authorized key identifiers, it can grant access to the electronic key. However, the above non-limiting method may not be secure since the electronic key transmits the private key ID to the electronic lock. As discussed herein, such transmission of the private key ID can cause the electronic lock and key system described herein less secure since unauthorized users may be able to access the private key ID during communication between the electronic lock and the electronic key. This can be especially true in situations where the transmission of the private key ID occurs wirelessly.

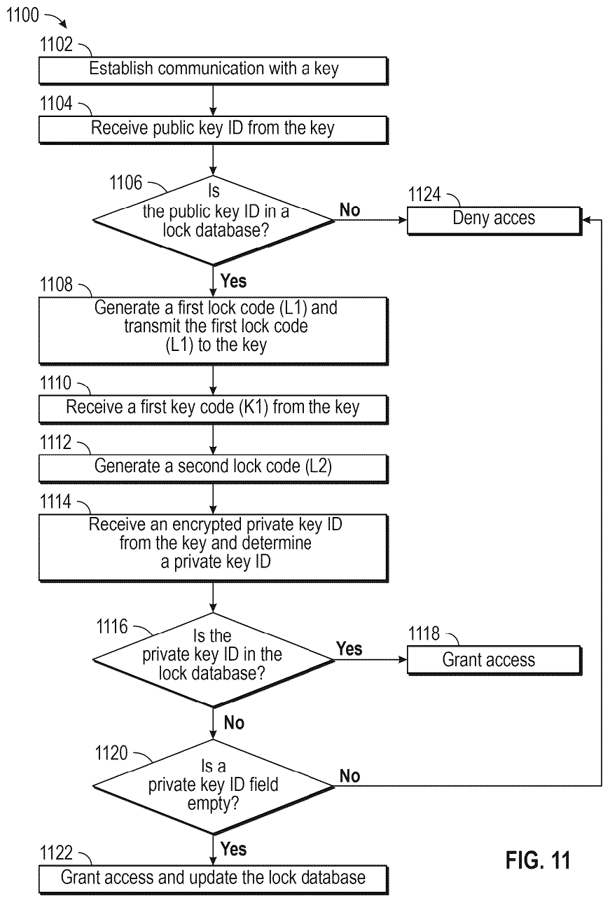

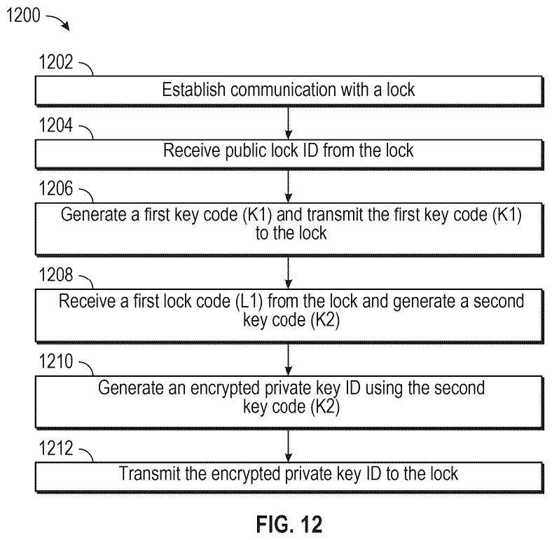

An encryption/decryption scheme or system to can be used to authenticate the electronic key without transmitting the private key ID between the electronic key and the electronic lock. FIGS. 11 and 12 describe a non-limiting, example method of using private key ID, public key ID, public lock ID, and private lock ID to authenticate the electronic key. FIG. 11 shows an example method 1100 of authenticating an electronic key. At block 1102, an electronic lock can establish communication with an electronic key. As discussed above, the connection between the electronic lock and the electronic key can be wireless. The wireless communication between the key and the lock can be established via different types of wireless communication protocols including, but not limited to, Bluetooth®, near-field communication (NFC), Wi-Fi, and the like. Additionally or alternatively, the communication between the electronic lock and the electronic key can be established via corresponding connection interfaces (for example, USB 2.0, USB 3.0, Thunderbolt, Micro, Mini, Firewire 800, eSATA, and the like) of the electronic lock and the electronic key. In some embodiments, the communication between connection interfaces of the electronic lock and the electronic key can be established via a cable assembly suitable to mate with the connection interfaces.

At block 1104, the electronic lock can receive a public key ID from the electronic key. The controller of the electronic key can retrieve the public key ID from the storage device (of the electronic key) and transmit the public key ID to the electronic lock via the communication link established between the lock and the key. Once the electronic lock receives the public key ID, a controller of the lock can check if the public key ID matches an identifier stored at a non-volatile memory associated with the lock at block 1106. The memory (or storage device) may include one or more identifiers associated with electronic keys that are authorized to access the lock. The nonvolatile memory may be included in the lock or in a remote system. Further, the block 1106 may include comparing the public key ID to one or more identifiers stored at the non-volatile memory associated with the lock. In some cases, the one or more identifiers are stored in a database or other data structure configured to store one or more public key IDs, or other identifiers associated with one or more keys. The database can be stored within the lock or at some remote location. The database can be located within a server located at a remote location. The database of the lock may be accessed and/or modified by different users. Access and modification of the database of the lock may depend on a level of authentication for each user. The database can include one or more public key IDs and one or more corresponding private key IDs.

Once the controller of the electronic lock determines that there is a match between the public key ID of the electronic key and an identifier stored in the storage device of the electronic lock, the lock can generate a first lock code (L1) at block 1108. The first lock code may be unique. The first lock code can be generated using at least the private lock ID and the public lock ID. The first lock code can be generated using different types of encryption methods including, but not limited to, triple data encryption standard (DES) algorithm, Rivest-Shamir-Adleman (RSA), Blowfish, Twofish, Advanced Encryption Standard (AES), and the like.

At block 1110, the electronic lock receives a first key code (K1) from the key. The first key code can be generated using a public key code or a private key code. In some examples, the first key code can be generated using both the public key code and the private key code. The first key code can be generated using different types of encryption methods including, but not limited to, triple data encryption standard (DES) algorithm, Rivest-Shamir-Adleman (RSA), Blowfish, Twofish, Advanced Encryption Standard (AES), and the like.

The first lock code (L1) and the first key code (K1) may be the same or different. The first lock code (L1) and the first key code (K1) can comprise one or more alphanumeric characters. Prior to the exchange of the first key code (K1) and the first lock code (L1), the codes (e.g., K1 and L1) can be generated and stored. In some embodiments, the codes (e.g., Kl and L1) can be stored in a non-volatile memory. Additionally or alternatively, the codes (e.g., K1 and L1) can be stored within a volatile memory such that the first key code (K1) and the first lock code (L1) may be removed from the volatile memory after a certain period of time. This can be advantageous in preventing others from accessing the electronic key or the electronic lock to access the first key code (K1) or the first lock code (L1) and determine the private key ID or the private lock ID using the first key code (K1) and the public key ID.

Once the first lock code (L1) and the first key code (K1) are swapped between the electronic lock and the electronic key, the codes (e.g., L1 and K1) may be stored in a non-volatile or volatile memory for future use. For example, once the first key code (K1) is transmitted from the electronic key to the electronic lock, the controller of the electronic lock may store the first key code (K1) within the storage device of the lock. The swapped codes can be stored and saved for a predetermined period of time or indefinitely. In some embodiments, the swapped codes can be encrypted prior to being stored.

At block 1112, the lock generates a second lock code (L2). The second lock code (L2) can be generated using at least the first key code (K1) or the private lock ID. In some examples, the second lock code (L2) is generated using the first key code (K1) and the private lock ID. Although the first key code (K1) may be made available or accessible to unauthorized users, the private lock ID can remain unknown and inaccessible to others, including the user. In this regard, the second lock code (L2) can remain secure and unknown. The second lock code (L2) can be generated using any of encryption methods described herein.

The electronic key can generate a second key code (K2) using at least the first lock code (L1) or the private key ID. In some examples, the second key code (K2) is generated using the first lock code (L1) and the private key ID. Since the private key ID remains unknown and inaccessible, the second key code (K2) can remain unknown. Even if unauthorized users intercept or access the first lock code (L1) transmitted from the lock to the key, the unauthorized users may not be able to determine the second key code (K2) since the private key ID is unknown.

In some embodiments, the second key code (K2) and the second lock code (L2) are the same. The second key code (K2) and the second lock code (L2) can be a secret code shared (for example, a shared secret) between the electronic lock and the electronic key, and may be unknown to others since they are generated using the private key ID and the private lock ID. The second key code (K2) may be used to generate an encrypted private key ID. Any suitable encryption methods described herein may be utilized to generate the encrypted private key ID.

Both the second lock code (L2) and the second key code (K2)—used to generate the encrypted private key ID-may be stored within the storage devices of the electronic lock and the electronic key, respectively. The storages device may be volatile or non-volatile.

At block 1114, the electronic lock receives the encrypted private key ID from the electronic key. The lock can decrypt the encrypted private key ID using the second lock code (L2) and determine the private key ID. As discussed herein, the second lock code (L2) and the second key code (K2) can be the same, secret shared code between the lock and the key. Accordingly, the lock can receive the encrypted private key ID from the key and use the secret shared code (e.g., second key code (L2)) to decrypt the encrypted private key ID to determine the private key ID. Different types of decryption methods can be used to determine the private key ID from the second unique code. The decryption methods can include, but not limited to, ideal observer decoding, maximum likelihood decoding, minimum distance decoding, syndrome decoding, partial response maximum likelihood, Viterbi decoder, and the like. The description method may be the same as the encryption method used for generating the encrypted private key ID.

At block 1116, after the lock determines the private key ID, it checks to determine if the private key ID is in a database (for example, key access database (KAD) as described herein). At block 1118, if the private key ID is in the database, the lock allows access. However, at block 1120, if the private key ID is not in the database, then the lock determines whether private key ID field for the database is empty. In other words, the lock determines whether the database does not have any private key IDs. At block 1122, if the private key ID field of the database is empty, then the lock allows access and updates the database to add the private key ID determined from the second unique code. At block 1124, if the private key ID field of the database is not empty, then the lock powers down. In some embodiments, the process of adding the private key ID (of an electronic key) when the private key ID field of the KAD is empty, for example, as described herein, may include one or more of the embodiments described with respect to the analysis 806 of the method 800 shown in FIG. 8. In some embodiments, the process of adding the private key ID when the private key ID field of the KAD is empty may include one or more embodiments described with respect to the method 200 shown in FIG. 2.

FIG. 12 illustrates a method 1200 of sharing private key ID between the key and the lock. As discussed herein, it is advantageous to not to directly share the private IDs of the key or the lock to ensure that those IDs remain private. At block 1202, the key can establish connection with the lock. As discussed above, the connection between the lock and the key can be wired or wireless. The wireless communication between the key and the lock can be establish via different types of wireless communication protocols including, but not limited to, Bluetooth®, near-field communication (NFC), Wi-Fi, and the like.

At 1204, the key receives the public lock ID from the lock. The transmission of the public lock ID from the lock to the key can occur manually or automatically after connection is established between the key and the lock. Instead of a public lock ID, any information, data, or identifier (for example, a public ley ID) can be used instead.

At block 1206, the key generates a first key code (K1) and transmits the first key code (K1) to the lock. The first key code (K1) can be generated based at least on one publicly available data and at least one private data. The publicly available data may be a public lock ID or a public key ID. Any data known between the lock and the key may be used to generated the first key code (K1). The private data may be the private key ID or some other data and/or information that may be unique or not unique for the electronic key. For example, the key may generate the first key code (K1) using the private key ID and public lock ID. The public key ID and public lock ID may be available to both the key and the lock when communication is established therebetween.

At block 1208, the key receives a first lock code (L1) from the lock and generates a second key code (K2). The second key code (K2) can be generated using at least the first lock code (L1) and the private key ID. In this regard, the second key code (K2) remains secure since private key ID is kept secure and not shared with any users or devices. The blocks 1206 and 1208 can occur simultaneously. At block 1210, the key can generate an encrypted private key ID. The encrypted private key ID can be based on the private key ID and the second key code (K2). Since the second key code (K2) is generated using the private key ID as discussed above, the encrypted private key ID generated using the second key code (K2) can also be secure. At block 1212, the key transmits the encrypted private key ID to the lock for authentication.

The key and the lock described herein can be programmed using a mobile computing device, application, a mobile platform, computing device. The key can, as discussed herein, have a specific serial number and/or a volume name as its public key identifier. The volume name or the serial number may be generated and stored in a text file accessible by users via a word processing applications. The text file storing the volume name or the serial number may be accessed or modified via other suitable applications or other means. The volume name can be a name of an electronic storage located within the key per mass storage device specifications. The public key identifier of the key can be added to a list of keys within a database (for example, lock configuration file) via, for example, an application of a mobile device. The database (for example, lock configuration file) including a list of keys having access privileges can be located within a remote server or stored on the key as a text file.

The electronic key can be associated with one or more electronic locks using the mobile application. The mobile application can allow one or more keys to have access to a given electronic lock. In some aspects, the mobile application can establish wireless communication with an electronic lock to provide a list of keys that can access/operate the electronic lock. It is understood that various different types of wireless communication protocols can be established between a mobile device running the mobile application and an electronic lock including, but not limited to, near-field communication (NFC), Bluetooth®, Wi-Fi, and the like. The wireless communication between the key and the lock described herein can allow the lock to generate power from the wireless communication. For example, the key and the lock described herein can communicate via NFC and the NFC can allow the lock to generate power from NFC wireless signal.

In some embodiments, the electronic lock can include a list of authenticated electronic keys that can access the lock. The list of keys can be stored within a data storage device within the lock or in a remote database. The list of keys can be stored within a remote server such that it can be accessed with a mobile device that has access to the list of keys.

Users of an electronic lock or an electronic key can establish a user account. The user account can be associated with the electronic lock or the electronic key. The user account can store information associated with the electronic lock or the electronic key. In some examples, the information associated with the electronic lock or the electronic key can be stored at a remote server and the user account may be able to send a request to the remote server to access the information associated with the electronic lock or the electronic key.

An electronic lock or an electronic key may be added to a user account using various methods. A user may access his or her user account and manually add his or her electronic lock or key to his or her user account by associating the user account with identifying information of the electronic lock or key. The identifying information may be public key identifier or public lock identifier. In some examples, information related to the electronic lock or key may automatically be associated with the user account. A mobile application may be used to automatically access and retrieve identifying information from the electronic lock or key once the mobile application establishes communication with the electronic lock or key. A mobile application may be operated using computing device such as a desktop computer, laptop computer, a mobile communication device, tablet, or the like suitable to establish physical connection (e.g., via cable or communication interface) or wireless connection with the electronic lock or key.

Each user account can be associated with one or more electronic locks or keys. In some embodiments, an electronic lock associated with a first account can be associated with an electronic key associated with a second account. The information of the key associated with the second account can be provided to the first account associated with the lock and such information can be used to authenticate the key associated with the second account with the lock associated with the first account. The method of authenticating the key of the second account for the lock of the first account can include the first account requesting information of the key of the second account. Once the first account associated with the lock receives information of the key (e.g., a public key identifier of the key or a private key identifier of the key) from the second account, the first account can use the information to authenticate the key of the second account. In this regard, a user account can include a first list of electronic locks and keys associated with a user, and for each electronic lock in the first list, a second list of electronic keys authenticated to access the electronic lock.

For example, John can have his user account which can include a key and a lock. John can authenticate Kate's key to have access to his lock. In this regard, John's user account can not only include information associated with his own lock and key, but also include information associated with Kate's key, including, but not limited to, a public key identifier of Kate's key, a public key identifier of Kate's key, or both.

Once the information of Kate's key is added to John's user account, it can be modified. For example, John may be able to create an alias for Kate's key. Such alias may be the same or different from the key's public key identifier that may be generated by Kate. Kate may use “ABCD” as her key's public key identifier and John may use “Kate's key” as an alias for Kate's key.

Users may also be able to remove an authenticated key from their accounts. In the example above, John may remove Kate's key from his account. Removal of Kate's key may remove or disable authenticated status of Kate's key. Therefore Kate's key may no longer be able to access John's lock. As described herein, users may add one or more keys as authenticated keys for their locks. For example, John may add Kate's and David's keys as authenticated keys having access to John's lock. By having their keys associated with John's lock, Kate and David may now have access to John's lock.

In some embodiments, only a user (e.g., an owner) of a lock may add authenticated keys (or authorized keys) to grant access to the lock. This can prevent unauthorized users from granting themselves access to locks of other users without permission. In some other embodiments, the user of the lock can generate and provide a secure link, message, or any other suitable medium that can grant owners of electronic keys access to the lock.

In some embodiments, a user may be able to determine locations of locks associated with the user's user account. A user may also be able to determine locations of keys that are authenticated to access his locks. Information of the authenticated keys can include public key identifiers or descriptions provided by their respective owners.

The list of keys or locks (including authenticated keys) may be displayed in a tabulated format or in a graphical format overlaid with a map to show locations of the keys when available.

The user account may not show private IDs of the locks it is associated with. This is advantageous in preventing wrongful access of private lock IDs used to authenticate keys using methods and/or system discussed above. Private ID of the keys and the lock can remain unknown to users for security purposes.

The user account may be accessed via various types of devices including, but not limited to, a desktop computer, a laptop, a mobile phone, a smartphone, a tablet, and the like. In some embodiments, an application installed on a device may be used to access user accounts. The device used to access a user account may additionally be used as a key. For example, a smartphone may be used as to access a user account to, for example, view a list of keys authorized to access a lock and also as a key to access the lock. A smart phone or any mobile computing device may be used for authentication and access the lock.

The user account can be associated with one or more users. Users may or may not have the same level of access to the information associated with the user account. For example, a first user may access all information regarding locks and which keys are authorized to access which of the locks. The first user, in addition, may be able to view and change a list of keys authorized to access a lock. In contrast, a second user may have a lower level of access and may be able to merely view the list of keys authorized to access the lock and not to change the list of keys. In other examples, the first user may be able to access, view, and change a list of keys authorized for all of the locks associated with the account while the second user may be able to access, view, and change a list of keys authorized for a subset of the locks associated with the account. In other examples, the first user may be able to add and remove a key to a list of authorized keys for a lock while the second user may only be able to remove a key from the list of authorized keys.

The user account can include a master user that can change access level of other users. The master user can be changed to allow another user or other users to become master user(s). The master user may be able to add other users and grant them access to the user account. The examples of different levels of access for a user account and a list of keys discussed above are merely for an example and do not limit the scope of the disclosure in any way. It is understood that other variations of different levels of access of a user account is possible.

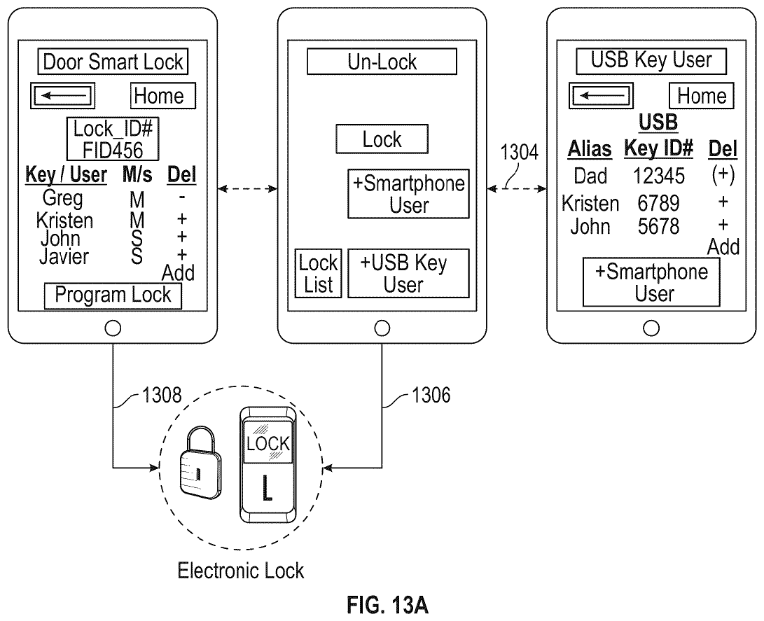

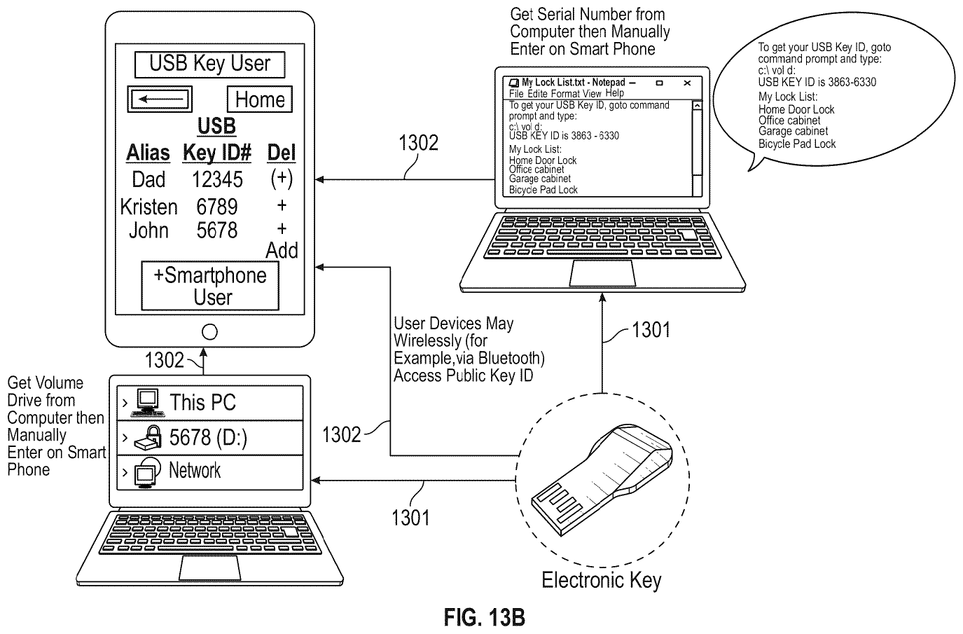

FIG. 13 illustrates a schematic dataflow diagram illustrating a flow of data between electronic keys, electronic locks, computing devices, and a mobile application associated with the computing devices. As discussed above, the electronic key can include an electronic storage device that can store different types of files. The electronic key can include a public key ID and a private key ID that uniquely identifies the key. While the public key ID can be accessible to users and locks, the private key ID may not be accessible and remain secret to ensure integrity of authenticating the key.

At block 1301, the electronic key can be connected to another computing device (for example, a PC or a laptop). At block 1302, the electronic key can be connected to, or in communication with, another electronic device (for example, a mobile device) used for access control. As discussed herein, the communication can be established via a physical connection or via a wireless communication protocol using wireless communication interfaces. For wireless communication, suitable short-range or long-range wireless communication protocols may be utilized, including, but not limited to, Bluetooth®, Z Wave, ZigBee, near-field communication (NFC), Wi-Fi, and the like. For physical connection, various suitable connection interfaces described herein may be utilized. In order to establish a physical connection between the electronic key and another electronic device, a compatible set of connection interfaces may be needed between the devices. In some embodiments, the electronic key can be used to access an electronic lock and a computing device (for example, a PC or a laptop).

Once connected, files that can be stored in the electronic key, and the public key ID, can be accessed, viewed, or modified via an application operable on an electronic device (e.g., a desktop computer, laptop computer, a tablet, or other computing device). A processor of the electronic device can, via the application, query or attempt to access the public key ID from the electronic key. In some embodiments, the electronic key automatically transmits the public key ID to the electronic device via the application. On the other hand, as discussed herein, the private key ID may not be accessed, viewed, or modified by the application or transmitted by the electronic key.

In some embodiments, the public key ID may be manually accessed by or provided to a user. For example, a user may access a public key ID of an electronic key by connecting the electronic key to a computer. Once connected, the computer may access the electronic key and the user may be able to view the public key ID (of the electronic key). As described herein, the public key ID may be a volume name of a storage unit of the electronic key. The user may copy the public key ID and manually enter it in a lock configuration file associated with an electronic lock the user wishes to access. Once the public key ID is added to the lock configuration file, the user may access the electronic lock. In some embodiments, as described herein, the computer may automatically identify the public key ID of the electronic key once the electronic key is connected to the computer.

A user may identify the public key ID by coupling the electronic key to a computing device (e.g., a desktop or laptop computer). The computing device can display the public key ID and allow the user to manually enter the public key ID to an application operating on either the same computing device or another computing device (e.g., a mobile communication device or a tablet). In some examples, a user may establish communication directly between a mobile computing device and the electronic key to query the public key ID. Establishing communication between the mobile computing device and the electronic key can automatically cause an appropriate mobile application to query and receive the public key ID from the controller of the electronic key. In some examples, querying and receiving the public key ID occurs manually.

At block 1304, the public key ID can be added to a user account. The user account can be accessed via an application installed on a user device or having a web-based network interface. Once the user account is accessed, users can add or remove the public key ID to the user account. The public key ID can be displayed with or without an alias (for example, “dad” or “mom”) based on user preferences. The public key ID can be added to a list of keys having access for a specific lock. The list of keys having access to the lock can be used as a reference database for the lock when authenticating a key.

In some embodiments, the electronic key, once authenticated by the electronic lock, allows a user to access the electronic lock (e.g., open the lock). In some other embodiments, the electronic key, once authenticated, can actuate a locking or an unlocking mechanism of the electronic lock to allow a user of the electronic key to access the lock.

The mobile application can allow users to view or change settings for a given lock for which the users are authorized to access or program. The mobile application can have an interface that includes a lock button and an unlock button that, when triggered, allow users to lock and unlock the lock, respectively. Additionally, the mobile application can allow mobile computing devices such as a smartphone or tablet, for example, to be used as a key. For example, the mobile application can use a wireless communication device (including, but not limited to, NFC or Bluetooth®) of a mobile device to wirelessly communicate and authenticate using systems and methods described above.

At block 1306, the mobile application can be used to remotely unlock an electronic lock. At block 1308, the mobile application can be used to program an electronic lock and/or unlock an electronic lock. In some embodiments, the programming of the electronic lock and unlocking of the electronic lock can occur simultaneously. A mobile phone with the mobile application may not need to be within a predetermined range to access an account associated with a given key and authenticate the account or the key. In this regard, authentication may occur wirelessly via different wireless communication protocols including, but not limited to, Code Division Multiple Access (CDMA), Global System for Mobile Communication (GSM), 3G cellular network, 4G Long-Term Evolution (LTE), Long-Term Evolution Advanced (LTE-A), Wi-Fi, Bluetooth®, BLE, Z-Wave, or any other protocols that allow wireless transmission of data.

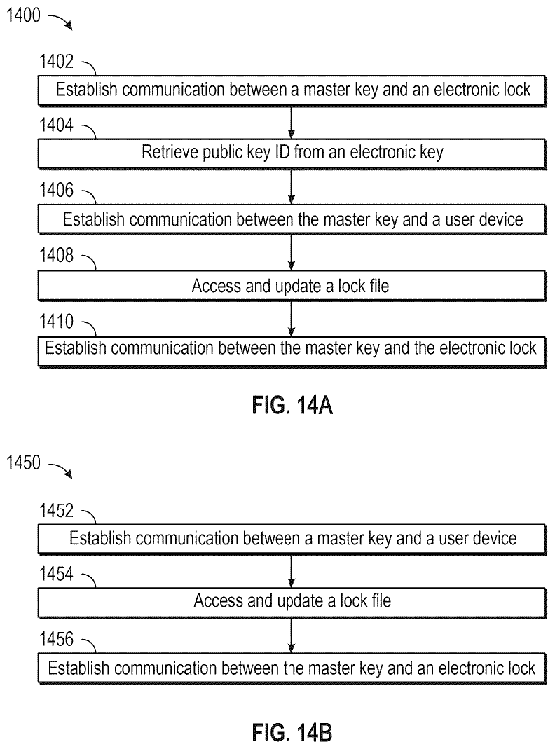

FIG. 14A illustrates an example embodiment of a method 1400 of providing access to an electronic key for an electronic lock. At block 1402, communication between a master key and an electronic lock is established. In some cases, a communication between a master key and an electronic lock may be physical coupling. For example, the electronic lock may include a USB connector and the master key may include a corresponding USB connector that may allow a physical coupling between the master key and the electronic lock. When the communication is established between a master key (for example, a first electronic key coupled to an electronic lock) and an electronic lock, a lock file may be generated and stored within a storage unit of the master key. Additionally and/or optionally, when the communication is established between the master key and the electronic lock, the master key may be added to the electronic lock's KAD.

At block 1404, a public key ID is retrieved from an electronic key (for example, John's electronic key) different from the master key. In some cases, the public lock ID may be retrieved by establishing a communication between an electronic key and a user device (for example, a desktop computer, a laptop computer, a smartphone, a tablet, and the like). For example, John's electronic key may be connected to a laptop computer, and the laptop computer may display a volume name or a volume number associated with John's electronic key. As described herein, the volume name (or the volume number) may be a public key ID of John's electronic key.

At block 1406, communication between the master key and a user device (for example, a desktop computer, a laptop computer, a smartphone, a tablet, and the like) may be established. At block 1408, once communication is established, user may be able to access the lock file stored within a storage unit of the master key and update the lock file, as described herein. The lock file may be a text-based file that can be edited using a text-editing application or software. As described herein, the lock file may contain a list of electronic keys that have access to a given electronic lock. The lock file can be edited to add or remove an electronic key from the list, thereby editing who has an access to an electronic lock. For example, John's electronic key may be added to the lock file by adding the public key ID of John's electronic key At block 1410, communication between the master key and the electronic lock from block 1402 is established. The communication between the master key and the electronic lock may cause an automatic update of the electronic lock's KAD. For example, if the lock file has been edited to add, for example, John's electronic key with a public key ID of “5678,” the electronic lock's KAD may be updated to include John's electronic key as one of electronic keys having access to the electronic lock.

FIG. 14B illustrates an example embodiment of a method 1450 of removing access granted to an electronic key. At block 1452, communication between a master key and a user device is established. As described herein, a master key may store a lock file that may be specific to a certain electronic lock. A user may be able to access the lock file via the user device and edit the lock file. At block 1454, the lock file is updated. As described herein, the lock file may be edited to add or remove an electronic key (for example, John's electronic key). For example, John's electronic key may be removed from the lock file by removing a public key ID associated with John's electronic key (for example, “5678”) from the lock file. At block 1456, communication between the master key and an electronic lock is established. The communication between the master key and an electronic lock may cause an automatic update of the electronic lock's KAD. For example, the electronic lock's KAD may be automatically updated to reflect the removal of John's electronic key from the lock file.

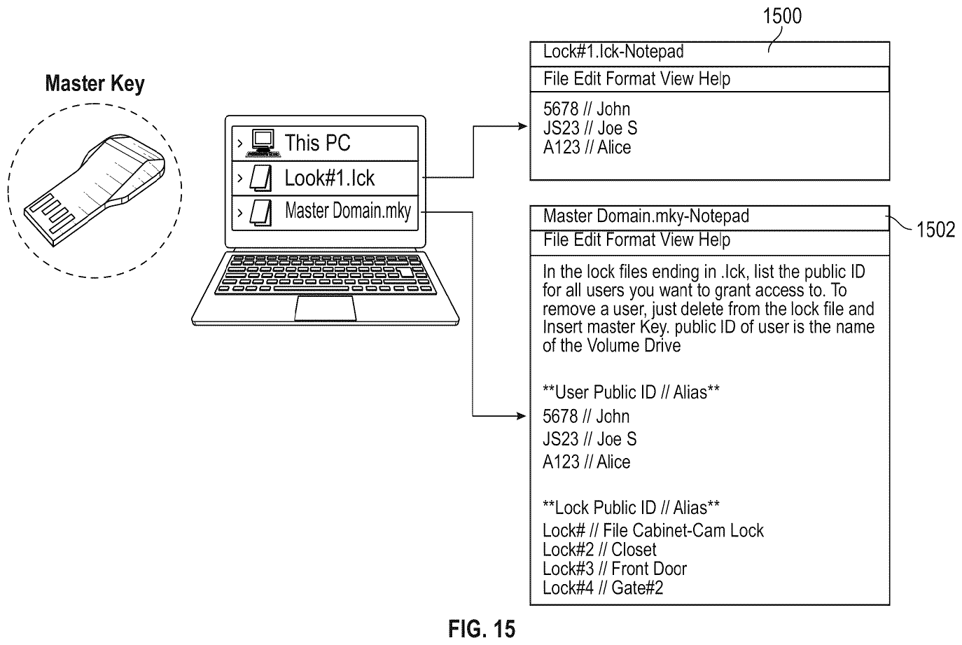

FIG. 15 illustrates example embodiments of graphical interfaces 1500 and 1502 for editing a lock file and a master domain file, respectively. As described herein, the lock file may contain a list of electronic keys that have been granted access to an electronic lock. The lock file may have a name, for example, “Lock #1” as shown in an example illustrated in FIG. 15. In some cases, the name of the lock file may be a public ID for an electronic lock. Additionally and/or optionally, the lock file may display corresponding alias for each electronic key public key ID. The master domain file may include a list of electronic keys (for example, public key IDs and corresponding alias) and a list of electronic locks (for example, public lock IDs and corresponding alias). As described herein, a user may be able to access and edit a lock file and a master domain file when a master key is coupled to a user device (for example, connected to a laptop computer or a desktop computer via USB connector interface).

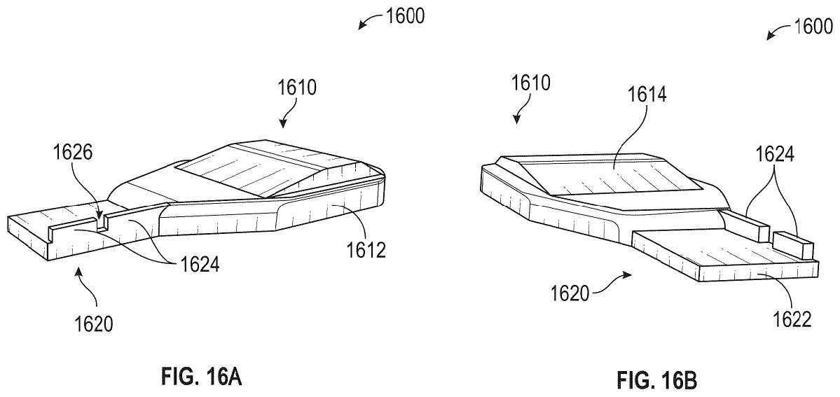

FIGS. 16A and 16B illustrate perspective views of an embodiment of an electronic key 1600. The electronic key 1600 can include a first portion 1610 and a second portion 1620. The first portion 1610 and the second portion 1620 can be connected to form a unitary body for the electronic key 1600. The first portion 1610 can be a gripping portion of the electronic key 1600. The first portion 1610 can include a body 1612 housing various electronics including, for example, memories, processors, and storage devices for the electronic key 1600. The electronic key 1600 can include circuitries and/or any variants of the circuitries disclosed herein.

The body 1612 can include a gripping aid 1614 that can facilitate gripping of the first portion 1610. The gripping aid 1614 can include at least one of grooves, ridges, bumps, protrusions, or any suitable device or mechanism to facilitate gripping of the first portion 1610. In the example shown in FIGS. 16A and 16B, the gripping aid 1614 is a protrusion formed on, for example, a top surface of the body 1612. The gripping aid 1614 can indicate where a thumb of a user may be placed on the body 1612 when gripping the first portion 1610. For example, the thumb of a user can be placed on top of the gripping aid 1614 while an index finger of the user can be placed below and rest against a bottom surface (that is, a surface opposite of the gripping aid 1614) of the body 1612 such that the first portion 1610 of the electronic key 1600 is positioned between and gripped by the thumb and the index finger. The protrusion 1614 can rest against the user's thumb to prevent the electronic key 1600 from sliding away while the user is holding on to the electronic key 1600.

In some embodiments, the body 1612 can include one or more of the gripping aid 1614. The gripping aid 1614 can be disposed on one or more of the outer surfaces of the body 1612. For example, the gripping aid 1614 (for example, a protrusion as shown in FIGS. 16A and 16B) can be disposed on the top surface or the bottom surface of the body 1612.

In some embodiments, the first portion 1610 can be manufactured using a grippy, non-slip material (for example, silicone) that can advantageously improve a user's grip when holding onto the first portion 1610. In some embodiments, the first portion 1610 can be, additionally or alternatively, coated with a grippy, non-slip material.

The second portion 1620 can be a connection interface. The second portion 1620 can be inserted into an opening of an electronic lock. The second portion 1620 can implement a data transfer interface and include one or more pins that facilitate data transfer between the electronic key 1600 and another electronic device (for example, an electronic lock or a computer). It is contemplated that different pin configurations can be used. The pins of the second portion 1620 can be coupled to electronics housed within the body 1612 of the first portion 1610 such that electrical signals can be transmitted between the pins and the electronics housed within the body 1612.

The pins may be positioned or printed on the second portion 1620 such that when the second portion 1620 is inserted into a corresponding opening or slot of, for example, an electronic lock, the pins can come into contact with corresponding pins (or electrical contacts) of the electronic lock. The contact between the pins of the second portion 1620 and the corresponding pins of the electronic lock can allow electronic data transmission between the electronic key 1600 and the electronic lock. In some embodiments, the pins may be positioned on the top surface (that is, the surface facing upward in FIG. 16A), the bottom surface (that is, the surface facing downward opposite of the gripping aid 1614), either of the side surfaces (that is, surfaces that are positioned between and orthogonal to the top and the bottom surfaces), or the front surface (that is, the surface positioned between the top, bottom, and the side surfaces and facing away from the first portion 1610) of the second portion 1620. In some embodiments, the pins may be positioned on one or more of the aforementioned surfaces of the second portion 1620.

The second portion 1620 can include one or more rails 1624. As shown in example embodiments shown FIGS. 16A and 16B, the second portion 1620 can include two rails 1624 and a notch 1626 positioned and formed between the rails 1624. In some embodiments, the second portion 1620 can include more than two rails and more than one notch.

Various combinations of positions or orientations of the rails 1624 and the notch (or notches) 1626 may be utilized. The second portion 1620 can include two or more sets of rails that are disposed on the same surface or different surfaces of the second portion 1620. For example, both a first set of rails 1624 and a second set of rails 1624 can be disposed on the top surface (or the bottom surface) of the second portion 1620. In other examples, the first set of rails 1624 can be disposed on the top surface (for example, as shown in an example embodiment of the electronic key 1600 in FIG. 16A) of the second portion 1620 while the second set of rails 1624 can be disposed on the bottom surface of the second portion 1620.

In some embodiments, the two or more sets of rails 1624 can be disposed on the same side (or edge) or different sides of the second portion 1620. For example, a first set of the rails 1624 can be positioned on the right side (for example, as shown in an example embodiment of the electronic key 1600 in FIG. 16A) of the second portion 1620 while the second set of the rails 1624 can be positioned also on the right side or on the left side of the second portion 1620.

In some embodiments, the rails 1624 can be disposed next to each other (for example, adjacent to each other lengthwise or widthwise). For example, a first set of rails 1624 and a second set of rails 1624 can both be disposed about the right side (or edge) of the top surface of the second portion 1620.

The rails 1624 can extend along an axis parallel to the length of the second portion 1624. In some examples, the rails 1624 can extend along the entire length of the second portion 1624. Alternatively, the rails 1624 can extend along at least a portion of the length of the second portion 1624.

As shown in an example embodiment shown FIGS. 16A and 16B, the rails 1624 can have a rectangular cross-sectional shape. However, the rails 1624 can have a different cross-sectional shape including, but not limited to, semi-circular, triangular, square, and the like. The cross-sectional shape of the rails 1624 may be irregular.

Depending on the orientation of the electronic key 1600, the rails 1624 and the notches 1626 can facilitate coupling and decoupling of the electronic key 1600 and an electronic lock. For example, an electronic lock can include an opening (for example, a key hole) having a groove that corresponds to the rails 1624 of the electronic key 1600. The shape of the groove of the opening of the electronic lock may correspond the cross-sectional shape of the rails 1624 to allow the rails 1624 and the second portion 1620 to be inserted into the opening of, for example, the electronic lock. The electronic key 1600 may need to be in a certain orientation in order for the second portion 1620 of the electronic key 1600 to be inserted into the opening of the electronic lock. When in a first orientation, the rails 1624 of the electronic key 1600 may align with a corresponding groove of an opening the electronic lock such that the second portion 1620 can be inserted into the opening of the electronic lock.

Once the electronic key 1600 is inserted into the opening of the electronic lock, the notch 1626 can prevent decoupling of the electronic key 1600 from the electronic lock. Once the electronic key 1600 is coupled with the electronic lock (for example, inserted into the opening of the electronic lock) in a first orientation, the electronic key 1600 can be turned (for example, rotated about an axis parallel to the length of the second portion 1620 of the electronic key 1600) such that the electronic key 1600 is in a second orientation. Once the electronic key 1600 is turned (for example, in the second orientation), the notch 1626 can engage a corresponding protrusion located inside the opening of the electronic lock and prevent decoupling of the second portion 1620 of the electronic key 1600 from the electronic lock. When the electronic key 1600 is in the second orientation, the corresponding protrusion of, for example, the opening of the electronic lock, may be inserted within the notch 1626 (that is, between the rails 1624) such that the rails 1624 prevent longitudinal (that is, along an axis parallel to the length of the electronic key 1600) movement of the electronic key 1600 (for example, pulling the electronic key 1600 out of the opening of the electronic lock. In other words, when the electronic key 1600 is in the second orientation, it may not be decoupled from the electronic lock. When the electronic key 1600 is brought back to the first orientation (that is, the position of the electronic key 1600 when it was inserted into the opening of the electronic lock), the notch 1626 no longer engages the corresponding protrusion of the electronic lock and allows the electronic key 1600 to be removed from the opening of the electronic lock. The first orientation and the second orientation of the electronic key 1600 may be angularly offset from each other about, for example, an axis parallel to the length of the second portion 1620.

The rails 1624 can, as shown in FIGS. 16A and 16B, extend from the top surface of the second portion 1620. In some embodiments, the rails 1624 may extend from other surfaces (that is, the side surfaces, the bottom surface, and the front surface) of the second portion 1620.

In some embodiments, the rails 1624 can be perpendicular with respect to, for example, the top surface of the second portion 1620. Alternatively, the rails 1624 can extend at an angle less than 90 degrees or greater 90 degrees with respect to the top surface of the second portion 1620. In some embodiments, the rails 1624 can be positioned about side edges (for example, the left edge or the right edge) of, for example, the top surface of the second portion 1620. Additionally or alternatively, the rails 1624 can be positioned anywhere between the side edges of the top surface (or any one of other aforementioned surfaces) of the second portion 1620.

### Contactless Electronic Access Control System

The access control system as contemplated by at least some embodiments generally includes an electronic lock and an electronic access apparatus. The electronic access apparatus can also be referred to as an electronic key or a smart phone. The electronic lock and the electronic access apparatus are configured to communicate with each other via a wireless interface without a mechanical interface. The electronic lock can include, for example, an electronic lock mechanism, such as a latch, an electronic access interface or connector, a controller (e.g., a microcontroller), program modules, nonvolatile memory including lock configuration information, key access information, an access log, and other information stored thereon, other mechanical and/or electrical components. In some embodiments, the electronic lock mechanism can include, for example, a piezoelectric latch or another type of energy-efficient latch, motor or actuator. The wireless interface can include, for example, antennas, sensors, photovoltaic cells, radio frequency identification (RFID) and near field communication (NFC) interface components, signal processing components (e.g., a signal processing circuit), and/or other wireless interface components. Functional components can be integrated into a single physical component. For example, the memory of the lock may be embedded on the same integrated circuit as the controller.

In some embodiments, the electronic access apparatus can include, for example, a wireless transceiver, an electromagnetic signal source (e.g., a light source or radio frequency generator), a key housing, a microcontroller, program modules, a lock interface or connector, a power source, a memory card slot, a memory device having one or more key identifiers, lock configuration files containing key access information for a lock, mechanical and/or other electrical components. Some embodiments of the electronic access apparatus can also include a battery, a battery charger, a digital bus connector, circuitry to detect when the electronic access apparatus is connected to another device, memory integrated with the microcontroller, a storage device controller, a file system, and/or program logic for determining what actions to perform in response to conditions or events. In some embodiments the electronic access apparatus can be a general purpose computing device, such as, for example, a cellular phone, a smart phone, a tablet computer, a laptop, or other computing device. In some embodiments the electronic access apparatus can be a dedicated electronic access device, where the primary purpose of the device is to provide access to one or more electronic access systems.

In some embodiments, the access control system includes an application program for managing access between electronic locks and electronic keys. The access control system can operate on one or more computing systems. In some embodiments, the access control system can be configured to operate in a distributed network environment. The access control system can be used to create domains and/or lock configuration files. The files can be stored on electronic keys, and or other computing devices. In some embodiments, the access control system can manage a plurality of domains so that key access information for groups of electronic locks and keys to be managed more efficiently. For example, a domain can include access control information for a plurality of locks and keys, while an individual lock configuration file may contain access control information for a single lock in the domain.

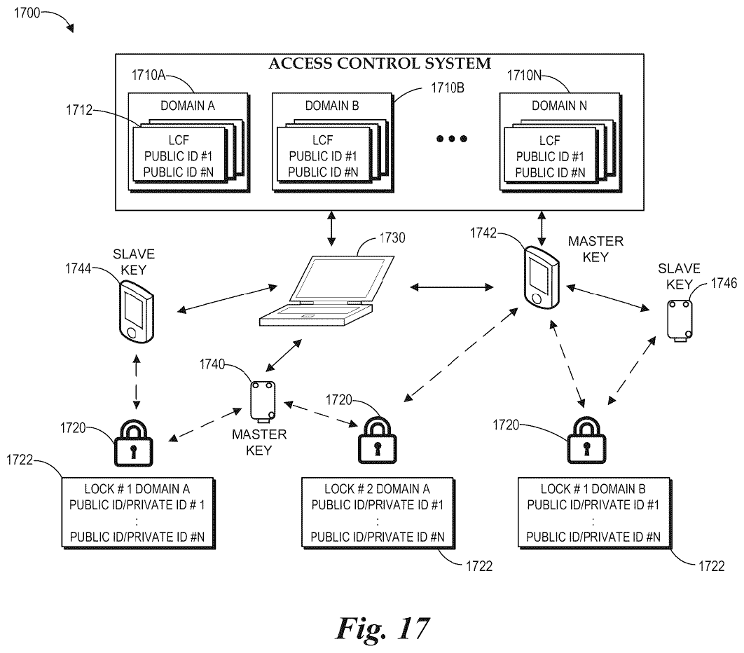

FIG. 17 illustrates an example embodiment of an access control system 1700 configured to have a plurality of domains 1710A-N. Each domain 1710 is associated with a controlled access environment, such as, for example, a residence, an office building, or other defined environment. The domain 1710 can include one or more locks 1720, such as, for example, padlocks, door locks, cabinet locks, equipment locks, or other types of locks. The domains 1710 can have a lock configuration file 1712 associated with each lock 1720. The lock configuration files 1712 store the public identifiers associated with each lock. Each lock 1720 can have a key access information file 1722. The key access information file 1722 stores public identifiers and private identifiers. A different access control system can be associated with each master key.

In the embodiment shown in FIG. 1, master keys 1740, 1742 are associated with the first domain 1710A and master key 1742 is also associated with the second domain 1710B. Master keys have privileges to perform administrative functions on the locks in a domain. For example, in some embodiments, master keys can access, erase, program, or reprogram locks in a domain. Thus, the master keys 1740, 1742 in the first domain 1710A are able to perform any of the master key functions on locks 1720A, 1720B. Master keys can also have administrative privileges in other domains. For example, master key 1740 can access lock 1720C in the second domain 1710B. However, in some embodiments master key may not have administrative privileges in more than one domain, such that the master key can only access the locks but not erase, program, or reprogram the lock and act as a slave key.

The domains can have slave keys 1744, 1746. Slave keys can have privileges to access one or more locks in a domain but do not have privileges to perform administrative functions. In some embodiments, an access control system administrator can set up a domain such that slave keys have access to only a portion of the locks in a domain. In some embodiments, a slave key can have access privileges to locks in multiple domains.

The master keys and slave keys can wirelessly communicate with the locks using electromagnetic signals. The computing devices, master keys and slave keys can also wirelessly communicate with each other via a wireless communication protocol, such as Bluetooth, NFC, RFID, WiFi, Cellular, or other wireless communication protocol that uses electromagnetic signals for purposes of synchronizing domain and lock configuration files via the application. The electromagnetic signals may take any suitable form, such as radio frequency (RF) signals, light signals, etc. In some embodiments, the keys can physically couple to the lock using an appropriate physical connector such as a USB connector.

In some embodiments, each of the domains 1710A-N is associated with a domain file. The domain file can contain information associated with a domain of the access control system 1700, including, for example, key users and locks in a domain. One or more lock configuration files 1712 can also be associated with each domain. In some embodiments, a lock configuration file contains key access information associated with an electronic lock. The domain file can be created or modified by an access control administration application program (an “admin application”). In some embodiments, the administrative application and the domain file can be stored on a master key 1742, such as an electronic access apparatus (e.g., a cell phone or electronic key), on a computer 1730, or on both. In some embodiments, master keys have administrative privileges only in the domains in which they are assigned. In some embodiments, master keys and slave keys can have access privileges for locks in any domain. A domain file can be password protected to increase the security of an access control system. In some embodiments, a person possessing a master key is allowed to use the admin application to modify the domain file and lock configuration files on the master key. For example, the person could reconfigure the domain file and lock configuration files to remove other master keys from the domain. In some embodiments, the user can directly edit domain files and lock configurations via an application on the computing device or directly with the electronic access apparatus (e.g., an app on a smart phone). However, in some embodiments, a person must also know a domain password in order to be able to modify the domain file and lock configuration files or access the application. In this embodiment the access control system 1700 can be stored locally on the electronic apparatus (e.g., key, smart phone, computer). The electronic apparatus can communication via a wired or wireless connection to program and synchronize of the master and slave keys devices. In some embodiments, the master key does not have to communicate with the slave key. The master key can update the lock with the slave key public identifier (e.g., a phone number) and the slave key can then update its private identifier to the lock upon a first access. The slave key can do this without interacting with the master key.

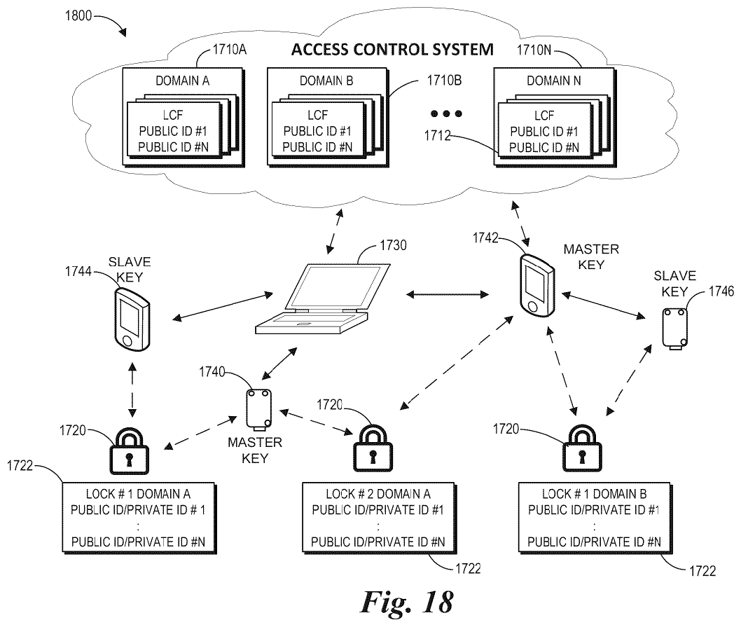

FIG. 18 illustrates an embodiment of and access control system 1800 operating in a distributed operating environment (e.g., a cloud-based system). In the distributed operating environment, the master keys and slave keys function in the same manner as described in association with FIG. 1. However, in the distributed operating environment, the access control system 1800 is accessible over a network using an account-based system. The account-based system allows computing device to access the access control system information over a network (e.g., the Internet). The access control system 1800 stores domain information, associated lock configuration files, and other associated information on a remote computing device, such as a server. The access control system 1800 has a network-based user interface that allows a user to login to an account. The account can be an administrator account, also referred to as a master account or a user account. The account can have one or more domains associated with the account. Each domain can have one or more locks associated with the account. An account with administrator privileges for a domain can manage the domain and lock configuration files. The access control system 1800 can be used to provide the files onto a local computing device in order to program and access the locks within a domain.

The access control system can use public identifiers and private identifiers to determine access to the locks. Additional information regarding using public identifiers and private identifiers is provided in U.S. Pat. Nos. 8,035,477, and 8,339,239, which are incorporated by reference in its entirety.

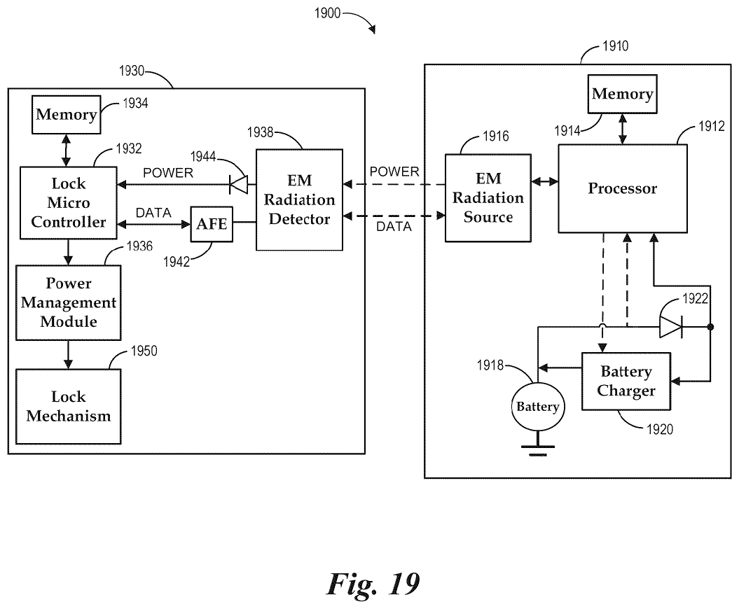

FIG. 19 is a block diagram of an embodiment of an electronic lock and key system 1900 including an electronic access apparatus 1910 and an electronic lock 1930. The electronic access device 1910 can include a housing that contains a processor 1912 that is connected to a memory 1914. The electronic access device 1910 can be a dedicated electronic key (e.g., a single purpose computing device), a mobile computing device, such as a cellular phone, a smart phone, or other computing device capable of communicating with the electronic lock 1930. In some embodiments, the processor is a microcontroller 1912. The memory 1914 can be a nonvolatile memory device, such as NAND flash memory. The memory 1914 can also include a memory card or other removable solid state media such as, for example, a Secure Digital card, a micro Secure Digital card, etc. The microcontroller 1912 can also have an optional integrated memory (not shown). In some embodiments, the electronic access device 1910 can include a display. The display can be a LED, LCD, touch screen display, or other type of display. In some embodiments the electronic access device 1910 can have one or more buttons or controls can be configured to operate the electronic access device 1910. In some embodiments the buttons or controls can be integrated into the display.

The processor 1912 forms part of a circuit that can include a diode 1922, such as a Schottkey Diode, a battery charger 1920, a battery 1918, and other circuit components such as resistors, a ground plane, pathways of a lock connector, and other pathways. In one embodiment, the electronic access apparatus 1910 includes an external lock connector, such as, for example, a physical connector that is compatible with a USB connector.

The battery 1918 can be any suitable rechargeable battery, such as, for example, a lithium-ion battery, and can be configured to provide a suitable electric potential, such as, for example, 3.7 volts. The battery 1918 can be placed between a ground, such as Pin 4 of the USB connector, and a diode 1922. The electronic access apparatus can also include a detection circuit. For example, a reference integrated circuit or a Zener diode or voltage reference derived from the power bus feeding (or Pin 1) can be provided to a reference input for a comparator. The diode 1922 can be a diode with a low forward voltage drop, such as, for example, a Schottky diode, an energy efficient diode, or another type of diode. In some embodiments, another type of switching device can be used in place of the diode 1922. The diode 1922 is oriented to allow current to flow from the battery 1918 to the electrical input of the microcontroller 1912 and the battery charger 1920. The output of a detection circuit can be connected to a computer mode interrupt or reset of the key microcontroller.

The electronic access apparatus 1910 includes an electromagnetic radiation source 1916 that is configured to transmit electromagnetic radiation, such as radio frequency signals, optical light signals, and other electromagnetic radiation. The electromagnetic radiation source 1916 can be an optical light source, such as a light on a cellular phone, flashlight, an antenna, or other source capable of transmitting electromagnetic radiation. In some embodiments, the electromagnetic radiation source can transmit and receive electromagnetic radiation. For example, in some embodiments the electromagnetic radiation source 1916 can be configured to send and receive signals based on radio frequency identification (RFID) and near field communication (NFC) standards. In some embodiments, a photocell, antenna, or sensor can be used to receive data transmitted by an electromagnetic radiation receiver 1938 on the electronic lock 1930.

The electromagnetic radiation source 1916 is configured to transmit a power signal and a wireless digital data signal to the electronic lock 1930. The electromagnetic radiation source 1916 is configured to transmit a power signal to the electromagnetic radiation receiver 1938 on the electronic lock 1930. The wireless digital data signal is configured to communicate information for accessing and programming the lock 1930. If the electronic access apparatus 1910 is a master key, the digital data signal can include information such as a key access information file that is used to program the electronic lock. If the electronic access apparatus 1910 is a slave key or a master key being used to access the electronic lock, the digital data signal can include key identifiers, such as a public identifier and a private identifier. In some embodiments one or more, public and private identifiers can be sent to the electronic lock. In some embodiments, only the private identifier or identifiers are sent. The digital data signal can include a lock instruction that instructs the lock 1930 to lock, unlock, or temporarily unlock. In some embodiments, the lock 1930 toggles the current state of the lock (e.g., from lock to unlock or visa-versa) without receiving a lock instruction from the electronic key 1910.

The electromagnetic radiation source 1916 is configured to transmit a wireless power signal to the electronic lock to provide power to the electronic lock sufficient to actuate a lock mechanism 1950 within the electronic lock 1930. The power signal from the electronic access apparatus 1910 is capable of actuating the electronic lock 1930 even when there is no electrical conductor power connection to the electronic lock. In other words, the electronic lock is not physically connected to a permanent power supply (e.g., electrical mains or a battery). In some embodiments, the electronic key 1910 is the only source of electric power for the electronic lock. In some embodiments, the electronic key 1910 and/or light incident on a photovoltaic cell electrically connected to the electronic lock are the only sources of electric power for the electronic lock. In certain embodiments, the electronic access apparatus 1910 does not have an electric power transmission interface that mechanically mates with a specific electric power reception interface of the electronic lock.

In some embodiments, the electronic access apparatus 1910 can include a display with a user interface (e.g., a screen on a mobile phone) that displays a visual indication of a status of the electronic lock. The display can have control elements that are configured to control the operation of the electronic lock. For example, the user display can have buttons for a user to access the lock 1930, such as lock, unlock, and temporarily unlock commands. The display can also be used to perform other administrative functions on the lock, such as programming the lock. A dedicated electronic key may have physical buttons that the user can press. In some embodiments the dedicated electronic key can have one or more light-emitting diodes that display the current status of the lock. In some embodiments, the electronic apparatus does not use buttons to access or program a lock. Rather, the electronic apparatus can automatically access and program the lock.

The electronic lock 1930 includes memory 1934, a lock microcontroller 1932, an electromagnetic radiation receiver 1938, a power management module 1936, and an lock mechanism (e.g., electronic latch) 1950. In some embodiments, the memory 1934 and power management module 1936 can be incorporated into the microcontroller 1932. The electronic lock 1930 can include electric circuitry that includes a Schottky diode 1944 between the microcontroller 1932 and the electromagnetic radiation receiver 1938. The electronic lock can include a signal processing circuit 1942. The memory 1934 can be a nonvolatile memory device, such as NAND flash memory. The microcontroller 1932 can also have an integrated memory.

The electromagnetic radiation receiver 1938 can be hardware configured to receive electromagnetic radiation. For example the electromagnetic radiation receiver 1938 can be an antenna, a photovoltaic cell, a sensor or other component capable of receiving electromagnetic radiation. The electromagnetic radiation receiver 1938 is configured to can comprise one or more components. The electromagnetic radiation receiver 1938 is configured to receive, at least, a wireless digital data signal, and a wireless power signal from an electronic access apparatus 1910. The power signal and the data signal can be discrete signals that are received and processed separately. In some embodiments, the power signal is superimposed on the digital data signal. In some embodiments, the power signal and the data signal can be integrated into the power signal by pulsing the electromagnetic radiation on and off, the data can be modulated in the frequency-domain, time-domain, spatially, or in any combination. The electromagnetic radiation can be demodulated by the receiver on the electronic lock 1930. The power signal can be received and be transferred to the microcontroller 1932 through the diode 1944. In some embodiments, electronic lock does not include the diode 344. The data signal can be received and processed, or demodulated by the signal processing circuit (Analog Front End (AFE)) 1942. In some embodiments, the AFE 342 and electromagnetic radiation receiver 338 can be integrated into the same unit. The signal processing circuit can process and filter or demodulate the digital data signal before it is received by the microcontroller 1932.

In some embodiments, the electromagnetic radiation receiver 1938 can comprise multiple detector elements. For example, there can be a detector element that is configured to receive the data signal and a different detector element that is configured to receive the power signal. In one embodiment, the electromagnetic radiation receiver is a photovoltaic cell that is configured to receive the data signal and the power signal from the electronic access apparatus 1910. A photovoltaic cell is configured to convert electromagnetic radiation (e.g., optical light) to energy to power the lock microcontroller. The electromagnetic radiation detector 1938 can receive data signals via the electromagnetic radiation receiver 1938. In some embodiments the electromagnetic radiation detector can comprise a transceiver that can transmit and receive electromagnetic radiation. In some embodiments the electronic access apparatus 1910 can be greater than 0.5 centimeters from the electronic lock 1930 when providing the power signal to the electromagnetic radiation receiver 1938. In some embodiments the distance from the electromagnetic radiation receiver 1938 can be less than or equal to about four centimeters, and in some embodiments, less than or equal to about ten centimeters. In some embodiments, the electronic lock 1930 has a receiver mechanical configuration that need not match a mated transmitter mechanical configuration of the electronic access apparatus 1910 in order to receive the power signal or data signal. The wireless power signal is configured to provide power for powering all the circuits, including the microcontroller 1932, the power management module 1936 and the lock mechanism 1950.

The microcontroller 1932 is configured to control operation of the lock mechanism based on the digital data signal received from the electronic key 1910. The microcontroller 1932 can determine whether the key identifiers received from the key match the key access information stored in memory. The microcontroller 1932 can send a signal to the lock mechanism 1950 to actuate the lock if the key identifiers match. The microcontroller 1932 can also receive key instructions for operating the lock, such as lock, unlock, or temporary unlock, from the electronic access apparatus 1910. In some embodiments, the microcontroller 1932 can operate the lock mechanism without specific key instructions. For example, the microcontroller can toggle the lock from a locked state to an unlocked state or visa-versa. The microcontroller 1932 can also default to a temporary unlock state rather than toggling the state of the lock.

In operation, the microcontroller 1932 can boot up automatically when a sufficient amount of power is received from the power signal to satisfy a power threshold. In some embodiments, a boot up circuitry can be used to monitor the power level until a threshold voltage is satisfied, as microcontrollers can sink most of the current during the bootup phase. In one embodiment a power-on-reset device can be used to measure the boot threshold and the microcontroller via an analog switch. After the microcontroller boots, the power-on-reset device can be shutdown to reduce overall system power consumption. The lock microcontroller 1932 can communicate with the processor 1912 via data signals that are transmitted and received by the electromagnetic radiation receiver 1938.

In some embodiments, a digital data signal can cause the microcontroller 1932 to enter a lock connection mode. When in the lock connection mode, the processor 1912 can communicate with the lock microcontroller 1932 via the second electromagnetic radiation receiver. When certain criteria are satisfied, the lock microcontroller 1932 can perform various operations, such as, for example, erasing a lock memory or replacing key access information stored in the lock memory 1934.

The power management module 1936 and or microcontroller 1932 can monitor the electrical energy level in the lock 1930 and determine when the electrical energy level satisfies a specific threshold. The power management module 1936 can provide power to actuate the lock mechanism 1950 after the electrical energy level of the electronic lock satisfies an electrical energy level threshold. For example, the electrical energy can be stored in one or more capacitors in the electronic lock 1930. The electrical energy can be stored within the capacitors at a first voltage, based on an output voltage of the front end 2042. The time period in which the capacitors are charging can be referred to a charging mode, or a first mode of operation. During the charging mode, the micro controller 1932 can continue to authenticate the access device as the capacitors continue to store the electrical energy received from the power signal of the electronic key 1910. The power management module 1946 and/or microcontroller 1932 can monitor the charge of capacitors within an electric circuit and, when the microcontroller authenticates the electronic key and the charge satisfies the charge-based threshold, the microcontroller can instruct the power management module to provide power to the lock mechanism in order to actuate the lock mechanism. In some embodiments, the threshold can be a time-based threshold, in which the threshold is based on an amount of time that has after powering up the microcontroller. When the determined threshold has been satisfied, the electronic lock can transition from the charging mode to the actuation mode.

In some embodiments, the power management module 1946 can utilize an electric circuit that is configured to increase the voltage above the voltage level of the power signal. For example, in one embodiment, the electric circuit can be configured to increase a voltage value that is not greater than 2.7 volts to a voltage value between 3.6 volts and 6.8 volts. In some embodiments, the power management module can use switches and capacitors to double or triple the voltage. This can be more efficient than using a power regulator such as a switching regulator, which has significant switching losses. The configuration of the power management module 1946 can minimize power waste by only using one switch cycle to increase the voltage.

The lock mechanism 1950 can be an electronic latch. The lock mechanism 1950 can actuate between a locked state and an unlocked state based on a signal received from the microcontroller 1932. The lock mechanism 1950 can toggle between the locked and unlocked state. In other words, the lock mechanism 1950 can change the state of the lock mechanism from locked to unlocked, or visa-versa. The lock will remain in the new state permanently without power, or until it has received another command from the microcontroller 1932. In some embodiments the lock mechanism 1950 can have a temporary unlock state. In the temporary unlock state; the lock mechanism 1950 actuates the lock from the locked state to the unlocked state for a defined period of time. The defined period of time can be one second, two seconds, 5 seconds, or other period of time that the actuator can sustain based on the power provided by the electronic access apparatus 1910. This period of time can be determined by size of the reservoir capacitor, efficiency of the sensor, and the strength of the wireless power signal. After the defined period of time, the lock mechanism 1950 reverts back to the locked state. The lock mechanism can be a small efficient motor, piezoelectric latch or another style of latch or actuator that permits a relatively small amount of energy to actuate the latch. For example, the lock mechanism 1950 may include a Servocell AL1 or AL3, an actuator available from Rutherford Controls.

The power signal provided by the electronic access apparatus 1910 provides power to actuate the lock mechanism 1950. In some embodiments, the lock mechanism 1950 is capable of actuating between the locked state and the unlocked state with less than or equal to about 10 milliwatts total lock system power consumption. The peak power usage of the capacitor(s), the lock microcontroller 1932, the power management module 1946, and the lock mechanism 1950 during actuation of the lock can be less than or equal to about 120 milliwatts. In some embodiments, the microcontroller 1932 can use less than or equal to 1 milliwatt of power, less than or equal to 5 milliwatts of power, or less than or equal to 10 milliwatts of power. In some embodiments, the power management module 1946 can use less than or equal to 0.5 milliwatts, less than or equal to 1 milliwatt, or less than or equal to 5 milliwatts. In some embodiments, the lock mechanism 1950 can use less than or equal to 75 milliwatts, less than or equal to 90 milliwatts, less than or equal to 100 milliwatts, or less than or equal to 120 milliwatts.

The capacitor(s), the lock microcontroller 1932, the power management module 1946, and the lock mechanism 1950 are configured to use a combined total of electric energy less than or equal to 100 millijoules in order to actuate the lock mechanism between the locked state and the unlocked state or vice-versa. In some embodiments, the combined total energy usage can be less than or equal to 20 millijoules, less than or equal to 25 millijoules, or less than or equal to 50 millijoules. In some embodiments, the combined total energy usage can be between 10 and 20 millijoules.

In some embodiments, the total energy consumption of the lock microcontroller 1932 can be less than or equal to 3 millijoules, less than or equal to 5 millijoules, less than or equal to 10 millijoules, or less than or equal to 25 millijoules. In some embodiments, the total energy consumption of the power management module can be less than or equal to 1 millijoules, less than or equal to 2 millijoules, less than or equal to 3 millijoules, or less than or equal to 5 millijoules. In some embodiments, the total energy consumption of the lock mechanism can be less than or equal to 15 millijoules, less than or equal to 20 millijoules, less than or equal to 25 millijoules, or less than or equal to 50 millijoules.

In some embodiments, actuation of the lock mechanism can be accomplished by storing electrical energy in one or more capacitors and increasing a first voltage output from the capacitor(s) to a second voltage output that is within the limits of the lock mechanism. The second voltage output can be the same or greater than a voltage of a lock actuation threshold of the lock mechanism 1950. When the lock mechanism draws power, the latch can actuate before the voltage drops below the actuation threshold. In one embodiment, the piezo latch mechanism can initially draw up to 15 mA for approximately 50 ms to 75 ms in order to change states. One or more capacitors can be used to store energy and to provide the initial supply of current. In one embodiment, the electronic lock can use two capacitors in order to supply the sufficient amount of current to actuate the lock mechanism. In some embodiments, the electronic lock does not include a voltage regulator. In some embodiments, the power management module can be integrated into the microcontroller.

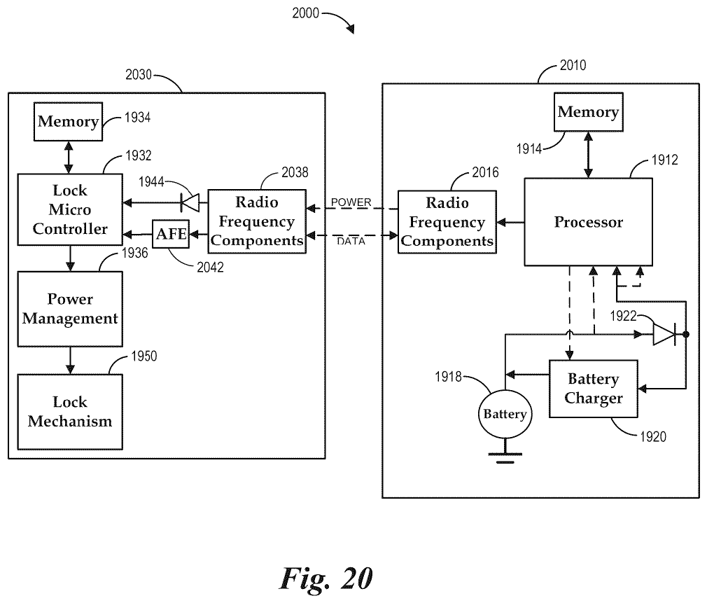

FIG. 20 is a block diagram of another embodiment of an electronic lock and key system 2000 including an electronic access apparatus 2010 and an electronic lock 2030. In this embodiment, the electronic key 2010 includes a housing that contains a processor 1912, memory 1914, a battery 1918, and a battery charger 1920, which are substantially the same as the components having the same reference numbers and described in association with FIG. 3. The electronic lock includes microcontroller 1932, memory 1934, power management module 1936, and lock mechanism 1950, which are substantially the same as the components having the same reference numbers and described in association with FIG. 19.

The electronic access apparatus, such as a smart phone or electronic key, 2410 also includes radio frequency (RF) components 2016 for communicating with the electronic lock 2030. In some embodiments, the electronic access apparatus 2430 and the electronic lock 2030 can use radio frequency identification (RFID) and/or near field communication (NFC) protocols to communicate and provide power. The RF components 2016 on the electronic access apparatus 2010 can include, for example, an antenna, a transceiver, modulator and a decoder/demodulator. The electronic lock 2030 can include corresponding RF components 2038, such as a transponder. Radio frequency based communication can be established between the processor 1912 in the electronic access apparatus 2430 and the microcontroller 1932 in the electronic lock 2030. The RF communication can allow the transfer of power between the electronic access apparatus 2430 and the electronic lock 2030. The power can be transferred via contactless inductive coupling between the electronic access apparatus 2430 and the electronic lock 2030 In some embodiments, the power transfer can occur when the electronic access apparatus 2430 is positioned at up to four centimeters from the electronic lock 2030. In some embodiments, it can be up to ten centimeters.

In this embodiment, the power provided by the electronic access apparatus 2430 can provide enough power to boot the microcontroller 1932, power the power management module 1936 and actuate the lock mechanism 1950. In order to activate the lock mechanism 1950 the power management module 1936 may need to increase the voltage of the power signal received from the electronic access apparatus 2010. In some embodiments, the power management module 1936 can use switches and capacitors to increase the voltage rather than a voltage regulator device. In one embodiment, the voltage value of the power signal is not greater than 2.7 volts and is increased to a voltage value between 4 volts and 6.8 volts in order to actuate the lock mechanism. In some embodiments, the voltage value may not need to be boosted to actuate the lock mechanism. In some embodiments, the receiver can be designed or selected to supply a sufficient amount of voltage and power to the lock. The microcontroller can monitor the voltage threshold and operate within the min and max specifications of the locking mechanism.

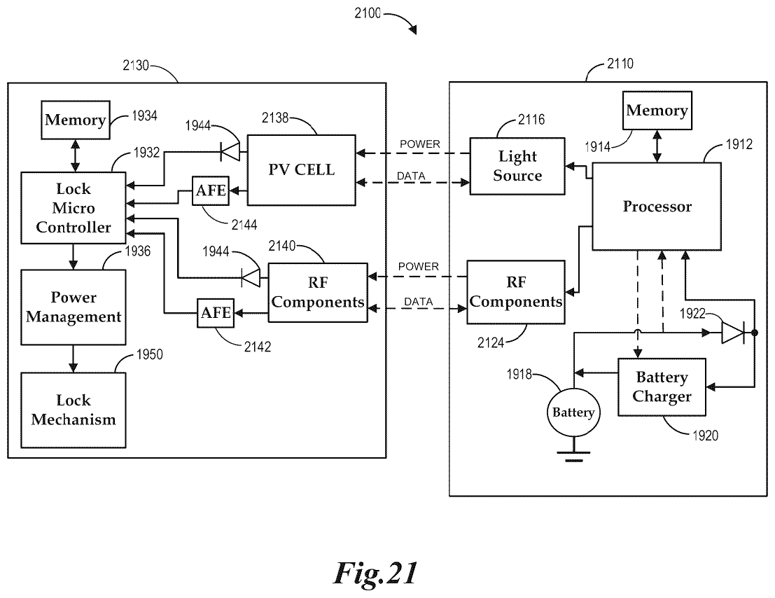

FIG. 21 is a block diagram of another embodiment of an electronic lock and key system 2100 including an electronic access apparatus 2110 and an electronic lock 2130. In this embodiment, the electronic access apparatus 2110 includes a housing that contains a processor 1912, memory 1914, a battery 1918, and a battery charger 1920, which are substantially the same as the components having the same reference numbers and described in association with FIG. 3. The electronic lock 2130 includes a microcontroller 1932, memory 1934, power management module 1936, and lock mechanism 1950, which are substantially the same as the components having the same reference numbers and described in association with FIG. 19.

The electronic access apparatus 2110, such as a smart phone, 2110 includes an optical light source 2116 and radio frequency components 2124. The optical light source 2116 is configured to emit optical light from the electronic access apparatus 2110 to provide power to the electronic lock 2130. The RF components 2124 include an antenna and necessary components necessary to emit and receive radio waves. The RF components are configured to transmit digital data signals to the electronic lock 2130. The RF components can also receive digital data signals from the electronic lock 2130. Combining both RF and PV components can increase the supply of power to the electronic lock 2130, which can result in quicker access and/or provide auxiliary power for added features such as an LED or display. In some embodiments, the electronic access apparatus 2110 is configured to transmit both power and data signals from the optical light source 2116 and the RF components 2124. In some embodiments, the optical light source only provides the power signal and the RF components only provide the data signal.

The electronic lock 2130 includes a photovoltaic cell 2138 and corresponding RF components 2140. The photovoltaic cell 2138 is configured to convert electromagnetic radiation (e.g., optical light) to energy to power the lock microcontroller 1932, the power management module 1936, and the lock mechanism 1950. The photovoltaic cell 2138 can have an associated signal processing circuit 2144 to process a digital data signal. The RF components 2140 are configured to receive a digital data signal from the electronic access apparatus 2110. The RF components 2140 are also configured to transmit digital data signals to the electronic access apparatus 2110. The RF components 2140 can have an associated signal processing circuit 2142 to process a digital data signal. In some embodiments, the RF signal can also supply a portion of the power by powering analog front end device. In some embodiments, the electronic access apparatus 2110 is configured to transmit both power and data signals from the optical light source 2116 and the RF components 2124. In some embodiments, the optical light source only provides the power signal and the RF components only provide the data signal. In such embodiments, the signal processing circuit 2144 associated with the photovoltaic cell can be omitted and/or the diode 1944 associated with RF components 2140 can be omitted. In some embodiments, the diode 344 is not included.

The electronic access apparatus 2110 can transfer power to the electronic lock 2130 via the optical light source 2116. The optical light source 2116 is configured to emit optical light onto the photovoltaic cell 2138 on the electronic lock 2130. The photovoltaic cell 2138 is configured to convert the optical light to power. After sufficient power has been transferred from the electronic access apparatus 2110 to the electronic lock 2130, the microcontroller 1932 boots up and can process the digital data signal received at the RF components 2140. The microcontroller 1932 verifies the key identifiers and sends the command to actuate the lock mechanism 1950.

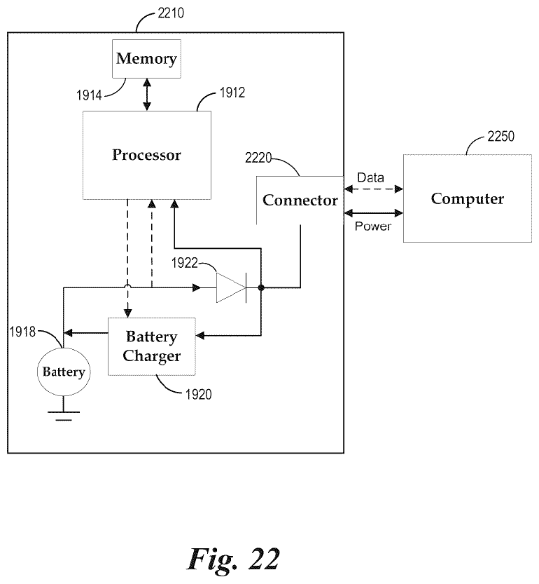

FIG. 22 shows a detailed block diagram of an embodiment of a computer 2250 connected to an electronic access apparatus 2210 that includes a rechargeable battery 1918 via a connector 2220. The computer 2250 can be, for example, a device containing a host USB interface, a desktop computer, a flash drive, a notebook computer, a handheld computer, a mobile phone, or another type of computing device. The computing device 650 can communicate wirelessly with the electronic lock.

In one embodiment, the electronic access apparatus 2210 is connected to the computer via a USB connector 2220. When Pin 1 of the USB connector is connected to a powered USB pin (for example, on a computer 2250 or on a USB charging device, not shown), the electric potential on Pin 1 is higher than the electric potential at the battery 1918 terminal, the output of the comparator changes, and the diode 1922 is open or “off.” In this state, the electric potential on Pin 1 is substantially equal to the electric potential supplied by a powered USB bus when the USB connector is plugged into a computer. The output change of comparator will trigger the computer mode interrupt or reset of the processor 1912. The processor 1912 will enter a computer connection mode. In PC mode that computer can update the keys LCF files to reconfigure the lock and also allow the key to be used a USB memory storage thumb or flash drive. In some embodiments, the USB connector can have four pathways or pins: a power supply pin (Pin 1), a data with clock recovery pin (Pin 2), a data and clock pin (Pin 3), and a ground pin (Pin 4). The D− pin (Pin 2) and D+ pin (Pin 3) are used to transmit differential data signals with encoding that the USB transceivers use to recover a clock. The computer can supply USB data with clock recovery encoding via pins of the computer's USB interface. The USB transceiver can assist in communications between the key and the computer 2250. In some embodiments, the processor 1912 provides instructions to the battery charger 1920 for charging the battery 1918 while in the computer connection mode. For example, the battery charger 1920 can be a Linear Tech LTC4065L from Linear Technology of Milpitas, CA, a battery charger for a lithium ion battery, or another suitable battery charger.

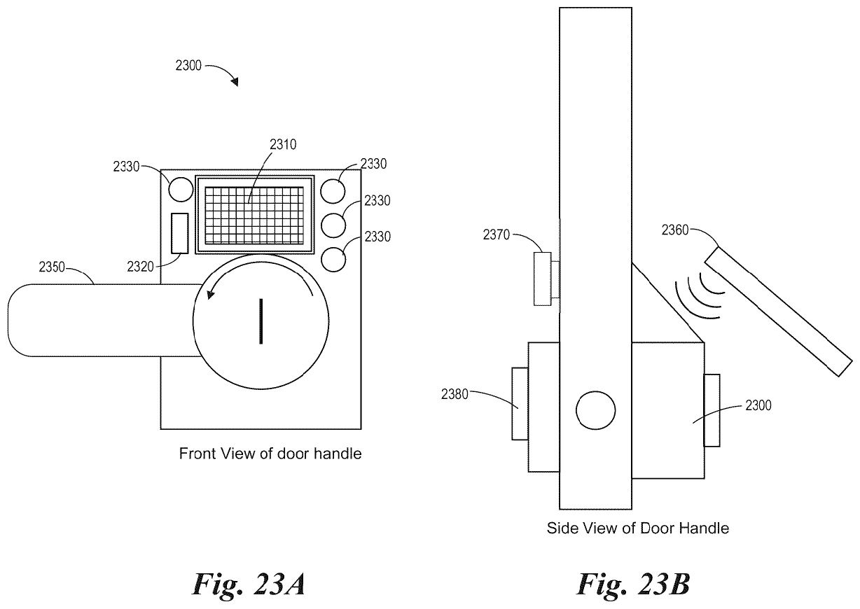

FIGS. 23 and 23B illustrate and embodiment of an electronic lock 2300. FIG. 23A illustrates a front view and FIG. 23B illustrates a side view of the electronic lock 2300. The electronic lock 2300 includes an electromagnetic radiation detector 2310, such as a photovoltaic cell or antennae or both, an electrical interface port 2320, a plurality of light-emitting diodes (LED) 2330, and a handle mechanism 2350. The electromagnetic radiation detector 2310 can be configured to convert optical light or RF signals to energy as described in association with FIGS. 19, 20 and 21. The electrical interface port 2320 can be a USB port or other type of mechanical port that establishes communication with the microcontroller of the electronic lock 2300. The port 2320 can be used as a secondary source of the power and/or data communication for the electronic lock 2300 if an electronic access apparatus is not available to provide power to the electronic lock 2300 via the electromagnetic radiation detector 2310.

In some embodiments, the LEDs 2330 can be configured to have different colors to indicate a status of the lock 2300. The LEDs 2330 can illuminate after the electronic lock 2300 has received power. For example, each LED 2330, or a combination of LEDs could represent a different state of the lock, such as locked, unlocked, lock programmed, processing, key identifier accepted, or other status. The microcontroller of the lock can control which LED illuminates.

FIG. 23B helps illustrates an embodiment of the shape of the housing of the electronic lock 2300. The electronic lock 2300 can be shaped such that the electromagnetic radiation detector 2310 can be more easily disposed to receiving optical light from solar radiation when using a photovoltaic cell and the lock 2300 is outside. The angle of the photovoltaic cell can also help to facilitate communication between the electronic lock 2300 and an electronic access apparatus 2360. In some embodiments, the electronic lock 2300 can be configured so that it is substantially planar with the door.

FIG. 23B also illustrates an embodiment of a lock handle 2370. The lock handle 2370 can provide a mechanical interface for controlling the state of the lock mechanism (e.g., locked or unlocked). The lock handle 2370 can be used to generate electrical energy based on the physical manipulation of the lock handle 2370. When the lock handle 2370 is rotated, or otherwise manipulated, in a first direction, the lock can be set in a first state, such as an unlocked state. When the lock handle 2370 is rotated, or otherwise manipulated, in a second direction, the lock can be set in a second state, such as a locked state. The lock handle 2370 can be used to set the state independent of an electronic key and can be configured so no authentication is required to lock or unlock the lock mechanism. In some embodiments, the door handle 780 can provide the same functionality as the lock handle 2370 without requiring an additional mechanical interface. In one embodiment, the lock handle 2370 can interface with the electronic lock 2030 as illustrated in FIG. 20. The electronic lock can have the same energy and power requirements as discussed herein.

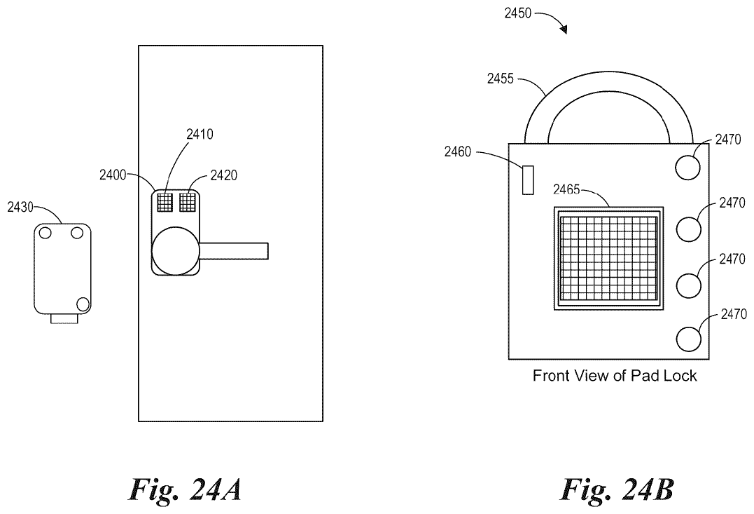

FIG. 24A illustrates another embodiment of an electronic lock 2400 and an electronic access apparatus 2430. In this embodiment the electronic lock 2400 has a first electromagnetic radiation detector 2410, such as a photovoltaic cell or antennae and a second electromagnetic radiation detector 2420, such as a photovoltaic cell or second antennae. The first electromagnetic radiation detector 2410 is configured to unlock the electronic lock and the second electromagnetic radiation detector 2420 is configured to lock the electronic lock. In some embodiments, the microcontroller can measure the voltage differences between two or more coils to determine direction and/or movement associated the electronic apparatus. The direction and/or movement information can be used to determine the lock instruction, such as a lock or unlock instruction. The electronic access apparatus 2430 can be a button-less controller that can lock or unlock the lock 2400 based on which electromagnetic radiation detector receives power from the electronic access apparatus 2430. In some embodiments, an electronic button-less key can be used with only a single electromagnetic radiation detector by toggling from lock to unlock. In one embodiment, this can be done by writing the state of the lock in nonvolatile memory of microcontroller once a match is determined and before the microcontroller decides to actuate the lock mechanism. In these instances, the photovoltaic cell can cause the lock mechanism to toggle the current state of the lock (e.g., lock to unlock and visa-versa). In some embodiments, the electronic apparatus can determine a direction and/or movement of the electronic apparatus in order to determine the lock or unlock instruction to be sent to the electronic lock. For example, the electronic apparatus can include an accelerometer. The electronic key apparatus be configured such that it does not include any buttons.

FIG. 24B illustrates a mobile electronic padlock 2450. The electronic padlock 2450 includes an electromagnetic radiation detector 2465, such as a photovoltaic cell or antennae, an electrical interface port 2460, a plurality of light-emitting diodes 2470, and a lock mechanism 2455. The electronic padlock functions in substantially the same manner as the other electronic locks described herein. In some embodiments, the electronic padlock 2450 can also include a geographic location component that is configured to only allow access to the lock when the lock is within a specific geographic area. The electronic access apparatus, such as a smart phone, can provide the global positioning system (GPS) location in order to determine the location of the padlock 2450. The padlock 2450 can be configured to unlock or lock, only if the lock is within a specific geographic area (e.g., specific geographic coordinates). This can be the case even if the key identifiers match. In some embodiments, the padlock 2450 can have more than one geographic position associated with it (e.g., home and work).

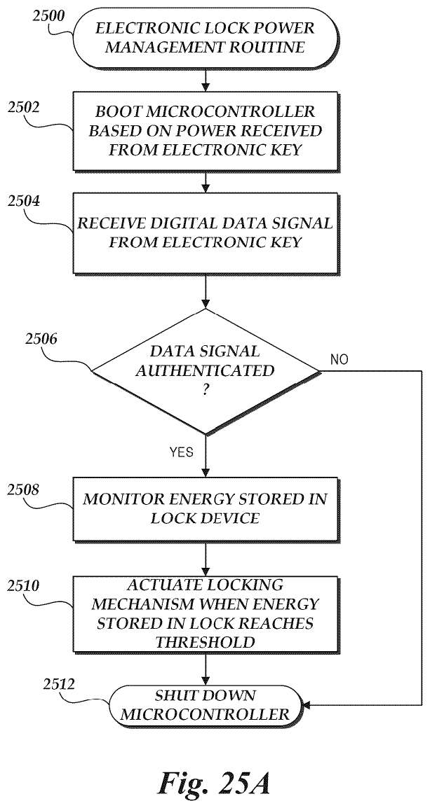

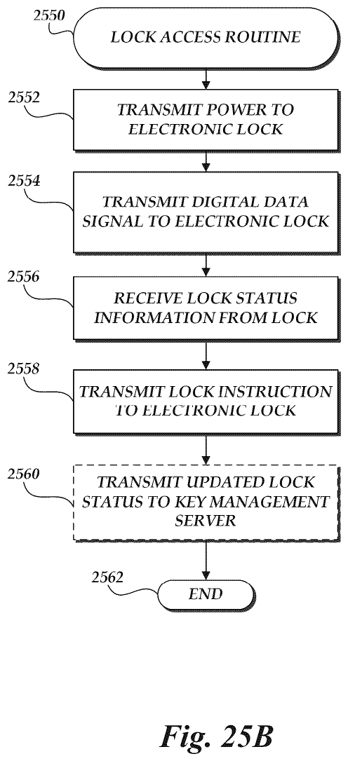

FIG. 25A is an embodiment of an electronic lock power management routine 2500. The electronic lock power management 2500 routine can be implemented by the microcontroller within an electronic lock. At block 2502, the microcontroller can boot up after the electronic lock has received power from the electronic access apparatus. The microcontroller can have a power threshold such that it boots automatically once enough power has been transferred from the electronic access apparatus to the electronic lock.

At block 2504, the microcontroller can process the digital data signal received from the electronic access apparatus. In some embodiments, the digital data signal can include key identifiers. The key identifiers can include at least one or more public key and/or at least one or more a private keys. At block 2506, the microcontroller authenticates that the digital data includes the correct authentication data. In one embodiment the microcontroller determines whether the key identifiers match the data stored in the key access information file stored in the memory on the electronic lock. If the authentication data provided in the digital data signal is incorrect, the microcontroller shuts down at block 2512. If the authentication data provided in the digital data signal is correct, then the routine proceeds to block 2508.

At block 2508, the microcontroller monitors the power received from the electronic access apparatus. The electronic access apparatus can transmit power simultaneously with the digital data signal. The power can continue to be stored within the electronic lock during authentication at blocks 2504 and 2506. At block 2510, the microcontroller sends the signal to actuate the lock mechanism when the electrical energy level reaches a lock activation threshold. In some embodiment, after the signal has been sent by the microcontroller, a power management module can boost the voltage of the power signal in order to actuate the lock mechanism. In some embodiments, the process of transferring power and authentication of the key can take less than about five seconds, less than about four seconds, less than about three seconds, less than about two seconds, less than about one second, or a time range between any of these times. The amount of time can be dependent upon the strength of the power signal and/or efficiency of the electromagnetic radiation receiver. A stronger power signal can decrease the amount of time and a weaker power signal can increase the amount of time. At block 2512, the microcontroller shuts down.

FIG. 25B illustrates an illustrative embodiment of a lock access routine 2550. The lock access routine can be implemented by an electronic access apparatus. At block 2552 the electronic access apparatus transmits a power signal to an electronic lock. The microcontroller boots up after receipt of the power signal and can communicate with the electronic access apparatus.

At block 2554, the electronic access apparatus transmits a digital data signal to the electronic lock. In some embodiments, the digital data signal can include key identifiers that are stored on the electronic access apparatus and used to access the lock. The key identifiers can include at least one or more private identifiers and/or one or more public identifiers. If the electronic access apparatus provides the correct authentication data (e.g., key identifiers), the electronic lock can provide lock instructions in order to actuate the electronic lock.

At block 2556, the electronic access apparatus receives information from the electronic lock providing the current status of the lock (e.g., locked or unlocked). The electronic access apparatus can provide the lock status to the user by way of a user interface display, an LED, or other indication. In some embodiments, the lock status will display on the electronic access apparatus, or smart phone and/or on the electronic lock. At block 2558 a lock instruction is transmitted from the electronic access apparatus to the electronic lock. The lock is actuated based on the lock instruction.

At block 2560, optionally before or after the lock has actuated the electronic access apparatus can transmit an updated lock status to an access control system, such as the access control system illustrated in FIG. 18. In some cases, the access control system can maintain the status of all the locks within each domain.

In some embodiments, the electronic access apparatus that is accessing the lock could send a message to the master key and/or access control system via a text message or using an application providing a notification that the lock has been accessed. In some embodiments, the access control system can maintain the status of all the locks within each domain.

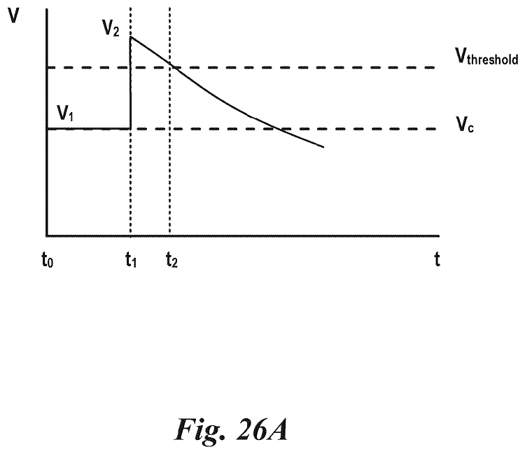

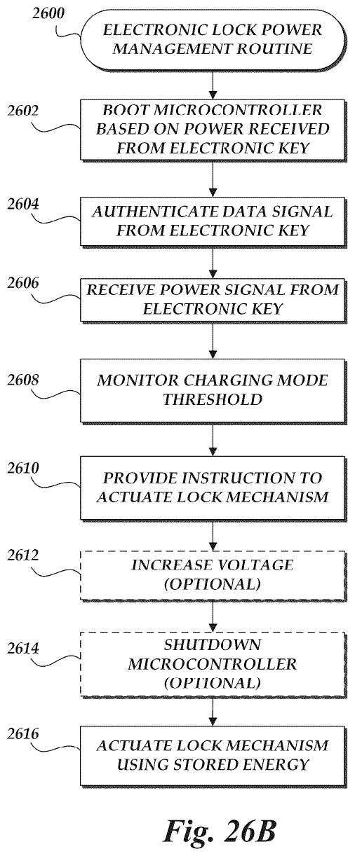

FIG. 26A illustrates an embodiment of plot illustrating voltage over time during an actuation of a lock mechanism. The plot is not drawn to scale and has been enlarged for illustrative purposes. Voltages on the y-axis and time is on the x-axis. The dashed line V_{c} represents a voltage output from the at least one capacitor and Vₜ is the voltage actuation threshold of the lock mechanism. The first voltage value, V₁, represents the voltage stored between t₀ and t₁. The second voltage value, V₂, represents an increased voltage value of the voltage output from the capacitor.

The time periods for the various modes of operation of the lock mechanism are illustrated. The time periods are not to scale and have been enlarged for illustrative purposes. A first period of time, between t₀ and t₁, represents a charging mode, or first mode of operation, of the electronic lock. A second period of time, between t₁ and t₂, represents an actuation mode, or second mode of operation.

During the charging mode of operation, at least one capacitor stores energy received from the wireless power signal. The energy that is stored by the capacitor(s) can be output at a first voltage represented by V₁. The first period of time can be based on satisfying a charge mode threshold. In some embodiments, the charge mode threshold can be a time-based threshold or a charge-based threshold. A time based threshold can be a determined period of time after the powering the microcontroller, such as 1 second, 2 seconds, 3 seconds, 5 seconds or other determined period of time. The charge-based threshold can be based on a charge of one or more capacitors. The charge state of the capacitor(s) can be monitored to determine when the charge state has satisfied the charge threshold. The length of time of the charge mode, between t₀ and t₁, can be less than 1 second, less than 2 seconds, less than 3 seconds, less than 5 seconds, or other period of time.

When the charge mode threshold is satisfied, the microcontroller 1932 can transition from the charge state to the actuation state. In the actuation state the microcontroller 1932 can send an actuation instruction to the power management module 1946. The actuation instruction can trigger the actuation of the lock mechanism 1950. The actuation instruction can trigger the power management module 1946 to boost the voltage from V₁ to V₂. The V₂ value is greater than the V₁ value and is at or above a voltage threshold for the actuation of the lock mechanism 1950. After the voltage has been boosted to V₂, the lock mechanism can be actuated using the stored energy from the capacitor(s). In some illustrative embodiments, V₁ is between 2 and 3 volts and V₂ is between 3.6 and 6.8 volts. In some embodiments, the voltage output of the capacitor(s), V_{c}, is at or above the voltage actuation threshold, Vₜ, of the lock mechanism 1950 and does not need to be increased to actuate lock mechanism 1950. The output voltage of the capacitor may be at or above actuation threshold of lock mechanism.

During the actuation mode, also referred to as an actuation time period, between t₁ and t₂, the voltage value is allowed to float or otherwise vary as the lock actuates. As illustrated, during the actuation the voltage value drops below the V₂ value and stays above the voltage actuation threshold, Vₜ, throughout the actuation period. In some embodiments, the voltage value is not controlled or regulated after initiation of the lock actuation by the microcontroller 1932 and power management module 1946. The length of time of the actuation mode, between t₁ and t₂, can be less than 1 second, less than 100 milliseconds, less than 50 milliseconds, or other period of time for the lock mechanism to actuate. Depending on the type of actuation, such as a lock or unlock actuation, the actuation time can vary. For example, in some embodiments the unlock operation can take more time than the lock operation. In some embodiments, the lock microcontroller can receive power from the electromagnetic radiation receiver during the first mode, the second mode, or both of modes of operation.

FIG. 26B illustrates an embodiment of an electronic lock power management routine 2600. The electronic lock power management routine 2600 can be implemented by the microcontroller 1932 within an electronic lock. At block 2602, the microcontroller can boot up after the electronic lock has received power from an electronic access apparatus. The microcontroller 1932 can have a power threshold such that it boots automatically once enough power has been transferred from the electronic access apparatus to the electronic lock.

At block 2604, the microcontroller authenticates that the digital data includes the correct authentication data. In one embodiment, the microcontroller determines whether the key identifiers match the data stored in the key access information file stored in the memory on the electronic lock.

At block 2606, the electronic lock receives a power signal from the electronic access apparatus. The electronic lock stores energy from the power signal in one or more capacitors. At block 2608, the charging mode threshold is monitored to determine when to transition from charging mode to the actuation mode. The charging mode threshold can be a time-based threshold for a charge-based threshold. When the threshold is satisfied, the microcontroller can transition from charge mode to the actuation mode.

At block 2610, the microcontroller can provide an instruction to actuate the lock mechanism. The construction can be based on instructions received from the electronic access apparatus. In some embodiments, the instruction can be based on information derived by the microcontroller based on the position of lock access apparatus relative to the electronic lock. For example, the lock and include two or more coils that allow the microcontroller to determine the position of electronic access apparatus based on a voltage difference between the coils. In some embodiments, the electronic apparatus can provide the instruction based on movement and/or position of the electronic apparatus.

At block 2612, the power management module can increase the voltage output from the one or more capacitors to a voltage value that is at or above a voltage actuation threshold of the lock mechanism. Depending on the output voltage of the capacitor(s), the output voltage may not need to be increased to satisfy the actuation threshold of the lock mechanism.

At block 2614, the microcontroller can shut down after providing the actuation command instruction. This is an optional step that does not necessarily need to be performed. In some embodiments, the microcontroller can continue to operate until the entire process has been completed as illustrated in FIG. 25A.

At block 2616, the lock mechanism is actuated using the energy stored in the one or more capacitors based on the actuation instruction. The voltage is allowed to float or otherwise vary during the actuation of the lock mechanism.

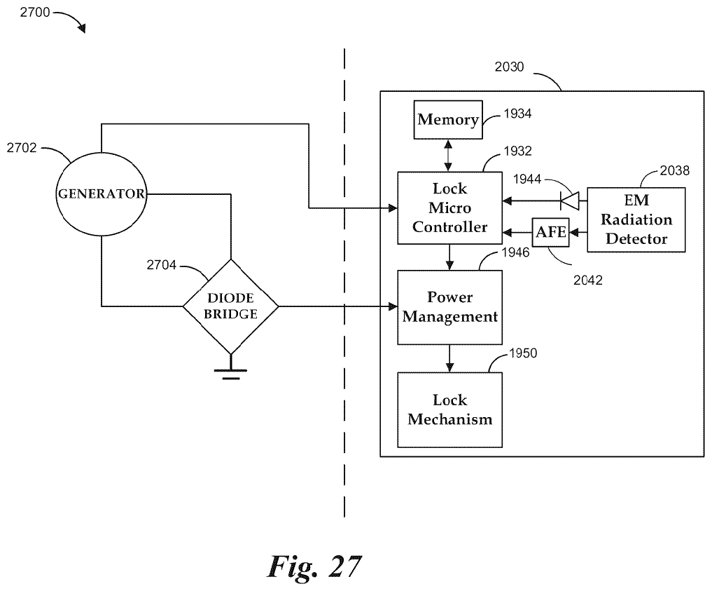

FIG. 27 illustrates an embodiment of an electronic lock that that interfaces with a lock handle or a door handle that is configured to actuate a lock mechanism using mechanical energy, such as the lock handle 2370 illustrated in FIG. 23B. The generator can be configured to generate mechanical energy from movement of the handle on the interior side of a door. This can allow lock mechanism to be actuated without using and electronic key. In this embodiment, the electronic lock 2700 includes a generator 2702 and the diode bridge 2704. No authentication is required to lock or unlock the door when using the lock handle on the inside door. The generator can generate the power to power the lock microcontroller 1932 and the lock mechanism 1950. The microcontroller 1932 and determine whether to lock or unlock the door based on the direction of the rotation of the lock handle. The microcontroller 1932 can then instruct lock mechanism to actuate according.

### Smart Locking Mechanics

The present disclosure provides embodiments of energy efficient smart lock systems, devices, techniques, and methods.

In some embodiments, an energy efficient locking system can electromechanically move a small barrier (also referred to as CAM) inside the lock to prevent or allow movement of a larger locking element, locking mechanism or component (e.g., a dead Bolt) by mechanical force applied by a user on the larger locking element. In some cases, the small barrier may controllably block the movement of a locking pin (also referred to as pin) or a latching element (also referred to as latch) that is configured to lock or maintain the locking element in place. In some cases, a locked state of a lock (e.g., a smart lock) may be referred to as No Access state where a user does not have access to the locking state of the lock and cannot move the locking element (e.g., to open a door). In contrast, an unlocked state of a lock may be referred to as Access state where a user has access to the locking state and can move the locking element (e.g., to open a door). In some cases, the locking system may move the small barrier using an electromechanical actuator (e.g., an electric motor) powered by a wirelessly charged power supply. In some examples, the power supply may comprise a capacitor that is charged by an antenna that receives an electromagnetic field from a transmitter (e.g., the electronic access device, electronic access apparatus, or electronic key) and converts the received electromagnetic field to a current or voltage provided or applied to the capacitor. For example, the antenna may comprise a coil that is magnetically coupled to a transmitted and is configured to convert a time varying magnetic field received from the transmitter to electric current or voltage. In some examples, the same antenna may be used to wirelessly communicate with the electronic access device (e.g., to send and receive data and instructions).

In some embodiments, the small size and low weight of the small barrier allows changing the state (temporarily or permanently) of the locking system between a locked (No Access) state and an unlocked (Access) state using a small amount of electromagnetic energy received from the electronic access device and stored in the power supply (e.g., a capacitor). In some cases, the locking system may include a small electromotor (e.g., a latch or linear motor coil) that moves the small barrier between positions that block or allow a locking element to move between the locked and unlocked states. In some cases, the small barrier (e.g., a CAM) may block or prevent the movement of the locking component (e.g., a dead bolt) via at least one intermediate component (e.g., a locking pin or a latch) that can limit the movement of the locking component and its motion can be constrained by the position of the small barrier. Advantageously mechanical link between the small barrier and the locking element via the intermediate components allows blocking or unblocking the movement of the locking component with a small movement of the small barrier by consuming electric energy wirelessly received from the electronic access device (or apparatus).

In some cases, such efficient power management designs are able to use an NFC link to power the smart lock. In some cases, to further reduce the power consumption during locking/unlocking process the barrier may be configured such that its position can be changed using low friction movements. In some embodiments, the barrier (CAM) or locking mechanisms may be moved by mechanical force provided by a user. In various embodiments, one or more of these features may be used in smart padlocks, smart door locks, or other types of smart locks so that they can be powered wirelessly using NFC (e.g., from a smart phone, a Keyfob, or other electronic access devices), or other near-field electromagnetic coupling methods, to operate without a battery.

### NFC Powered Lock Cylinders for Smart Door Locks

In some embodiments, to improve energy efficiency of a wirelessly powered smart lock, the wirelessly powered lock can include a small and/or low weight barrier configured to decouple a movement of a locking element (e.g., a dead bolt) from a user-controlled mechanical interface (e.g., a knob) using a clutch and a locking pin (herein referred to as pin). For example, when the barrier is at a first position (e.g., unlock position or Access position), it may constrain a movement of the pin such that moving (e.g., rotating) the user-controlled mechanical interface can move the locking element via mechanical coupling to pin, and when the barrier is at a second position (e.g., lock position or No Access position), the barrier allows the pin to move away when forced by the user-controlled mechanical interface causing the locking element to be mechanical decoupled from the user-controlled mechanical interface. In other words, when the pin is not blocked by the barrier, the user cannot move the locking element. In some cases, the barrier, and its movement between the first and second positions, may be configured to allow an electromotor to move the barrier between the first position to the second positions using a small amount of energy. In some cases, such small amount of energy may be wirelessly transferred from an electronic access device (e.g., controlled by a user) to a capacitor that supplies electric power to the electromotor or an electronic control circuit that controls the electromotor (also referred to as motor). As such, in some of the locking systems described herein, a locking element, which can be relatively large and heavy, is moved by mechanical force provided by the user but is locked in place by a small barrier that can be moved by the electrical energy transferred from an electronic access device. In some embodiments, the motor may comprise a small and efficient motor (e.g., a latch or linear motor coil). In some cases, the high power-efficiency of the locking system may allow charging a smart lock using NFC. In some embodiments, to further reduce power consumption, the barrier (e.g., a blocking barrier also referred to as CAM), may be configured to move along a near resistance free path when moving between the lock and unlock positions. In some cases, the light weight of the barrier combined with the low resistance movement allows a smart lock (e.g., a smart door lock) to operate free of battery and to be wirelessly powered via NFC by an electronic access device that is near or adjacent the smart lock.

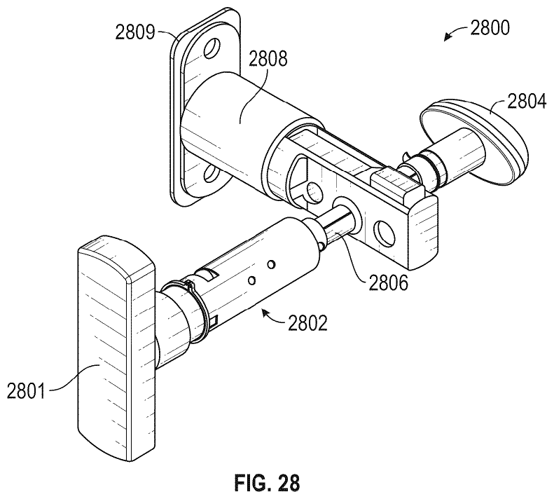

FIG. 28 illustrates a smart door lock assembly 2800 comprising an NFC lock cylinder (also referred to as lock cylinder) 2802 configured to be wirelessly powered and controlled by an electronic access device. In some embodiments, the door lock assembly 2800 may comprise, the lock clutch cylinder 2802, a first knob 2804 (e.g., an inside knob facing a room protected by the door lock assembly 2800), a second knob 2801 (e.g., an outside knob facing an area from which the room can be accessed), a clutch bar 2806, an enclosure 2808 that houses the dead bolt (when retracted) and a mechanical system that translates a rotational motion of the clutch bar 2806 to a linear motion of the dead bolt. In some cases, the lock clutch cylinder 2802 may comprise a clutch connected to the first knob 2804 via the clutch bar 2806. In some cases, rotating the clutch bar 2806 may control a linear position of the deadbolt with respect to the faceplate 2809 and thereby lock or unlock a door. In some examples, the clutch bar 2806 can be rotated using the first knob 2804 and a clutch of the lock clutch cylinder 2802. In some cases, when the lock clutch cylinder 2802 is in an unlocked (Access) state the second knob 2801 may be used to rotate the clutch bar 2806 to change the position of the dead bolt. In some cases, when the lock clutch cylinder 2802 is in a locked state (No Access), the second knob 2801 may be rotationally decoupled from the clutch and cannot be used to change the position of the dead bolt by rotating the clutch bar 2806.

In some cases, the smart door lock assembly 2800 may comprise an energy efficient smart lock system configured to enable wireless control of the lock clutch cylinder 2802 and wireless charging of a power supply used to power an electronic control circuit of the lock clutch cylinder 2802. In some cases, a user may use an electronic access device to change a locking state of the lock clutch cylinder 2802 between a locked state and an unlocked state by sending a wireless signal to the electronic control circuit. In some cases, lock clutch cylinder 2802 may be locked or unlocked by a tapping action (e.g., with a phone or an NFC Keyfob). In some cases, the tapping action may not include opening an application of the electronic access device. In some cases, the tapping action comprises bringing the electronic access device closer than a threshold distance to the lock for a short period. In some cases, the threshold distance can be from less than 5 inches but not greater than 2 inches. In some cases, the threshold time can be less than 2 seconds if the lock is already charged, and less than 6 seconds if the lock needs to be charged by the electronic access device.

In some embodiments, the power supply of the electronic control circuit may comprise a capacitor that can be wirelessly charged by the electronic access device and provide the charge to the electronic control circuit and/or to a motor to change the locking state of the lock clutch cylinder 2802. The wireless charging may comprise an NFC component. In some cases, the locking state of the lock clutch cylinder 2802 can be controlled both mechanically (e.g., using the first knob 2804, or the second knob 2801) and electronically (e.g., using an electronic access device). For example, a user may use the first knob 2804 to switch the locking state of the lock clutch cylinder 2802 between the locked and unlocked states and use the second knob 2801 to switch the state of the door lock assembly from an unlocked state to a locked state. In some embodiments, the locking state of the lock clutch cylinder 2802 can be controlled mechanically on the interior side (e.g., using the first knob 2804) and electronically (e.g., using an electronic access device) on the exterior side.

In some cases, the locking state of the lock clutch cylinder 2802 may be controlled using the electronic access device without physical contact between the electronic access device and the smart door lock assembly 2800. In some examples, the electronic access device may change the locking state of the lock clutch cylinder 2802 by changing the position of a barrier inside the lock clutch cylinder 2802 between a first position and a second position different from the first position. For example, a wireless signal received from the electronic access device may cause the motor to rotate the barrier from the first position to the second position and vice versa. In some examples, the energy required to move the barrier from the first position to the second position can be smaller than 800 millijoules, smaller than 500 millijoules, smaller than 300 millijoules, or smaller values.

In some embodiments, the smart door lock assembly 2800 may be configured to allow a plurality of users to wirelessly control the locking state of the lock clutch cylinder 2802 using different electronic access devices (e.g., their personal electronic access device). For example, the electronic control circuit of lock clutch cylinder 2802 may be configured to authenticate an electronic access device, or an application on the electronic access device (e.g., using a secret private ID). Once the electronic access device is authenticated, the electronic control circuit may allow the electronic access device to transfer electric power to the power supply (e.g., Capacitor) and control the locking state of the lock clutch cylinder 2802. In various implementations, the components of smart door lock assembly 2800 may comprise metallic or plastic components.

In various implementations, the control and access to the smart door lock assembly 2800 may comprise one or more features described above with respect to FIGS. 17 to 27.

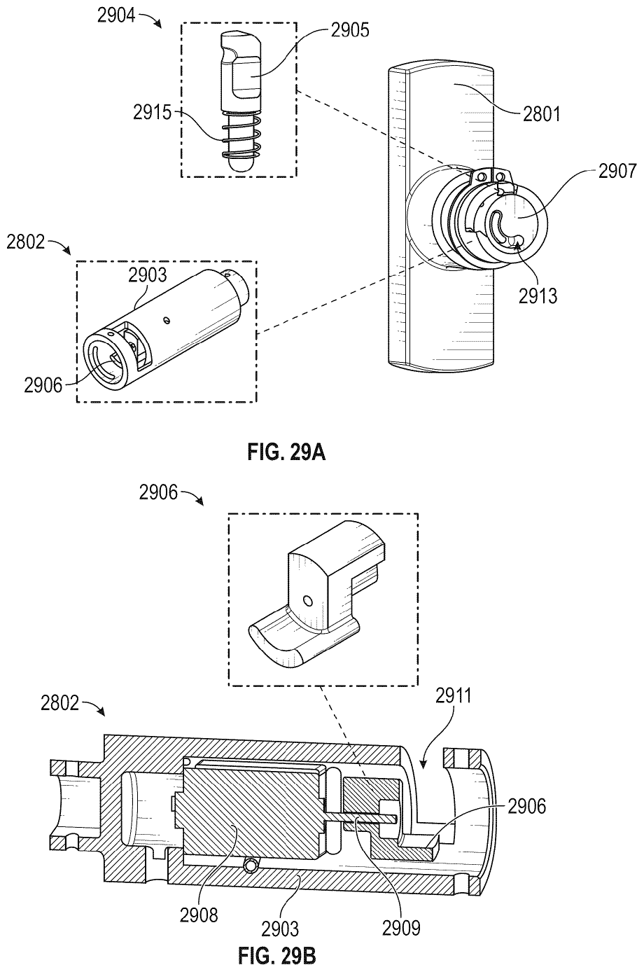

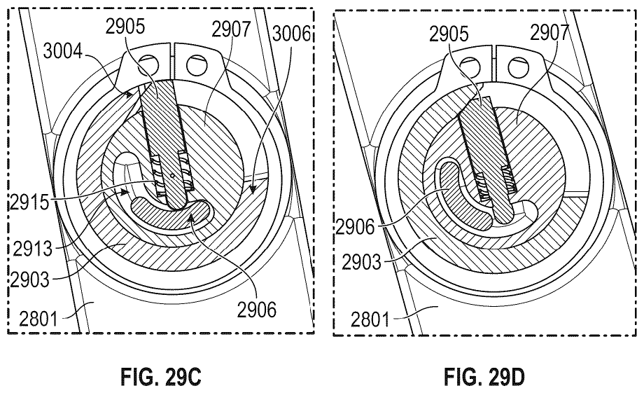

FIGS. 29A and 29B illustrate the second knob 2801, the lock clutch cylinder 2802, and some components of the lock clutch cylinder 2802. FIG. 29A illustrates a lateral cross-section of a lock clutch cylinder attached to the second knob (external knob) 2901. The insets show the lock clutch cylinder 2802 and the spring-loaded pin 2904 used in the lock clutch cylinder 2802. FIG. 29B illustrates a longitudinal cross-section of a lock clutch cylinder 2802. The inset shows the barrier 2906 of the lock clutch cylinder 2802. A mechanical coupling between the of the second knob 2801 and a dead bolt controlled by the lock clutch cylinder 2802 may be wirelessly controlled by the electronic access device to allow or prevent controlling the dead bolt using the second knob 2801. For example, when the lock clutch cylinder 2802 is in the locked state, the second knob 2801 can be mechanically decoupled from the locking element and thereby moving (e.g., rotating) the second knob 2801 may not change the position of the dead bolt to open the door. As described above, the locking state of the lock clutch cylinder 2802 can be changed mechanically using the first knob 2804 or wirelessly (e.g., remotely) using an electronic access device. In some cases, the second knob 2801 may be used to change the locking state of the lock clutch cylinder 2802 from an unlocked state to a locked state but not the opposite.

In some cases, the lock clutch cylinder 2802 may comprise, a spring-loaded pin 2904, a clutch 2903, a barrier (or CAM) 2906, and an electro-motor 2908 (herein referred to as motor). In some cases, at least the motor 2908 and the barrier 2906 are disposed inside the clutch 2903. In some cases, the clutch 2903 is rotatably coupled to a first knob 2804 via the clutch bar 2806. FIG. 29B is a longitudinal cross-section of the lock clutch cylinder 2802 showing the arrangement of the motor 2908 and the barrier 2906 with respect to the clutch 2903. In some examples, clutch 2903 may include a pin slot 2911 configured to allow the clutch 2903 to be mechanically coupled or decoupled from the first knob 2804 by the spring-loaded pin 2904. In some cases, the pin slot 2911 can be a circular slot having a first end having a right-angle end and a second end having a sloped end. In some cases, the shaft 2909 of the motor 2908 is connected to the barrier 2906 (also known as CAM) such that the motor 2908 can rotationally control an angular position of the barrier 2906 (e.g., with respect to the pin 2905). In some cases, the motor 2908 and the barrier 2906 may be positioned or embedded within a cavity inside the clutch 2903. in some such cases, the motor 2908 is secured and connected to the clutch 2903 while the barrier 2906 can freely rotate with respect to the clutch 2903 under the control of the motor 2908. in some cases, the lock clutch cylinder 2802 may be configured to receive a cylindrical portion 2907 of the second knob 2801. The cylindrical portion 2907 of the second knob 2801 may comprise a barrier slot 2913 configured to allow the barrier 2906 to rotate with respect to the cylindrical portion within an angular range defined by the barrier slot 2913. In some cases, the cylindrical portion 2907 of the second knob 2801 may be configured to allow the pin 2905 to be movably coupled to the second knob 2801 such that the pin 2905 can move in a radial direction with respect to the cylindrical portion 2907 while its rotational motion is coupled to and is in sync with a rotational motion of the second knob 2801. In some examples, the pin 2905 can translate a rotational motion of the first knob 2801 in a first rotational direction (e.g., a counterclockwise rotation) to a rotational motion of the clutch 2903 in the first rotational direction, when maintained at an unlock position by the barrier 2906. However, in some cases, the rotational motion of the clutch 2903 in the first rotational direction is decoupled from the rotational motion of the first knob 2801 in the first rotational direction, when the barrier 2906 does not maintain the pin 2905 is the unlock position. In some embodiments, the lock clutch cylinder 2802 may comprise an electronic control circuit (not shown) configured to communicate with and to be powered by an electronic access device (e.g., via an NFC link, blue tooth, and/or Wi-Fi link). In some cases, the lock clutch cylinder 2802 or the electronic control circuit, can include a capacitor configured to store power received from the electronic access device. In some cases, the lock clutch cylinder 2802 or the electronic control circuit, can include an antenna configured to send and received wireless signals to and from the electronic access device. In some cases, the antenna may comprise a coil, a planar antenna, printed circuit board (PCB) antenna, or other types of antenna.

FIG. 29C shows a vertical cross-sectional view of the lock clutch cylinder 2802 in an unlocked state. The cross-sectional plane of the vertical cross-section shown in FIG. 29C can be a plane passing through the pin slot 2911 of clutch 2903 and the cross-section is viewed from the location of the first knob 2804 (inside the room protected by the smart door lock assembly 2800). As shown in FIG. 29A and FIG. 29C, in some cases, pin slot 2911 can be a 90-degree slot formed in a side wall of the clutch 2903 and may comprise a sloped end 3004 and a right-angle end 3006. In some cases, the sloped end 3004 is configured to allow the rotational motion of the pin 2905 to be coupled to the rotational motion of the clutch 2903 in a first rotational direction when the barrier 2906 blocks the pin 2905, and prevent coupling between the rotational motion of the pin 2905 and the rotational motion of the clutch 2903 in a second direction opposite to the first rotational direction when the barrier does not block the pin 2905. In some cases, the right-angle edge is configured to allow rotational motion of the pin 2905 and to be coupled to the rotational motion of the clutch 2903 in the second direction independent of a position of the barrier 2906.

In some examples, barrier 2906 is placed in the barrier slot (e.g., a curved slot or groove) formed in a cylindrical portion 2907 of the second knob 2801. As mentioned above, the barrier slot 2913 allow a rotational motion of the barrier 2906 with respect to the second knob 2801. In the example shown, the barrier slot comprises a 90-degree circular section formed in the cylindrical portion 2907 of the first knob 2804. However, in various designs the barrier slot 2913 may comprise larger or smaller circular sections. In some examples, pin 2905 is placed in a pin groove (e.g., a straight groove) radially formed within the cylindrical portion 2907 of the second knob 2801. In some cases, the pin groove is configured to allow a linear motion of pin 2905 with respect to the cylindrical portion 2907 of the second knob 2801 while rotating the pin 2905 together with the second knob 2801. As such the second knob 2801 may be used to rotate the pin 2905 with respect to clutch 2903. In some cases, the motor 2908 and the barrier 2906 may rotate in sync with the clutch 2903. However, the motion of the barrier 2906 may be constrained by the barrier slot 2913. As such, when the barrier 2906 reaches an end of the barrier slot 2913, it may not move in sync with the clutch 2903 and the motor 2908 causing the shaft 2909 to rotate with respect to the motor 2908. In some examples, the spring 2915 may be configured to push the pin 2905 away from the cavity within which the motor 2908 and the barrier 2906 are disposed.

With continued reference to FIG. 29C, in the unlocked state, the barrier (CAM) 2906 is in a first position and blocks the motion of pin 2905. As such the pin 2905 cannot be pushed away (in the radial direction) by the sloped end 3004 of clutch 2903 and its rotation in a counterclockwise direction rotates the clutch 2903 in the same direction. As a result, when the lock clutch cylinder 2802 is in the unlocked state, rotating the second knob 2801 (and thereby the rotating the pin 2905) in a counterclockwise direction rotates the clutch 2903 in the same direction and move the dead bolt (e.g., to open the door).

FIG. 29D shows a lateral cross-sectional view of the lock clutch cylinder 2802 when the lock clutch cylinder 2802 is in the locked state. In this case the barrier (CAM) 2906 is in a second position does not block the motion of pin 2905. In this case, the barrier (CAM) 2906 is moved away from the path of the pin 2905 and as a result when the second knob 2801 is rotated in a counterclockwise direction, the pin 2905 is pushed down by a sloped end 3004 of the clutch 2903 and slides under the clutch 2903 without affecting the angular position of the clutch 2903. As such, in the locked state the second knob 2801 is mechanically decoupled from clutch 2903 when the second knob 2801 is rotated in the counterclockwise direction.

In some examples, the barrier 2906 can be moved (e.g., rotated) between the first position (FIG. 29C) and second position (FIG. 29B) by the motor 2908. In some cases, the total electric energy consumed by the motor 2908 for moving the barrier 2906 between the first and second positions can be In some examples, the energy required to move the barrier from the first position to the second position can be smaller than 800 millijoules, smaller than 700 millijoules, or smaller values. In various examples, moving the barrier 2906 between the first and second positions may comprise rotating the barrier 2906 by an angle from 5 degrees to 10 degrees, from 10 degrees to 20 degrees, from 20 degrees to 30 degrees, from 30 degrees to 50 degrees, from 50 degrees to 70 degrees, from 70 degrees to 90 degrees, or any ranges formed by these values or larger or smaller values.

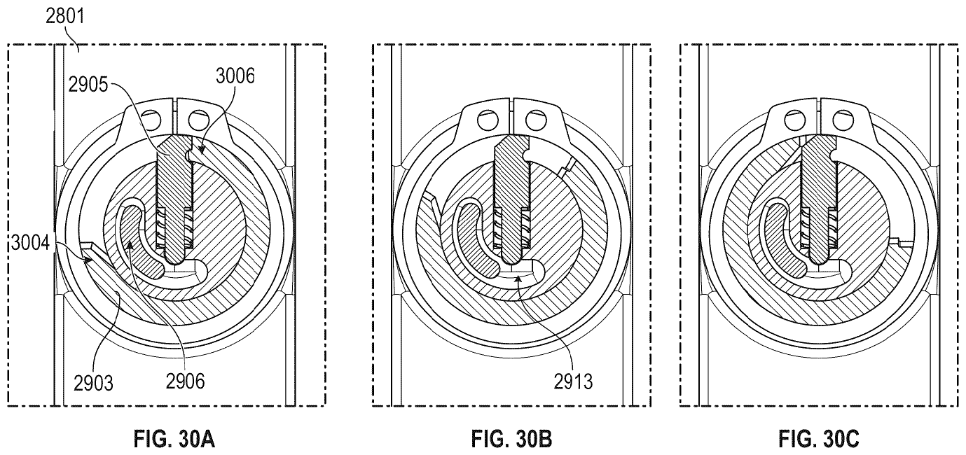

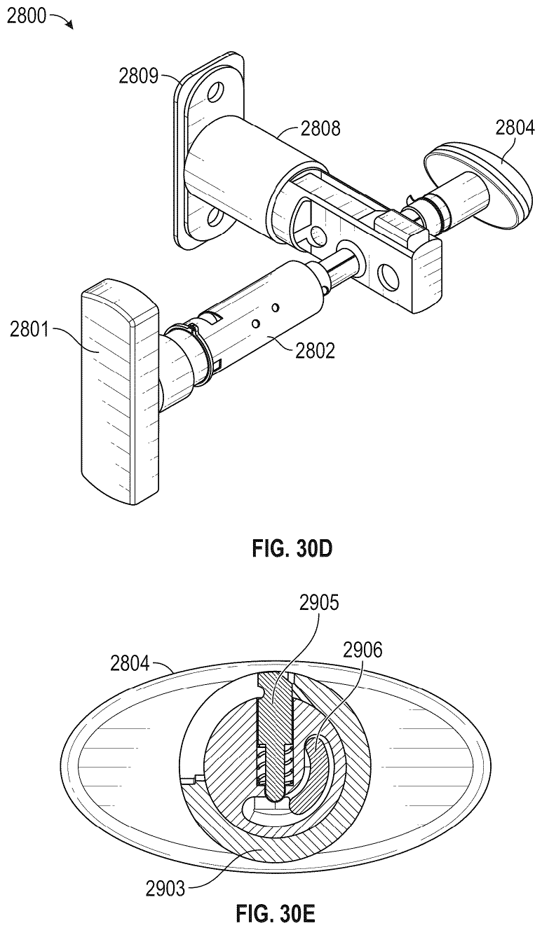

FIGS. 30A-30C illustrate a cross-sectional view of the lock clutch cylinder 2802 depicting selected rotational positions of the clutch 2903 with respect to the second knob 2801 (and thereby with respect to the pin 2905), when the first knob 2804 is used to move the clutch 2903 (and thereby the deadbolt) from an unlocked position to a locked position. In some cases, the first knob 2804 can be used to rotate the clutch 2903, and thereby the deadbolt, independent of a position of the barrier 2906 with respect to pin 2905. In FIG. 30A clutch 2903 is in the unlocked position and the dead bolt (not shown) is within the enclosure 2808. In FIG. 30B clutch 2903 is turned in a clockwise direction using the first knob 2804 moving the deadbolt out of the enclosure 2808 via the faceplate 2809. In FIG. 30C clutch 2903 has reached the locked position and the dead bolt is extended out of the enclosure 2808. In some cases, the first knob 2804 does not retract so the clutch 2903 stays in the locked position.

In some examples, the motor 2908 rotates in sync with the clutch 2903. In some such examples, the barrier 2906 rotates in sync with the clutch 2903 until it is blocked by the barrier slot 2913.

In the example shown, the motion of the barrier 2906 is blocked by the barrier slot 2913 and the barrier 2906 stays in the first position with respect to the pin 2905, keeping the lock clutch cylinder 2802 in a locked state so that the second knob 2801 cannot be used to move the clutch 2903 and the dead bolt. In some cases, the first position of the barrier 2906, which corresponds to the locked state of the lock clutch cylinder 2802, may be referred to as a “no access” position of the barrier 2906 (indicating that the second knob 2801 cannot be used to open the door lock and provide access to a room protected by the door lock). FIG. 30D illustrates the smart door lock assembly 2800 after the clutch 2903 has reached the locked position (corresponding to FIG. 30C). FIG. 30E shows the rotational position of the clutch 2903 in the locked position when viewed from outside the room that is protected by the smart door lock assembly 2800.

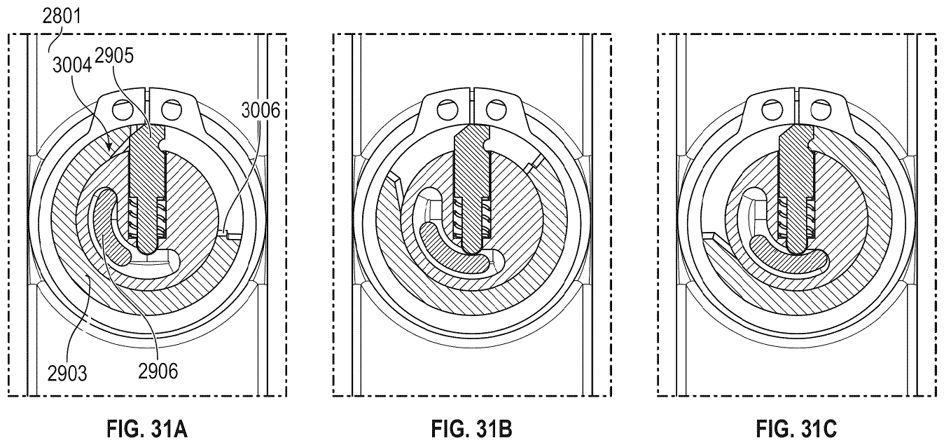

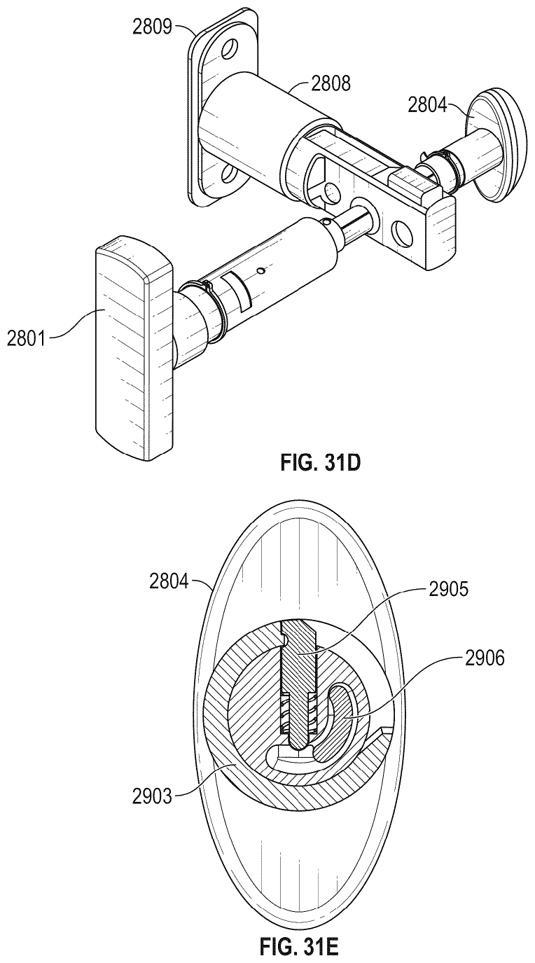

FIGS. 31A-31C illustrate a cross-sectional view of the lock clutch cylinder 2802 depicting selected rotational positions of the clutch 2903 with respect to the second knob 2801 (and thereby with respect to the pin 2905), when the first knob 2804 is used to move the clutch 2903 (and thereby the deadbolt) from a locked position to an unlocked position. In FIG. 31A clutch 2903 is in the locked position and the dead bolt (not shown) is within the enclosure 2808. In FIG. 31B clutch 2903 is turned in a counterclockwise direction using the first knob 2804 moving the deadbolt into the enclosure 2808 via the faceplate 2809. In FIG. 31C clutch 2903 has reached the unlocked position and the dead bolt completely retracted into enclosure 2808. In some examples, barrier 2906 rotates in sync with clutch 2903 until the barrier 2906 is blocked by the first groove of the second knob 2801 and stays at the second position with respect to the pin 2905 and thereby blocks the pin 2905. As such, in some cases, rotating the first knob 2804 and the clutch 2903 from an unlocked position to the locked position can change the state of the lock clutch cylinder 2802 from a locked state to an unlocked state such that the second knob 2801 can be used to move clutch 2903 and the dead bolt. FIG. 31D illustrates door lock assembly 2800 after the clutch 2903 has reached the unlocked position (corresponding to FIG. 31C). FIG. 31E shows the rotational position of clutch 2903 in the locked position when viewed from the outside.

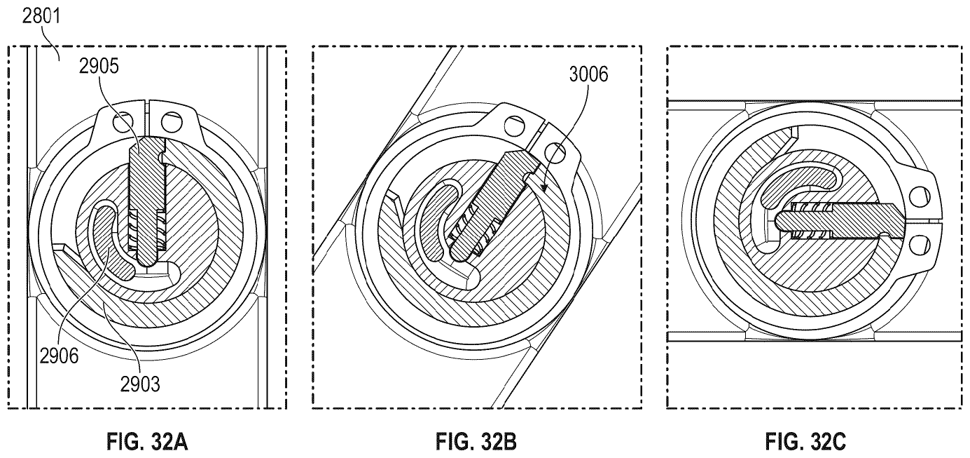

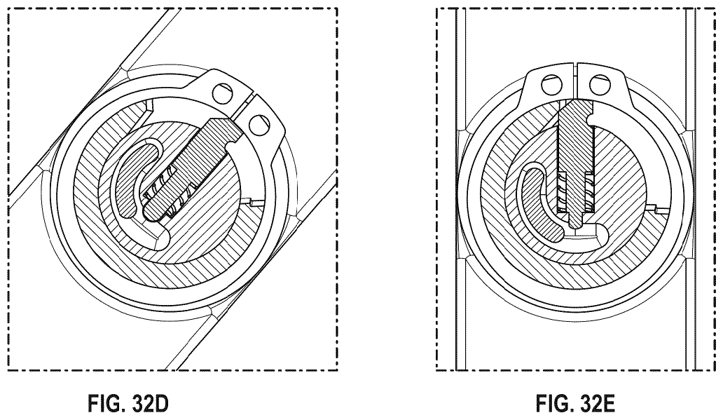

FIGS. 32A-32E illustrate a cross-sectional view of the lock clutch cylinder 2802 depicting selected rotational positions of the clutch 2903 and the pin 2905 with respect to the second knob 2801, when the lock clutch cylinder 2802 is in the locked state (the barrier 2906 does not block the pin 2905) and the second knob 2801 is used to move the clutch 2903 (and thereby the deadbolt) from the unlocked position to the locked position. As described above, in some embodiments, when the barrier 2906 does not block the motion of the pin 2905, second knob 2801 may be used to move the clutch 2903 (and therefore the dead bolt connected to it) from the unlocked position to the locked position but not from the locked position to the unlocked positions. In other words, when the lock clutch cylinder 2802 is in an unlocked state, a user can use the outside knob to put the door lock in the locked state; however to open the door, the user should first change the state of the lock clutch cylinder 2802 to the unlocked state (e.g., using an electronic access device). In FIG. 32A clutch 2903 is in the unlocked position and the dead bolt (not shown) is within enclosure 2808. In FIG. 32B clutch 2903 is turned by pin 2905 in a clockwise direction using the second knob 2801 causing the deadbolt to extend out of enclosure 2808 via the faceplate 2809. In FIG. 32C the second knob 2801 has been rotated by 90 degrees, the clutch 2903 has reached the locked position, and the dead bolt has reached its maximum extension with respect to enclosure 2808 (not shown). In some examples, the second knob 2801 rotates the pin 2905 and an end of the pin 2905 (e.g., a thicker end) is engaged with the right-angle end 3006 of the pin slot 2911 rotates the clutch 2903. In some examples, the barrier 2906 and the motor 2908 rotate in sync with clutch 2903 and the second knob 2801. As such, in some cases, rotating the second knob 2801 and the clutch 2903 from an unlocked position to the locked position does not change the locking state of the lock clutch cylinder 2802. In FIG. 32D the second knob 2801 is retracted back in a counterclockwise direction, and the pin 2905 is disengaged from clutch 2903. In FIG. 32E the second knob 2801 is back to its original position (in FIG. 32A), the clutch 2903 and the dead bolt are in the locked position, and the lock clutch cylinder 2802 is in a locked state. As such the deadbolt cannot be moved by the second knob 2801 before changing the locking state of the lock clutch cylinder 2802 to the unlocked state (e.g., using an electronic access device).

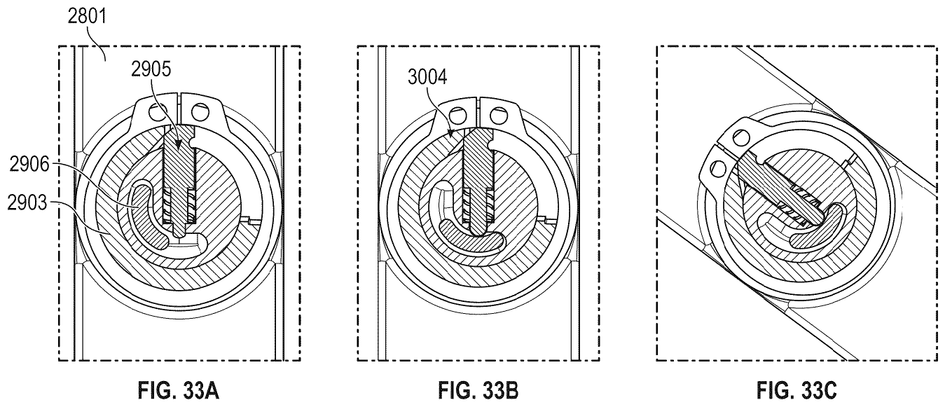

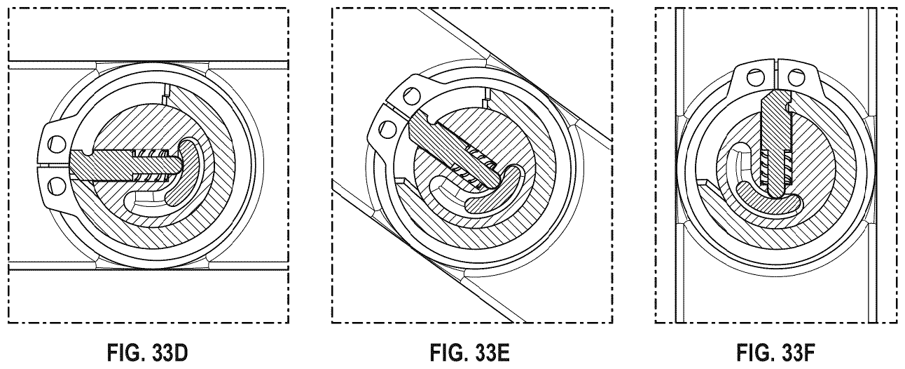

FIGS. 33A-33F illustrate a cross-sectional view of the lock clutch cylinder 2802 depicting selected rotational positions of the clutch 2903 and the pin 2905 with respect to the second knob 2801, when the lock clutch cylinder 2802 is in the unlocked state (the barrier 2906 blocks the pin 2905) and the second knob 2801 is used to move the clutch 2903 (and thereby the deadbolt) from the locked position to the unlocked position. In FIG. 32A clutch 2903 is in the locked position, the dead bolt (not shown) is engaged with a door frame, and the barrier 2906 is still in the locked state (the barrier 2906 does not block the pin 2905). In FIG. 32B the barrier is moved (rotated) under the pin 2905 and blocks the pin 2905. In some cases, the motor 2908 may rotate the barrier 2906 to the unlocked position in response to receiving a wireless signal (e.g., unlocking wireless signal) from an electronic access device. In some cases, the motor 2908 may rotate the barrier 2906 from the unlocked position (under the pin 2905) to an unlocked position in response to receiving another wireless signal (e.g., locking wireless signal) from an electronic access device.

In FIG. 33C the clutch 2903 is turned by pin 2905 in a counterclockwise direction using the second knob 2801 causing the deadbolt to be retracted toward the enclosure 2808 via the faceplate 2809. Since the pin 2905 is blocked by the barrier 2906, the pin cannot be radially pushed by the clutch 2903 and rotation of the clutch 2903 is coupled to the rotation of the second knob 2801 in counterclockwise direction, by the pin 2905. In FIG. 32D clutch 2903 has reached the unlocked position and the dead bolt is completely decoupled from the door frame and retracted inside the enclosure 2808. In some examples, the second knob 2801 rotates the pin 2905 and an end of the pin 2905 (e.g., a thicker end) is engaged with the sloped end 3004 of the clutch 2903 and rotates the clutch 2903. In some cases, when the pin 2905 rotates the clutch 2903 in the counterclockwise direction, the sloped end 3004 of the clutch 2903 may push the pin 2905 toward the barrier 2906 and depress the spring that loads the pin 2905. As described above, in some examples, rotating the second knob 2801 may not change the locking state of the lock clutch cylinder 2802. In FIG. 33E the second knob 2801 is rotated back in a clockwise direction, and the pin 2905 is disengaged from clutch 2903. In some cases, when the pin 2905 is disengaged from clutch 2903, the spring that loads the pin 2905 may push the pin 2905 away from the barrier 2906 but the barrier slot keeps the rotation of the barrier in synch with the second knob 2801. In FIG. 32F the second knob 2801 is back to its original position, the clutch 2903 and the dead bolt are in the unlocked position, and the lock clutch cylinder 2802 is in an unlocked state.

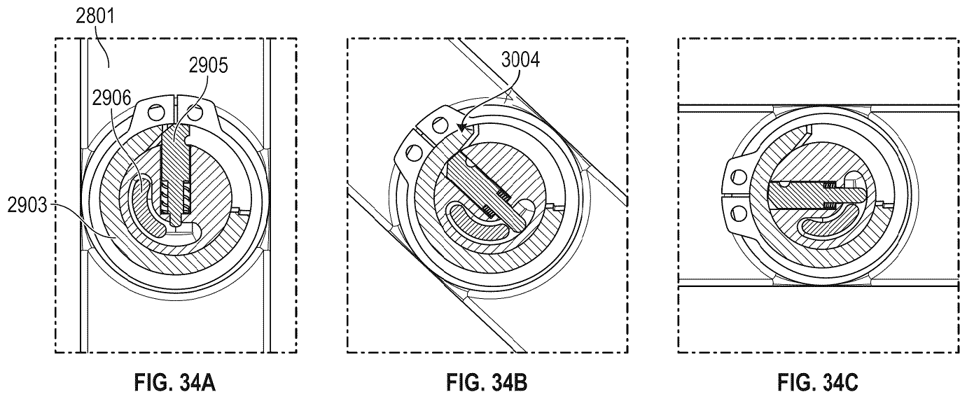

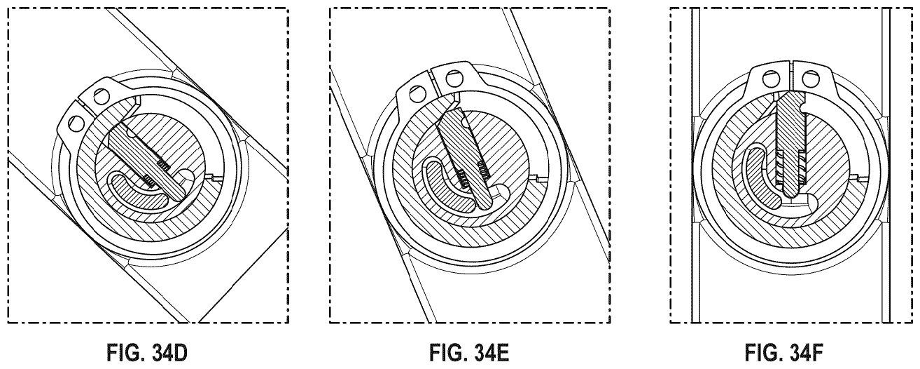

FIGS. 34A-34F illustrate a cross-sectional view of the lock clutch cylinder 2802 depicting selected rotational positions of the clutch 2903 and the pin 2905 with respect to the second knob 2801, when the lock clutch cylinder 2802 is in the locked state (the barrier 2906 does not block the pin 2905) and the second knob 2801 is rotated in the counterclockwise direction but cannot move the clutch 2903 (and thereby the deadbolt) from the locked position to the unlocked position. In FIG. 33A clutch 2903 is in the locked position, the dead bolt (not shown) is engaged with a door frame, and the barrier 2906 is in the locked state (the barrier 2906 does not block the pin 2905). In FIG. 33B the second knob 2801 is turned in the counterclockwise direction but since the pin 2905 is not blocked by the barrier 2906, the sloped end 3004 of the clutch 2903 radially pushes the pin 2905 into the barrier slot and depresses the spring the loads the pin 2905. As such the pin 2905 slips under the clutch 2903 and is rotationally decoupled from the clutch 2903 while pressing the barrier 2906. As the second knob 2801 rotates, the barrier slot that rotates with the first knob 2804 and the pin 2905 rotates the barrier 2906 in sync with the first knob 2804 and the pin 2905. In FIG. 34C the second knob 2801 is further rotated to an orientation 90-degree with respect to its original orientation in FIG. 34A. In FIG. 34D-34F the second knob 2801 is rotated back in a clockwise direction to its original orientation without affecting the rotational position of the clutch 2903 and thereby the locking state of the lock clutch cylinder 2802. As such when the barrier 2906 does not block the pin 2905 (lock or No Access position), the rotation of the second knob 2801 is decoupled from the rotational the clutch 2903 in a first rotational direction (counterclockwise rotation when viewed from the first knob 2804 side but can be coupled to the rotation of the clutch 2903 in a second rotational direction opposite to the first rotational direction. It should be understood that the clockwise or counterclockwise rotations described above with respect to FIGS. 29C-29D, 30A-30C, 31A-31C, 32A-32E, 33A-33E, and 34A-34E, are from the point of view of an observer that observes the cross-section of the lock clutch cylinder 2802 from inside (or the location of the first knob 2804). As such, the rotational directions will be reversed when observed from outside (e.g., by an observer that uses the second knob 2801).

In some embodiments, the lock clutch cylinder 2802 may be used in a smart lock used to lock or an unlock a cabinet door, or other types of doors.

In some embodiments, a smart lock (e.g., the smart lock assembly 2800) may comprise a button configured to rotate the clutch 2903 (e.g., a translational motion of the causes a rotational motion of the clutch 2903). In some cases, the first (internal) knob 2804 or the second (external) knob 2801 may include or may be replaced by such button.

In some cases, a smart lock (e.g., the smart lock assembly 2800) may comprise at least one conductive contact point configured to allow an electronic control circuit of the smart lock to receive power from an electronic access device.

### Smart Padlocks

In some embodiments, a smart padlock can be a padlock comprising a wirelessly controllable and chargeable locking system. In some cases, the smart padlock may be powered with near field coupling (NFC). In some cases, a locking state of the smart padlock can be controlled wirelessly using an electronic access device. In some cases, the same electronic access device can also charge a power supply (i.e., a capacitor) of the smart padlock via NFC. For example, the smart padlock may include a power supply that is configured to be magnetically coupled to the electronic access device and receive electric power from the electronic access device when a distance between the smart lock and the electronic access device is less than a threshold distance. In some cases, the threshold distance can be from 0.5 cm to 2 cm, from 2 cm to 5 cm, from 5 cm to 8 cm, or from 8 cm to 10 cm.

The smart lock may comprise an electronic control circuit configured to be powered by the wirelessly charged power supply and control the locking state of the smart padlock based on a wireless signal received from the electronic access device. In various implementations, the electronic access device may comprise a smart phone, an NFC Keyfob, or other electronic access devices (also referred to as electronic keys) configured to wirelessly communicate with the electronic control circuit and, in some cases, wirelessly charge the power supply that powers the electronic circuit. In some embodiments, the electronic access device may be used to unlock the padlock by a tapping action. In some implementations, the smart padlock can include a shackle movably connected to a housing. When the smart lock is in an unlocked state the shackle can move with respect to housing and when the smart lock is in a locked state the shackle can be locked to the housing (e.g., by a latch). In some implementations, the locking system of the smart padlock may comprise a latch, barrier (CAM), and a motor powered and controlled by the electronic circuit. In some cases, the barrier can limit the movement of the latch and the latch can limit or prevent the movement of the shackle with respect to the housing. For example, when the barrier is in a first position the latch can freely move (e.g., rotate) with respect to the housing, and when the barrier is in a second position it may prevent a movement (e.g., rotational or translational) of the latch with respect to the housing and keep it in a locked position. In some cases, the motor can be configured to move the barrier between the first and second positions. For example, in response to receiving a wireless locking signal (e.g., a from the electronic access device), the electronic control circuit may cause the motor to move the barrier from the first position to the second position and in response to receiving a wireless unlocking signal (e.g., a from the electronic access device), the electronic control circuit may cause the motor to move the barrier from the second position to the first position. In some cases, the shackle can be mechanically coupled or linked to the latch such that moving the shackle moves the latch and blocking the movement of the latch blocks the movement of the shackle (e.g., a translational movement away from the housing). In some cases, when the latch is in the locked position and the barrier is in the second position, the latch may block the movement of the shackle with respect to the housing keeping it in a locked position. In some cases, when the barrier is in the first position the shackle can be moved out of the housing and its movement may cause a movement of the latch (that can freely move when the barrier is in the first position). In some cases, pushing the shackle toward the housing may move the barrier from the second position to the first position and move the latch from the unlocked position to the locked position. As such, in some cases, a wireless unlocking signal may electro-mechanically move the barrier from the second position to the first position and pushing the shackle from the unlocked position to the locked position can move the barrier from the first position of the second position (causing the latch and thereby the shackle to be locked).

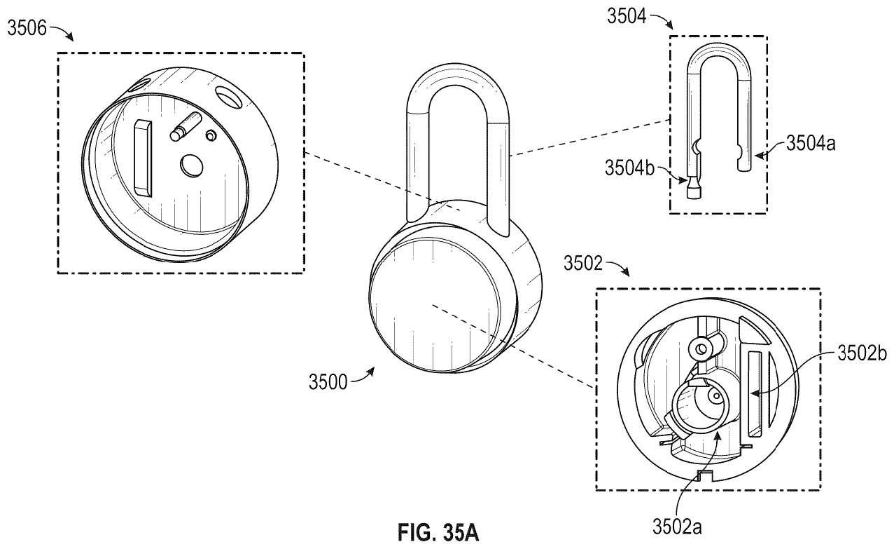

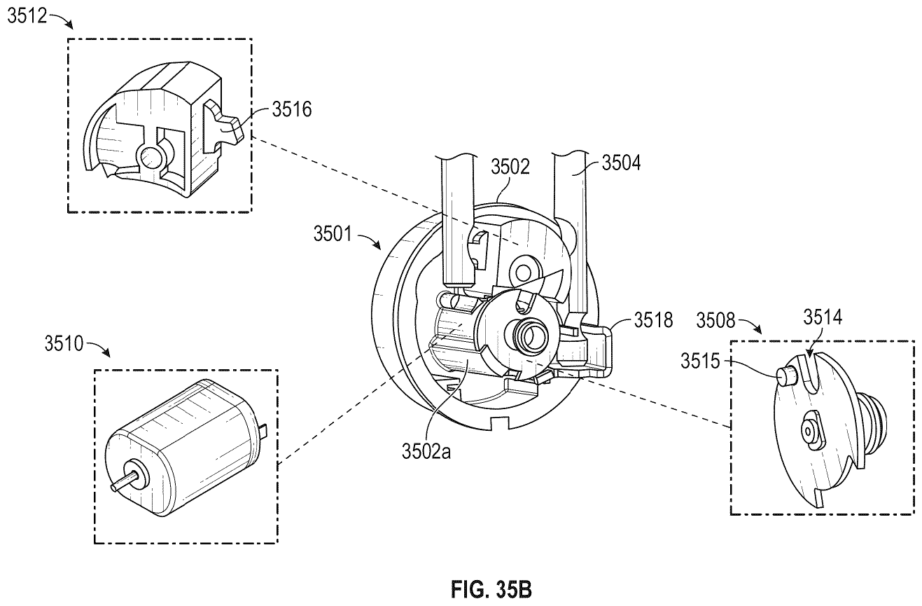

FIG. 35A illustrates an example smart padlock 3500 that can be wirelessly powered and controlled. In some cases, the smart padlock 3500 comprises a housing 3506, a shackle 3504, and a back cover 3502. In some cases, the shackle 3504 may comprise a U-shape component having a first end 3504a configured to be linked to and constrained by a latch, and a second end 3504b configured to be attached or connected to a flange to move a barrier. In some examples, the shackle 3504 may comprise plastic, a metal such as steel, stainless steel, aluminum, iron, or other metals and metallic alloys. In some embodiments, the back cover 3502 may be configured to all the two ends of the shackle to enter or exit a cavity of the housing 3506 and a latch to be rotatably linked or connected to the housing 3506. In some embodiments, the back cover 3502 may be configured to support a locking system and to be received by the housing 3506 (e.g., placed within the cavity of the housing 3506). The back cover 3502 may comprise a motor housing 3502a configured to house an electromotor and a rail 3502b configured to guide a flange connected to the second end 3504b of the shackle 3504. In some cases, the back cover 3502 or the housing 3506 may comprise an antenna housing (not shown) configured to house an antenna that can be wirelessly coupled to an electronic access device to receive electrical energy via NFC and charge an electronic control circuit of the smart padlock 3500. In some cases, the antenna housing may be configured to electromagnetically isolate the antenna from an electrically conductive portion of the back cover 3502 and housing 3506.

FIG. 35B illustrates the locking system 3501 of the smart padlock 3500. In some cases, the locking system 3501 may comprise an electromotor 3510 (also referred to as motor), a latch 3512, the shackle 3504, a flange 3518, and a barrier 3508. In some cases, the barrier 3508 may comprise a disk having a return pin 3515 and a notch 3514. The components of the locking system 3501 may be linked to or supported by, at least in part, the back cover 3502. In some cases, the motor 3510 may be disposed in the motor housing 3502a and the latch 3512 may be rotatably coupled to back cover 3502 via a rod that is extended from the housing 3506 to the back cover 3502. The barrier 3508 can be connected to an output shaft of the motor 3510 such that its rotational position with respect the motor 3510, housing 3506, and back cover 3502 can be controlled by the motor 3510. For example, the motor 3510 can move the barrier 3508 from a second position, at which the barrier 3508 prevents or blocks a rotational motion of the latch 3512 at least in one direction, to a first position at which the barrier 3508 is decoupled from the latch 3512. In some examples, the latch 3512 may comprise a latch pin 3516 configured to be latched to the first end 3504a of the shackle 3504 and to link a motion (e.g., a linear motion) of the shackle 3504 to the rotation of the latch 3512. In some examples, the notch 3514 of the barrier 3508 is configured to mat e with the latch 3512 and block or prevent a rotational motion of the latch 3512, at least in one direction, when the barrier 3508 is in a second position. In some examples, the return pin 3515 is configured to mechanically couple the barrier 3508 to the flange 3518 attached to the second end 3504b of the shackle 3504, such that pushing down the shackle 3504 rotates the barrier 3508 (e.g., back to a lock position). In some cases, when the barrier 3508 is in the second position (lock position) the latch 3512 cannot rotate in a counterclockwise direction (when viewed from the back cover 3502 side).

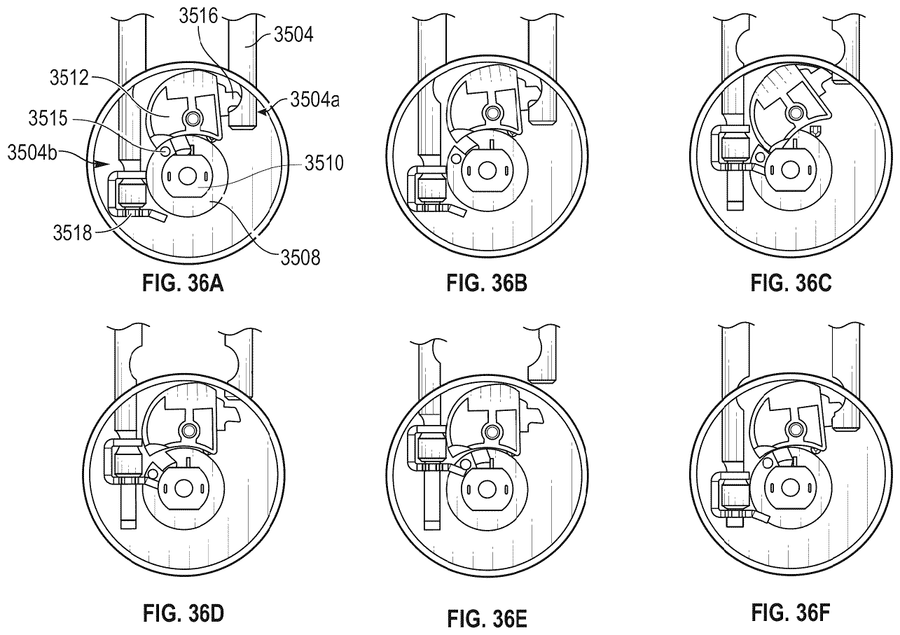

FIG. 36A-36F show cross-sectional views of the locking system 3501 of the smart padlock 3500 when the state of the locking system 3501 changes from a locked state (FIG. 36A) to an unlocked state (FIG. 36B-36E) and back to the locked state FIG. 36F.

In FIG. 36A the smart locking system (and thereby the smart padlock 3500) in the locked state where the shackle 3504 and the latch 3512 are both in their locked position, the latch 3512 prevents a translational motion of the shackle 3504 (linear motion away from the housing) and the barrier 3508 is in a second position (rotational position) where it prevents a rotation of the latch 3512 at least in one direction. In the example shown, the translational motion of the shackle 3504 is prevented by the latch pin 3516 of the latch 3512 which is latched to the first end 3504a of the shackle 3504, and the rotational motion of the latch 3512 is prevented by the notch 3514 of the barrier 3508. As such, the barrier 3508 indirectly locks the shackle 3504 via the latch 3512.

In FIG. 36B, the motor 3510 has rotated the barrier 3508 from the second position to the second position such that the notch 3514 of the barrier 3508 is disengaged from the latch 3512 and the latch 3512 can freely rotate. In some cases, the transition from the locked state (FIG. 36A) to the unlocked state (FIG. 36B) may comprise, by an electronic control circuit of the smart padlock 3500, receiving an unlocking wireless signal from an authenticated electronic access device and in response to receiving the wireless unlocking signal, activating the motor 3510 to rotate the barrier 3508 from the second position to the first position. In some cases, the first and second positions of the barrier 3508, can be rotational positions of the notch 3514 with respect to an edge of the latch 3512 that is configured to be latched to the notch 3514. Advantageously, linkage between the rotational motion of the barrier 3508 and translational motion of the shackle 3504 via the latch 3512 allows unlocking the smart padlock 3500 with a small motion of the barrier 3508 and with a negligible amount of energy provided to the motor 3510. In various implementations, the energy for pulling the shackle 3504 is provided by a user and the barrier 3508 takes the brunt of the force when locked and distributes force to housing 3506 and the back cover 3502, and not the motor 3510.

In some cases, the electronic circuitry receives energy from a wirelessly chargeable power supply of the smart padlock 3500 (e.g., included in the housing 3506). In some embodiments, the electronic control circuit may first charge the power supply, e.g., via NFC, and then transmit the unlocking wireless signal for unlocking the locking system 3501. In some cases, the energy required for changing the position of the barrier from the first to the second position can be less than 800 millijoules, less than 700 millijoules, less than 600 millijoules, less than less than 400 millijoules, or less than 200 millijoules. In some cases, the power supply may comprise a capacitor that is charged via NFC.

In FIG. 36C-36E, a user pulls the shackle 3504 away from the housing 3506 to release the shackle 3504 from the latch 3512 (that can move freely when the barrier 3508 is in the first position). As the shackle 3504 is pulled out, the latch 3512 rotates in the counterclockwise direction until the latch pin 3516 of the latch 3512 is completely decoupled from the first end 3504a of the shackle 3504 (FIG. 36D). Subsequently the first end 3504a is pulled out of the housing 3506 (FIG. 36E). In the meantime, as the shackle 3504 is pulled out, the flange 3518 attached to the second end 3504b of the shackle 3504 is engaged with the return pin 3515 of the barrier 3508 and rotates the barrier 3508 in a clockwise direction such that the first end 3504a is pulled out of the housing 3506, the barrier 3508 is back to the first position where it blocks the counterclockwise rotation of the latch 3512. When the user pushes the shackle 3504 back toward the housing 3506, the first end 3504a of the shackle 3504 enters the housing 3506 and rotates the latch 3512 in the clockwise direction by pushing the latch pin 3516 until it latched to the stopper (36F). Since previously pulling up the shackle 3504 has also rotated the barrier 3508 to the first position, now the locking system 3501 is in locked state and the smart padlock cannot be opened until it receives another wireless signal from an authenticated electronic access device that rotates the barrier from the first position to the second position.

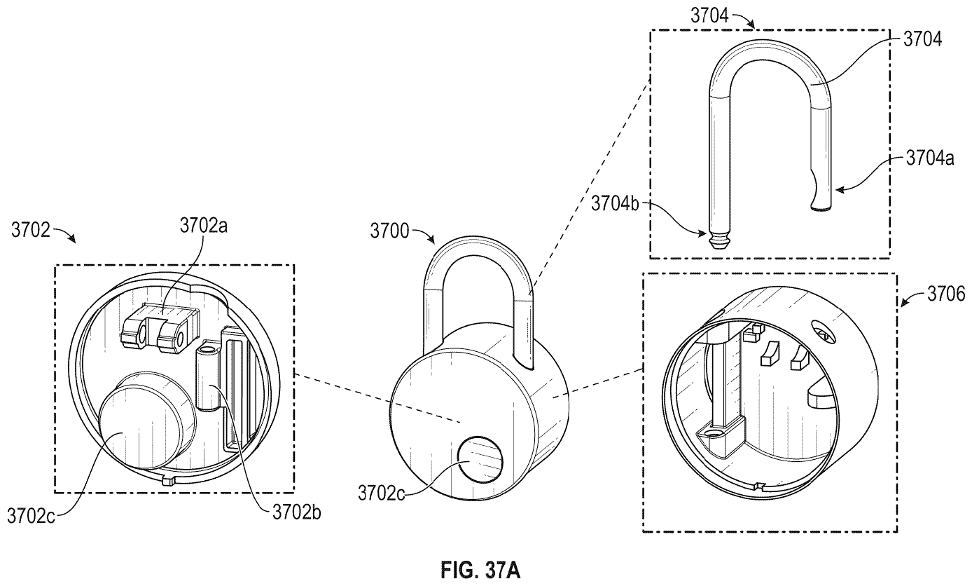

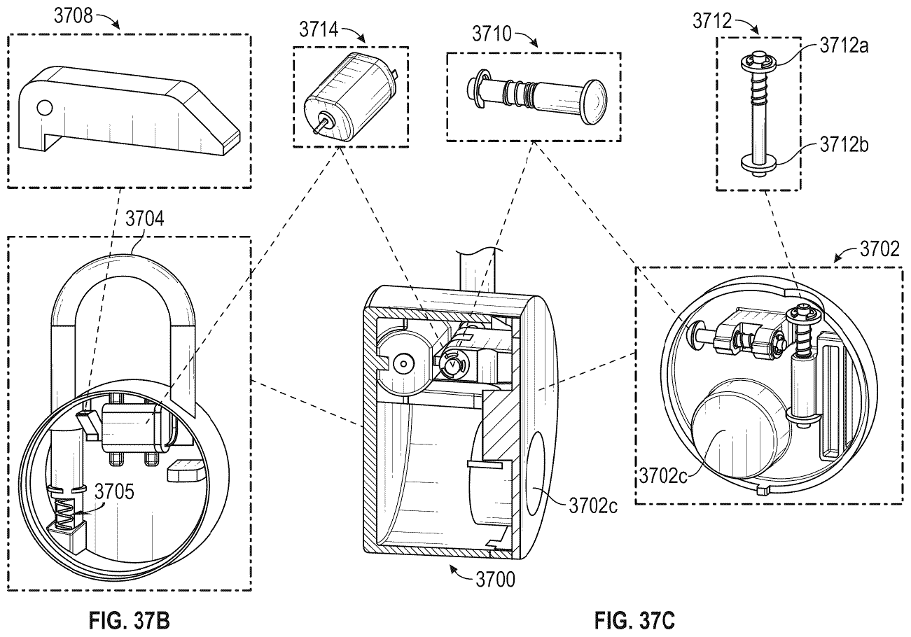

FIG. 37A illustrates another example smart padlock 3700 comprising a wirelessly charged and controlled locking system. The smart padlock 3700 may comprise one or more features described above with respect to smart padlock 3500. In some cases, the smart padlock 3700 can include a housing 3706, a shackle 3704, and a back cover 3702. The shackle 3704 may comprise a U-shape component having a first end 3704a configured to be linked to and constrained by a latching pin, and a second end 3704b configured to be attached to a slider that can move a barrier return pin when the shackle 3704 is pushed down. In some examples, the shackle 3704 may comprise plastic, a metal such as steel, stainless steel, aluminum, iron, or other metals and metallic alloys. The housing 3706 and the back cover 3702 may be configured to support the components of the locking system of the smart padlock 3700. In some embodiments, the housing 3706 may be configured to allow the two ends of the shackle 3704 to enter and exit a cavity of the housing 3706 and a seat configured to hold an electromotor. For example, a top portion of the housing 3706 may include two holes adapted to receive the two ends of the shackle 3704. In some embodiments, the back cover 3702 may be configured to be received by the housing 3706. The back cover 3702 may comprise at least two barrels 3702a, 3702b configured to movably connect a latching pin and a barrier return pin to the back cover 3702. In some cases, the back cover 3702 may comprise an antenna housing 3702c configured to house an antenna that can be wirelessly coupled to an electronic access device to receive electrical energy via NFC and charge an electronic control circuit of the smart padlock 3700. In some cases, the antenna housing 3702c may be configured to electromagnetically isolate the antenna from an electrically conductive portion of the back cover 3702 and housing 3706.

FIGS. 37B and 37C illustrate cross sections of the smart padlock 3700 showing components of the locking system housed in a cavity of the housing 3706 and supported by the housing 3706 and the back cover 3702. In some cases, the locking system may comprise an electromotor 3714 (also referred to as motor), a latching pin 3710, the shackle 3704, a barrier 3708 (e.g., a blocking lever), and a barrier return pin 3712. The components of the locking system may be connected to or movably linked to one or both back cover 3702 and the housing 3706. In some cases, the motor 3714 may be attached to a housing 3706, and the latching pin 3710 and the barrier return pin 3712 may be movably connected to the back cover 3702. In some examples, the barrels 3702a and 3702b can be configured to allow the latching pin 3710 to move (e.g., linearly move) along a first direction and to allow the barrier return pin 3712 to move (e.g., linearly move) along a second direction different from the first direction. In some cases, the first direction can be perpendicular to the second direction. In some cases, the latching pin 3710 and the barrier return pin 3712 are spring loaded such that in the absence of an external force the spring keeps them in a default position. The spring that loads the latching pin 3710 may be configured to push the latching pin 3710 to the to the first end 3704a of the shackle 3704. In some examples, a first end of the latching pin 3710 may comprise a rounded shape adapted to be moved and latch to the first end 3704a of the shackle 3704, and a second end of the latching pin 3710 may comprise a flange configured to limit a range of motion of the latching pin 3710 when it is pushed by the spring. In some cases, the barrier 3708 may be attached to an output pin of the motor 3714 such that its position with respect the rounded end of the latching pin 3710 can be controlled by the motor 3714 to allow or prevent a movement of the latching pin 3710 with respect to the housing 3706. For example, when the barrier 3708 is in a first position, the latching pin 3710 may be pushed away by the first end 3704a of the shackle 3704 and when the barrier 3708 is at a second position, it can block the latching pin 3710 causing the first end 3704a of the shackle 3704 to stay latched to the latching pin 3710. In some cases, the spring that loads the barrier return pin 3712 may be configured to push the barrier return pin 3712 toward a top portion of the housing near the hole that receives the second end 3704b of the shackle. In some examples, a first end of the barrier return pin 3712 may comprise a first flange 3712a configured to be linked to the barrier 3708 and rotate the barrier 3708 from the first position to the second position when the shackle is pushed toward the housing 3706. A second end of barrier return pin 3712 may comprise a second flange 3712b configured to be linked to the second end 3704b of the shackle 3704 (e.g., via a flange connect to the shackle 3704) so that when the shackle 3704 is pushed toward the housing 3706, it moves the barrier return pin 3712 causing the barrier 3708 to rotate from the first position (unlock position) to the second position (lock position). In some cases, a spring 3705 disposed between the second end 3704b of the shackle 3704 and the bottom portion of the housing 3706, may load the shackle 3704 by pushing it away from the bottom portion of the housing 3706.

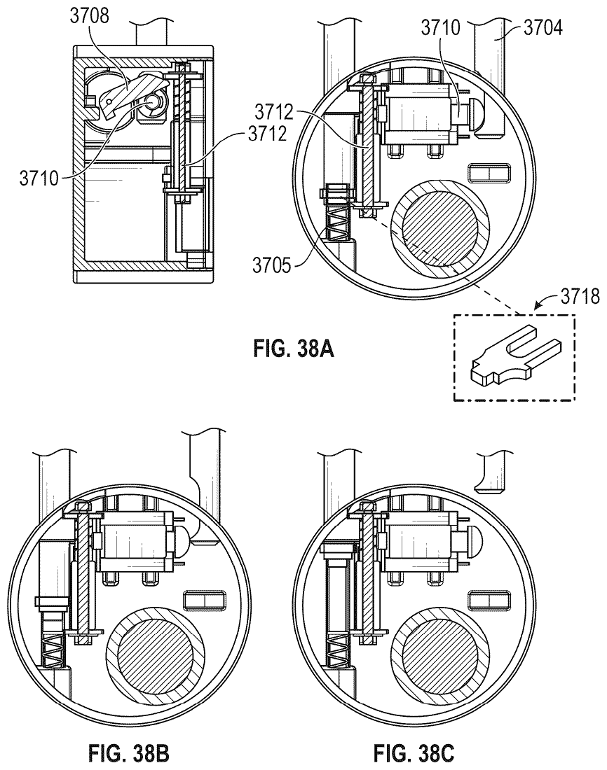

FIGS. 38A-38C show cross-sectional views of the locking system of the smart padlock 3700 during an unlocking process. In FIG. 38A the smart locking system (and thereby the smart padlock 3700) is in an unlocked state where the barrier 3708 is in the first position and does not block the movement of the latching pin 3710. However, the first end 3704a of the shackle 3704 is still within the housing 3706 and in contact with the rounded end of the latching pin 3710. In some cases, the locking state of the locking system may have been changed from a locked state to an unlocked state by the motor 3714 that rotates the barrier 3708 from the second position (where it blocks the movement of the latching pin 3710) to the first position. In some cases, the transition to the locked state may comprise, by an electronic control circuit of the smart padlock 3700, receiving an unlocking wireless signal from an authenticated electronic access device and in response to receiving the wireless unlocking signal, activating the motor 3714 to rotate the barrier 3708 from the second position to the first position. In the example shown the barrier 3708 is blocking lever and the first and second positions of the barrier 3708, are rotational positions. Advantageously, linkage between the rotational motion of the barrier 3708 and translational motion of the shackle 3704 via the latching pin 3710 allows unlocking the smart padlock 3700 with a small rotation of the barrier 3708 and with a negligible amount of energy provided to the motor 3714. In some cases, the electronic circuitry receives energy from a wirelessly chargeable power supply of the smart padlock 3700 (e.g., included in the housing 3706). In some embodiments, the electronic control circuit may first charge the power supply, e.g., via NFC, and then transmit the unlocking wireless signal for unlocking the smart padlock 3700.

In FIG. 38B the shackle 3704 has been pulled by a user and the is decoupled from the latching pin 3710. The latching pin 3710 is pushed by the first end 3704a of the shackle 3704 as shackle 3704 is pulled out. In FIG. 38C the first end of the shackle 3704 is pulled out of the housing 3706 (the smart padlock 3700 is fully unlocked) while the second end 3704b stays in the housing. In some cases, the slider 3718 (attached to the second end 3704b), stops the shackle 3704 from being pulled out of the housing 3706. Once the first end 3704a of the shackle 3704 is decoupled from the latching pin 3710, the spring that loads the latching pin 3710 moves the latching pin 3710 back into its default position.

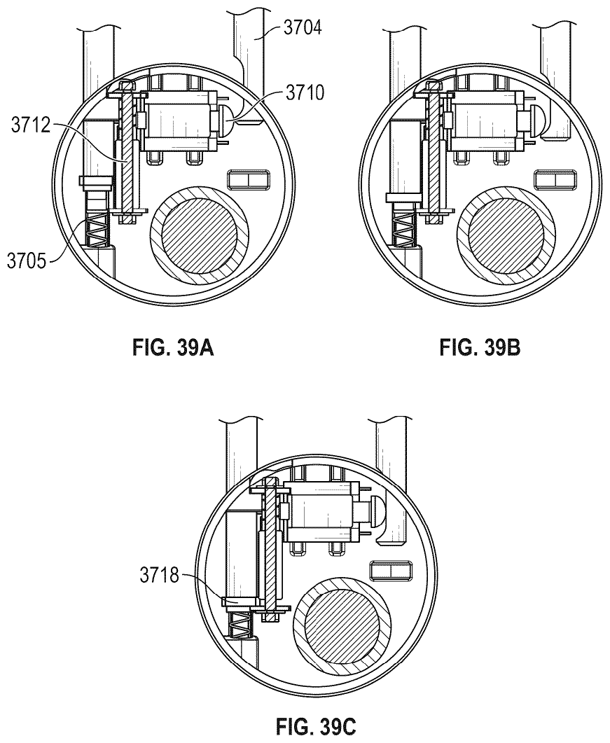

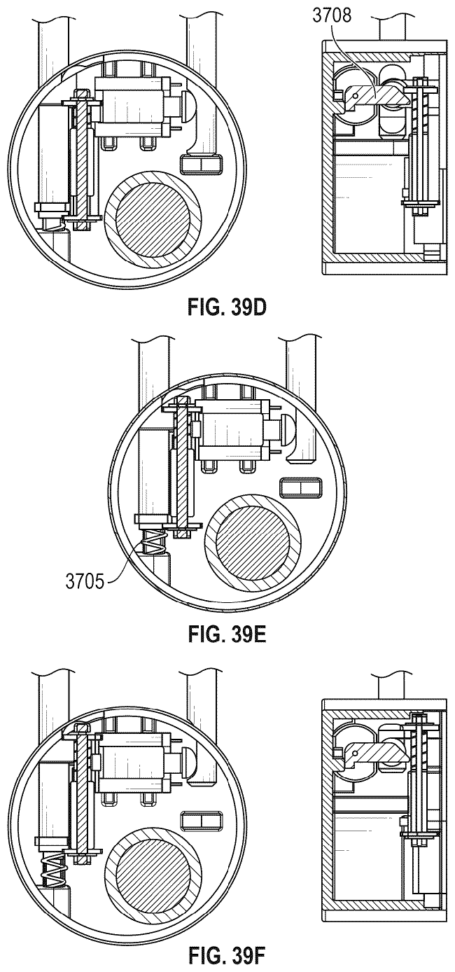

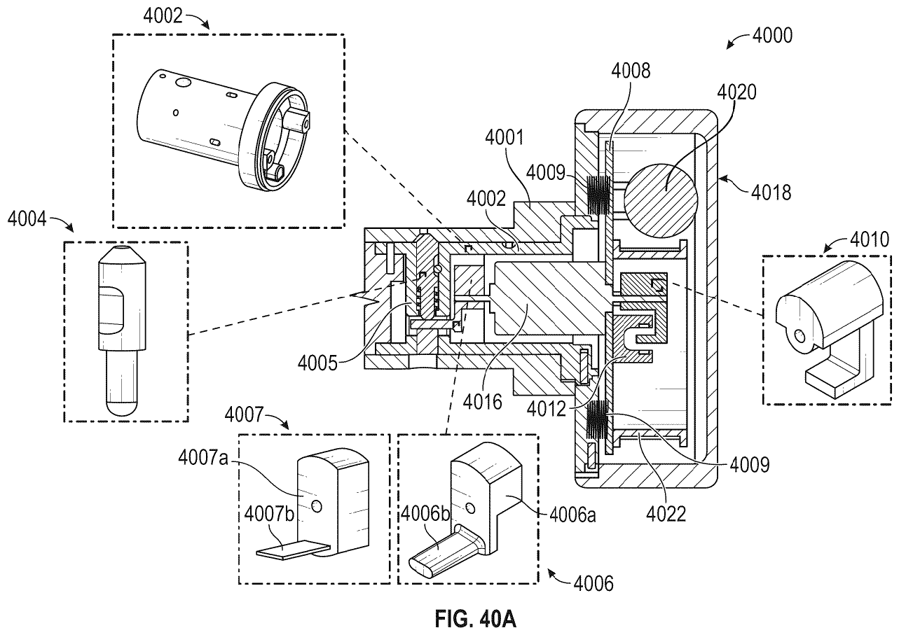

FIGS. 39A-39F show cross-sectional views of the smart padlock 3700 during a locking process where, starting from a fully unlocked position (FIG. 38C), a user pushes the shackle 3704 toward the housing 3706 to latch the shackle 3504 to the latching pin 3710 and rotate the barrier 3708 from the second position (lock position) to lock the smart padlock 3700. FIG. 39A-39C and FIG. 39E show a front cross-sectional view of the smart padlock 3700. FIGS. 39D and 39F, each show a front (left) and side (right) cross-sectional view of the smart padlock 3700. In FIG. 39A the first end 3704a of the shackle 3704 has entered the housing and pushed the latching pin away such that an edge of the shackle 3704 is in contact with the rounded end of the latching pin 3710. In this position, the latching pin 3710 is depressed and the barrier 3708 is still in the first position (unlock position) so it does not limit the movement of the latching pin 3710. In FIG. 39B, the shackle 3704 is pushed further and the spring that loads the latching pin 3710 moves the latching pin 3710 toward the notch formed at the first end 3704a of the shackle 3704. In FIG. 39C the shackle fully latched and the spring that loads the latching pin 3710 has pushed the latching pin 3710 to its default position (lock position). Additionally, the slider 3718 is engaged with the second flange 3712b of the barrier return pin 3712 and pushes down the barrier return pin 3712. As a result, the first flange 3712a of the barrier return pin 3712 rotates the barrier 3708 back to the second position. As shown FIG. 39D the user may over push the shackle 3704 further down (into the housing 3706) to rotate the barrier 3708 to the second position. In some cases, a length of the notch along the first end 3704a may be configured to allow let shackle 3704 to be over pushed. As the shackle is over pushed, the barrier return pin 3712 is pushed by the slider 3718 and causes the barrier 3708 to return the barrier 3708 to the second position (locking position). In FIGS. 39E and 39F, after the user removes the force on shackle 3704, the spring 3705 disposed between a lower portion of the housing 3706 and the second end 3704b of the shackle 3704 pushes the second end 3704b up (away from the lower portion of the housing 3706). As a result, the second flange 3712b of the barrier return pin 3712 is decoupled from the slider 3718 and the spring that loads the barrier return pin 3712 moves up the barrier return pin 3712 to its default position. Moving the barrier return pin 3712 to its default position decouples the first flange 3712a of the barrier return pin 3712 from the barrier 3708 and the barrier 3708 stays in the locked position until another unlocking wireless signal received by the electronic control circuit causes the motor 3714 to rotate the barrier 3708 to the first (unlock) position. In FIG. 39F, the shackle 3704 is latched to the latching pin 3710, the barrier 3708 blocks the latching pin 3710, and the padlock 3700 in a locked state.

### Wirelessly Powered Tap and Access Free of Battery (FOB) Cylinders

As described above to improve energy efficiency of a wirelessly powered smart lock, the locking state of a wirelessly powered lock can be controlled by moving a small and/or low weight barrier configured to prevent or allow movement of a locking element (e.g., a dead bolt) by a user-controlled element (e.g., a knob) by a user. In some embodiments a smart lock may include a wirelessly powered and controlled locking cylinder (e.g., a wirelessly powered FOB cylinder) that can be locked or unlocked via a tapping action. In some cases, a tapping action can comprise bringing an electronic access device close to the smart lock such that the electronic access device can wirelessly communicate with the lock, e.g., via NFC.

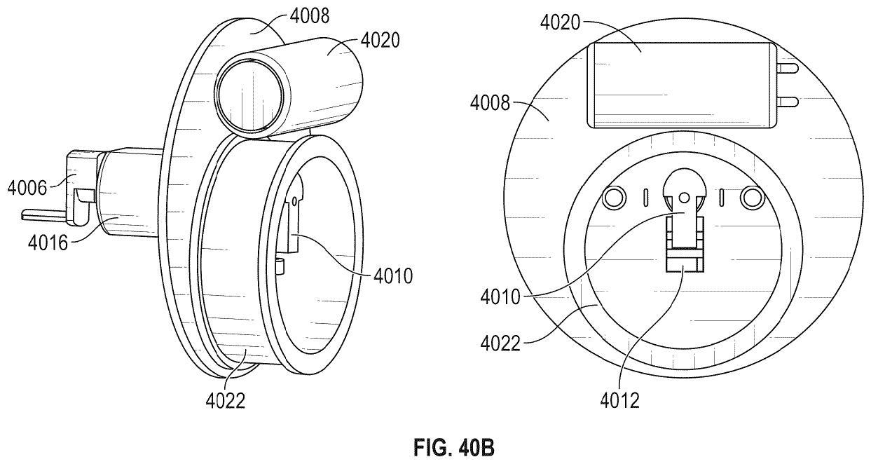

FIG. 40A shows an example smart lock that includes a wirelessly powered and controlled FOB cylinder 4000 (also referred to as locking cylinder). The FOB cylinder 4000 may comprise a core 4002, a dual shaft motor 4016, a barrier 4006 (or 4007) attached to a first output shaft of the motor 4016, and a pin 4004. In some cases, the core 4002 is rotatably linked to a housing 4001 (e.g., a housing connected to a door frame). In some cases, the housing 4001 comprises a door frame and the FOB cylinder 4000 is rotatably coupled to an opening of the door frame. In some examples, the barrier (also referred to as CAM) 4006 may comprise a main block or body 4006a and a cantilever like blocking section 4006b connected to the body 4006a. In various examples, a length of the blocking section 4006b can be from 0.5 cm to 5 cm and a width of the blocking section 4006b can be from 0.2 cm to 4 cm. In some cases, the body 4006a is connected to of the first output shaft of the motor 4016 and the barrier 4006 is aligned with respect to the pin 4004 such that by rotating the body 4006a, the motor 4016 can move the blocking section 4006b under the pin 4004 to block a translational motion of the pin 4004 away from the housing 4001 (e.g., a translation motion in a direction perpendicular to a side wall of the core 4002. The pin 4004 may comprise two cylindrical portions having different diameters or may be square or rectangular. In some cases, the thinner portion of the pin 4004 may be configured to support a spring and a thicker portion may be configured to block the spring and engage with a pin notch provided in the frame. In some cases, an end of the thicker portion may comprise a conical shape configured to fit in a pin notch and to lock the FOB cylinder 4000 when the barrier 4006 blocks an end (e.g., rounded end) of the thinner portion of the pin 4004. While in the example shown the pin 4004 comprises a cylindrical shape, in various cases, the pin 4004 may comprise other chapes.

In some cases, the motor 4016, the barrier 4006, and the pin 4004 are placed inside a cavity of the core 4002. In some cases, the motor 4016 is aligned along an axis of the core 4002, and the pin is aligned perpendicular to the axis of the core 4002. In some cases, the motor 4016 may be attached to the core 4002 and rotate with the cylinder body when a user rotates the FOB cylinder 4000. In some examples, the core 4002 includes a cylindrical sub-cavity 4005 within which the spring and the pin 4004 are positioned such that a radial motion of the pin 4004 is guided by the cylindrical sub-cavity and the spring pushes away the pin 4004 in an outward radial direction with respect to the sub-cavity 4005 through a hole in the core 4002. As such the cylindrical sub-cavity 4005 may rotationally link the pin 4004 and the FOB cylinder such that they rotate together, while allowing the pin 4004 to radially move with the respect to the core 4002. In some cases, the thicker portion of the pin 4004 may comprise a notch (e.g., an elongated notch) configured to support a rolling-element bearing (e.g., a ball bearing) to facilitate the radial motion of the pin 4004 with respect to the sub-cavity 4005.

In some cases, the motor 4016 may be attached (e.g., soldered) to a spring-loaded backplate 4008 connected to the core 4002 via two springs 4009. In some cases, the backplate 4008 may comprise a printed circuit board (PCB). As such when a vertical force (in a radial direction with respect to the core 4002) is applied on the barrier 4006 (e.g., when the pin 4004 is depressed), the springs 4009 may allow the backplate 4008 and thereby the motor to 4016 to pivot and prevent the application of excessive force on the output shaft that may cause damage. For example, when a user attempts to rotate the FOB cylinder in a no access state (when the barrier 4006 blocks the pin 4004), the excessive force applied on the pin 4004 may be transferred to the springs (instead of bending the output shaft). In some cases, the body 4006a (or 4007a0 of the barrier 4006 (or 4007) may cover or enclose the entire length of the first output shaft to prevent the shaft from bending.

In various implementations, the body 4006a and the blocking section 4006b may have different shapes and sizes and may comprise the same or different materials (e.g., metal, plastic, and the like). For example, the barrier 4007 may comprise a body 4007a made of metal and a blocking section 4007b made of plastic (or vice versa). Advantageously, a plastic blocking section 4007b can bend under excessive vertical force that may be exerted by the pin 4004. As such a flexible blocking section (e.g., a plastic blocking section) may prevent such excessive force to be transferred to the first output shaft of the motor 4016. In some examples, employing a barrier with a flexible blocking section in the FOB cylinder 4000 may eliminate the need for the springs 4009 (e.g., in these cases, the backplate 4008 may be directly connected to the core 4002).

In some cases, the second output shaft of the motor 4016 is connected to a shutter 4010 configured to intercept an optical path, an electric filed, or a magnetic field configured for position sensing. As such the shutter 4010 and the barrier 4006 are rotationally linked so that a rotational position of the shutter 4010 indicates a rotational position of the barrier. In some cases, a position sensor 4012 can be disposed on the backplate 4008 and aligned with respect to the shutter 4010 such that a portion of the shutter 4010 overlaps with a sensitive region of the position sensor 4012 to allow detection of a rotational position of the shutter 4010 and thereby a rotational position of the barrier 4006 with respect to the pin 4004. In some examples, the barrier (CAM) 4006 and the and shutter 4010 are balanced during a manufacturing and calibration process to reduce a resistance during their rotational motion by the motor 4016.

In various implementations, the position sensor 4012 may comprise an optical sensor (e.g., a photo-interrupter such as Rohm RPI-0352E), a magnetic sensor (e.g., a Hall sensor), or a contact sensor. In some examples, when the position sensor 4012 comprises an optical sensor, when the barrier is in a locking position and blocks the pin 4004 the shutter 4010 may intercept an optical path between a light source and a photodetector. In some cases, the position sensor may be configured to generate a sensor signal indicative of a rotation position of the barrier. In some cases, as the motor 4016 rotates in a stepwise manner, the position sensor generates a sensor signal indicative of an angular position of the barrier with respect to the pin 4004. In some other examples, the sensor signal may indicate whether the barrier is fully blocking the pin 4004 (e.g., the pin 4004 is perpendicular to the top surface of the blocking section 4006b) but may not indicate any angular position in between.

The backplate 4008 may comprise an electronic control circuit (or electronic board) 4008 that controls the motor 4016 and receives electric power and electric signals from an antenna 4022 (e.g., a coil antenna) disposed on the backplate 4008 and configured to receive wireless signals or wirelessly receive power from an external electronic access device (e.g., from a smart phone). In some cases, the antenna 4022 may comprise a coil warped around a cylinder body. In some case, the antenna 4022 may be positioned on the backplate 4008 such that the optical position sensor 4012 and the shutter 4010 are contained within the coil. In various implementations, the FOB cylinder 4000 may comprise other types of antennas (e.g., planar antenna on printed circuit). The electronic control circuit can include a capacitor 4020 that is charged by the electric power received via the antenna 4022 and provides the received power to the motor 4016 when discharged. In some cases, the capacitor 4020 may be charged (e.g., fully charged) during a charging period and discharge, during an unlocking period, via the motor 4016 to rotate the barrier 4006 and the shutter 4010. The FOB cylinder 4000 may comprise a back cover 4018 connected to the core 4002 and configured to contain and protect the backplate 4008, the capacitor 4020, the antenna 4022, the optical position sensor 4012, the shutter 4010, and other components of the FOB cylinder 4000 mounted on or near the backplate 4008.

Similar to a mechanical cylinder, which can be locked and unlocked using a key, when the FOB cylinder 4000 is in an access state, it can be rotated by user (e.g., via a knob) to move a locking element (e.g., a dead bolt) and when the FOB cylinder 4000 is in a no access state its rotational motion with respect to the Housing 4001 is prevented or blocked by the pin 4004.

In some cases, the barrier 4006 can block a movement of the pin 4004 to prevent the rotational motion of the FOB cylinder (the core 4002 and the components therein), with respect to the Housing 4001. For example, when the barrier 4006 is in a first position (e.g., unlock position), it may allow the pin 4004 to move (e.g., be radially pushed inside the core 4002) when a user rotates the FOB cylinder, and when the barrier 4006 is in a second position (e.g., lock position) it may block the motion of the pin 4004 and prevent the FOB cylinder from being rotated by keeping the pin 4004 engaged with a notch or hole in the Housing 4001. In some cases, the barrier 4006 and its movement between the first and second positions may be configured to allow the motor 4016 to move the barrier 4006 between the first position and the second positions using a small amount of energy. In some cases, such small amount of energy may be wirelessly transferred from an electronic access device (e.g., controlled by a user) to an electronic control circuit of the FOB cylinder 4000 that provides electric power to the motor 4016. As such, in some of the locking systems described here, the movement of a locking element (e.g., a dead bolt), which can be relatively large and heavy, can be controlled by a small and light barrier (e.g., the barrier 4006 or 4007) that can be moved using a small amount or electrical energy. In some embodiments, the motor 4016 may comprise a small and efficient motor (e.g., a latch or linear motor coil or solenoid). In some cases, the high power efficiency of the FOB cylinder 4000 may allow powering the electronic and the motor using via NFC. In some embodiments, to further reduce power consumption the barrier 4006 may be configured to move along a resistance free or nearly resistance free path when moving between lock and unlock positions. In some cases, the light weight of the barrier 4006 combined with the resistance free movement allows the FOB cylinder 4000 to operate free of battery and to be wirelessly powered via NFC by an adjacent electronic access device (e.g., a smart phone or a Keyfob). In some cases, a power supply such as a battery is used to power the FOB cylinder, but due to its lower power design, the battery life is extended.

As described above, in some cases, the FOB cylinder 4000 includes a position sensor 4012 configured to generate a sensor signal indicative of a position of the barrier 4006 (or a rotational position of the barrier 4006 or the out shaft of the motor 4016). In some implementations, the electronic control circuit of the FOB cylinder 4000 may control a position of the barrier 4006 based at least in part on the sensor signal generated by the position sensor 4012.

In some embodiments, the electronic control circuit of the FOB cylinder 4000 may receive a sensor signal from the position sensor 4012, and in response to receiving the sensor signal, wirelessly transmit a corresponding state signal to an external electronic access device so that the electronic access device can detect a state of the FOB cylinder and perform an action (e.g., generate a control signal) based at least in part on the detected state signal. For example, when the state signal indicates that the barrier 4006 is in a second or no access position (e.g., is blocking the pin 4004), the electronic access device may send an signal to the FOB cylinder 4000 to move the barrier 4006 away from the pin 4004 to a first or an access position. In some cases, the signal may cause the barrier 4006 to move (e.g., rotate) until the sensor signal indicates that the barrier 4006 is in an access position (is completely out of a path of the pin 4004). In some cases, the movement of the barrier 4006 may be automatically stopped after the electronic control circuit receives a sensor signal indicating that that barrier 4006 is in the access position and does not block the pin 4004. In some cases, the position sensor may be used to determine an initial position of the motor 4016 and/or barrier 4006 when the FOB cylinder 4000 is booting up. In some embodiments, the sensor signal received by a microcontroller of the electronic control circuit can indicate a partial blockage of the pin 4004 by the barrier 4006 and cause the microcontroller to slow down or speed up motor 4016.

In various implementations, the FOB cylinder 4000 may comprise steel, plastic, stainless steel, or other materials.

In some cases, the FOB cylinder 4000 may comprise a ball detent that holds the FOB cylinder 4000 in a temporarily fixed position relative to the housing 4001. For example, the FOB cylinder 4000 may include a spring-loaded locking ball that positions the FOB cylinder 4000 in 90-degree intervals with respect to the detent holes in the housing 4001 to which the FOB cylinder 4000 is movably connected or linked. In some cases, FOB cylinder 4000 may include a recoil spring that bring the cylinder back to its original position with respect to the housing 4001.

In some cases, housing 4001 may include two or more pin notches (e.g., notches configured to engage with the tip of the pin 4004 in a no access state. The pin notches can be of the 90 degrees apart around the circumference of the FOB cylinder 4000. As such the rotational position the FOB cylinder 4000 may be locked at two or more angular positions.

FIG. 40B shows a closeup view of the backplate 4008 and the components of the FOB cylinder 4000 that are attached to it (e.g., the dual shaft motor 4016, the capacitor 4020, the antenna (coil) 4022, and the position sensor). Also shown, are the barrier 4006 connected to the first output shaft of the motor 4016 and the shutter 4010 connected to the second output shaft of the motor 4016.

FIG. 41 illustrates an example compact FOB cylinder 4100 (also referred to as locking cylinder) that is configured to be wirelessly powered and controlled using an electronic access device. In some cases, the FOB cylinder 4100 may comprise one or more features described above with respect to the FOB cylinder 4000. In some embodiments, the FOB cylinder 4100 may comprise, a pin 4004 (e.g., a locking pin), a single-shaft motor 4016, a barrier 4006 connected to the output shaft of the motor 4016, and a cylinder body 4102 that contains the motor 4016, the barrier 4006, and the pin 4004. In some cases, the motor 4016 and the barrier 4006 may be positioned within a main cavity of the cylinder body 4102 and the pin 4004 may be positioned within a sub-cavity of the cylinder body 4102. In some cases, the cylinder body may be connected to a backplate 4106 and the motor 4016 may connect to a knob 4013 that allows a user to mechanically rotate the FOB cylinder 4100 when it is unlocked (e.g., when the barrier 4006 does not block the pin 4004). In some cases, the backplate 4106 may comprise an electronic control circuit for the FOB cylinder. The electronic control circuit may be formed on a PCB and the PCB can be integrated with the backplate 4106. In some cases, the backplate 4106 may comprise a planar antenna 4122 (e.g., a planar integrated coil or a printed antenna) that wirelessly receives power from an electronic access device and provides the received power to electronic control circuit and thereby to the motor 4016. In some cases, the electronic control circuit may be integrated within the cylinder body 4102. In some cases, the backplate 4106 can be non-metallic backplate (e.g., a plastic plate). In some examples, the backplate may be connected to the cylinder body 4102 and secured in place using force of the cylinder shell (cylindrical housing) and grooves provided on an outer surface of the cylinder body. In some cases, the electronic control circuit may communicate with an external electronic access device using NFC. Additionally, in some cases, the electronic control circuit may communicate or receive power directly from an electronic access device via conductive contacts 4104. In some cases, FOB cylinder 4100 may receive power from the electronic access device via the conductive contacts 4104 and wirelessly communicate (e.g., receive control signals) with the electronic access device using NFC.

In some cases, an NFC Keyfob or another electronic access device may be configured to be connected to the conductive contacts 4104 to provide power to the FOB cylinder 4100 and communicate with the FOB cylinder 4100 via a wireless link. In some examples, the electronic access device (e.g., the NFC Keyfob) may include a battery (e.g., a Li or LiIon rechargeable battery)

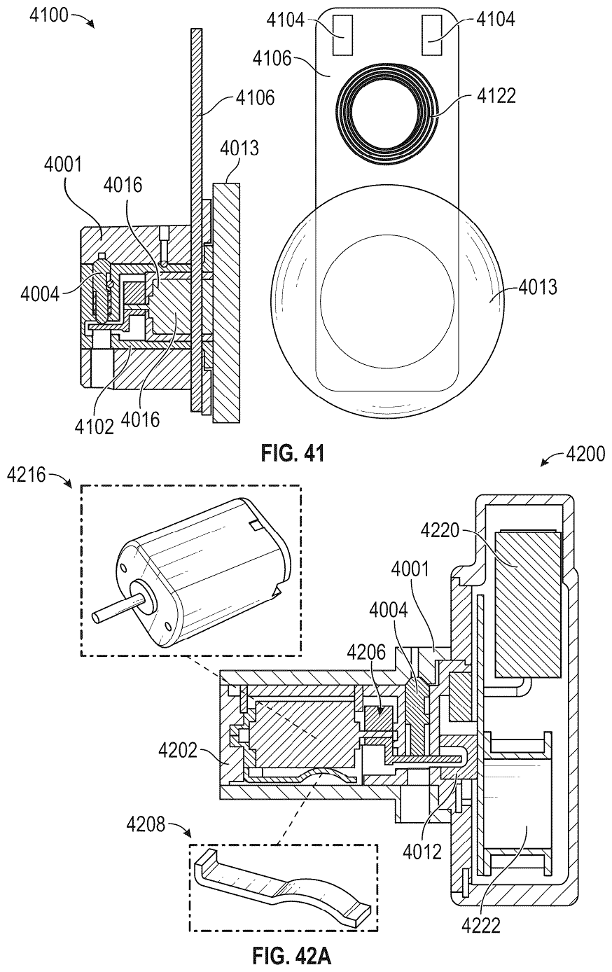

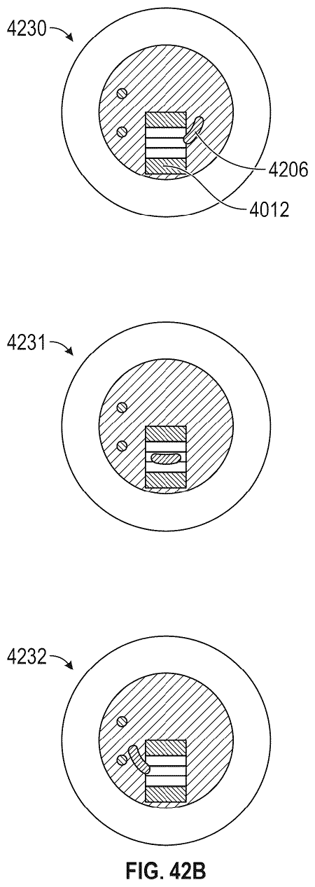

FIG. 42A illustrates another example of a compact FOB cylinder 4200 (also referred to as locking cylinder) that similar to the FOB cylinder 4200 comprises a position sensor. The FOB cylinder 4200 may comprise one or more features described above with respect to the FOB cylinder 4000. In some examples, in contrast to the FOB cylinder 4000, the FOB cylinder 4200 may use a single-shaft motor 4216 to control a barrier 4206 to block the pin 4004. In some examples, the barrier 4206 may be configured to block the pin 4004 and intercept a sensing region of a position sensor 4012. For example, the barrier 4206 may comprise a longer blocking section compared to the barrier 4006, allowing the blocking section to also serve as a shutter for the position sensor 4012 disposed near the pin 4004 within the cylinder body (cylindrical housing) 4202. In some embodiments, the motor 4016 may be positioned within a cavity of the cylinder body 4202 and mechanically linked to the cylinder body 4202 via spring leaf 4208 such that when a radial force is exerted by the pin 4004 on the barrier 4206, the motor 4216 can pivot to reduce or eliminate a force on the output shaft of the motor 4216 to which the barrier 4206 is attached. The spring leaf 4208 can be a separate part or it can be at least partially punched out of the cylinder. In some cases, during a manufacturing process the barrier 4206 may be balanced with the respect to the motor 4216 to allow smooth and low resistance rotational control. Various features of the FOB cylinder 4200 with respect to the locking mechanism, wireless control, and wireless powering are similar to those of the FOB cylinder 4000.

FIG. 42B shows, a cross-sectional view of the FOB cylinder 4200 across a cut-plane perpendicular to the output shaft of the motor 4216 and passing through the optical sensor. Panel 4230 shows that the blocking section of the barrier 4206 is rotated counterclockwise with respect to the optical position sensor 4012 and is not blocking the pin 4004 and the optical path of the optical position sensor 4012. Similarly, panel 4232 shows that the blocking section of the barrier 4206 is rotated clockwise with respect to the optical position sensor 4012 and is not blocking the pin 4004 and the optical path of the optical position sensor 4012. Panel 4231 shows that the that the blocking section of the barrier 4206 is blocking both the pin 4004 and the optical path of the optical position sensor 4012.

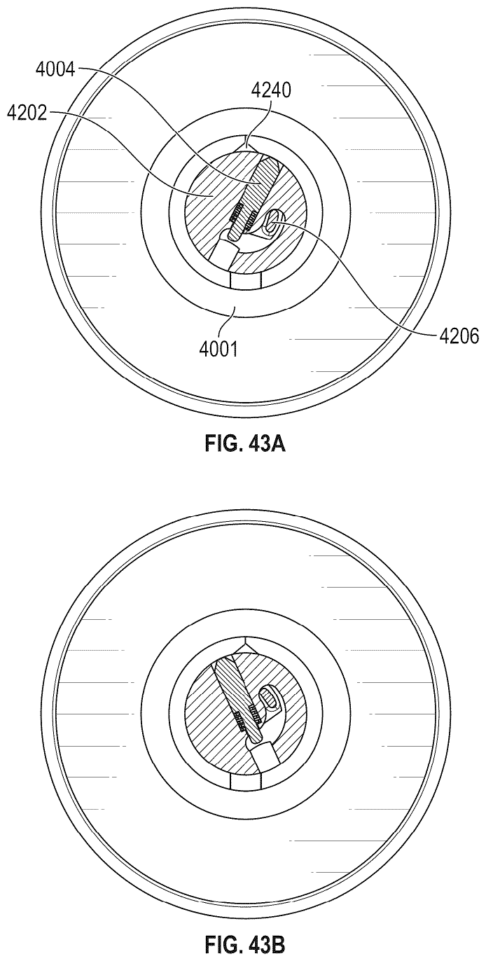

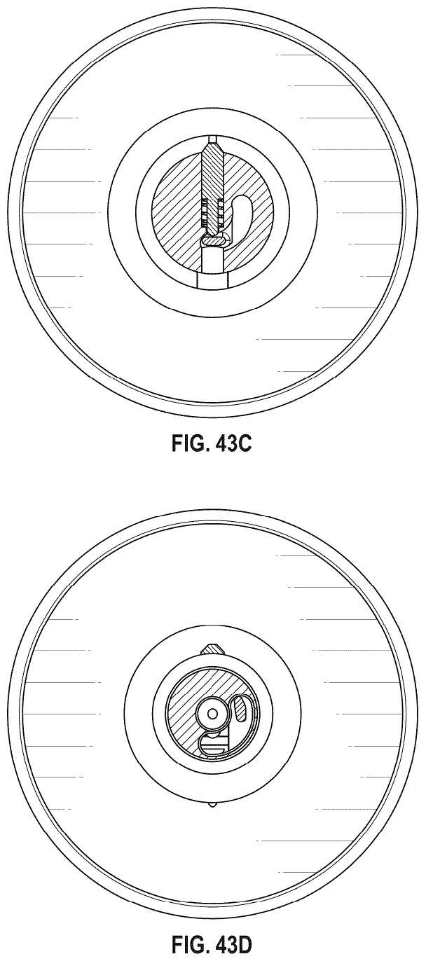

FIG. 43A-43C illustrate cross-sectional views of the FOB cylinder 4200 across a cut-plane perpendicular to the output shaft of the motor 4216 and passing through the pin 4004, viewed from the right side (opposite to the motor 4216). In FIGS. 43A and 43B the FOB cylinder 4200 is unlocked (the barrier 4206 is not blocking the pin 4004) and is rotated clockwise and counterclockwise, respectively. In both cases, the pin is not blocked and is depressed by the internal wall of the housing 4001 as the FOB cylinder 4200 is rotated (e.g., by user and via knob). In FIG. 43C the FOB cylinder 4200 is locked (the barrier 4206 is blocking the pin 4004) and the pin 4004 is engaged with the pin notch 4240 in the housing 4001. Since the barrier does not allow the pin 4004 to be pushed down (radially move toward away from the outer surface of the cylinder body 4202, the cylinder body and thereby the FOB cylinder 4200 cannot be rotated with respect to the housing 4001.

FIG. 43D illustrate a cross-sectional view of the FOB cylinder 4200 across a cut-plane perpendicular to the output shaft of the motor 4216 and between the pin 4004 and the body the barrier 4206, viewed from the left side (opposite to the optical position sensor 4012). Similar to FIGS. 43A and 43B, the FOB cylinder 4200 is unlocked (the barrier 4206 is not blocking the pin 4004) and is rotated with respect to the housing 4001 in clockwise direction (FIG. 43A) and counterclockwise (FIG. 43B) directions.

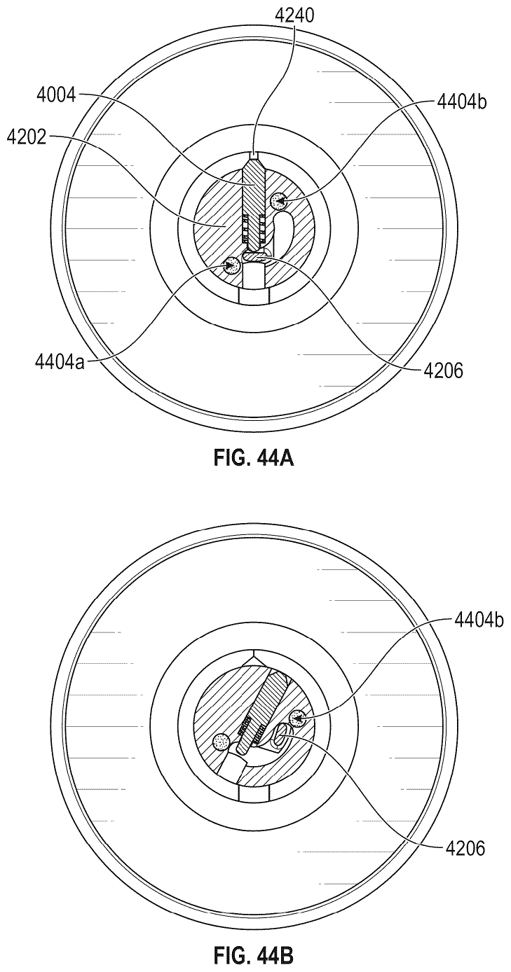

In some examples, when a FOB cylinder is rotated, the motor and the pin, which are mechanically linked to the FOB cylinder, rotate with the FOB cylinder. However, the barrier 4006 that is attached to the output shaft of the motor, may not follow the rotation of the FOB cylinder. As such a rotational position of the barrier with respect to the FOB cylinder may change as the FOB cylinder rotates. To prevent the rotation of the barrier with respect to the FOB cylinder, in some cases two weak magnets may be disposed near the two ends of the barrier slot within which the barrier moves. In various implementations, the magnets 4404a and 4404b may prevent the barrier 4006 to inadvertently move a lock position and lock the FOB cylinder, e.g., due to a motion or vibration of the FOB cylinder. FIG. 44A-44B show a cross-sectional view of an example FOB cylinder having two magnets 4404a and 4404b (e.g., two weak magnets) configured to rotate the barrier 4206 in sync with the FOB cylinder to maintain a relative rotational position of the barrier 4206 with respect to the cylinder body 4202. In FIG. 44A, the barrier 4206 is blocking the pin 4004 that is a locked position and is engaged with the pin notch 4240. In some examples, when in the locked position, the barrier 4206 may be near or at a first end of the barrier slot where a first magnet 4404a is disposed. In some embodiments the magnets 4404a/4404b are configured to keep the barrier 4206 in place (in contact with one of the magnets) when a user rotates the FOB cylinder and allow the motor to rotate the barrier 4206 from lock position (under pin 4004) to an unlock position (away from the pin 4004) and vice versa. In some examples, in response to receiving an unlocking signal from an electronic access device, the motor may decouple the barrier 4206 from the magnet 4404a and move the barrier 4206 away from the pin 4004 to unlock the FOB cylinder and thereby allow the pin 4004 to be pushed into the core 4002 when a user rotates the FOB cylinder. In some cases, the motor may rotate the barrier 4206 all the way to the second end of the barrier slot where it is coupled to the second magnet 4404b. Once the FOB cylinder is unlocked, the user may rotate the FOB cylinder (e.g., using a knob connected to the FOB cylinder) to unlock a door. In FIG. 44B, the user has moved the unlocked FOB cylinder in a clockwise direction. In some cases, when the user rotates back the FOB cylinder to its original orientation (similar to FIG. 44A), the magnet 4404b will keep the barrier 4206 at the second end of the barrier slot and prevent the barrier to move the lock position (under the pin 4004) inadvertently. In some cases, the magnets 4404a/4404b may comprise a sensor (e.g., a magnetic sensor) configured to generate sensor signal indicating a locking state of the FOB cylinder. In some cases, such sensor may detect a magnetic coupling between the barrier 4206 and the one of the magnets 4404a/4404b and thereby the position of the barrier with respect to the barrier slot. In some cases, an independent sensor, which does not rely on the magnets 4404a/4404b, may be disposed near each magnet to detect the presence or absence of the barrier 4206 at the corresponding end of the barrier slot. In some embodiments, a FOB cylinder may have two sensors disposed near the first and second end of the barrier slot instead of the magnets 4404a/4404b. In these embodiments, the sensors can detect a locking state of the FOB cylinder however the FOB cylinder does not include a mechanism for preventing accidental locking.

In some embodiments, instead of the barrier a FOB cylinder may use a worm access slider to block the movement of the pin that, when kept at a lock position, blocks the rotation of the FOB cylinder with respect to a frame. In these embodiments, the pin may comprise a notch configured to receive a tip portion of the worm access slider such that when the tip portion is engaged with the notch, it prevents movement of the pin with respect to the FOB cylinder and keeps the pin in a lock position.

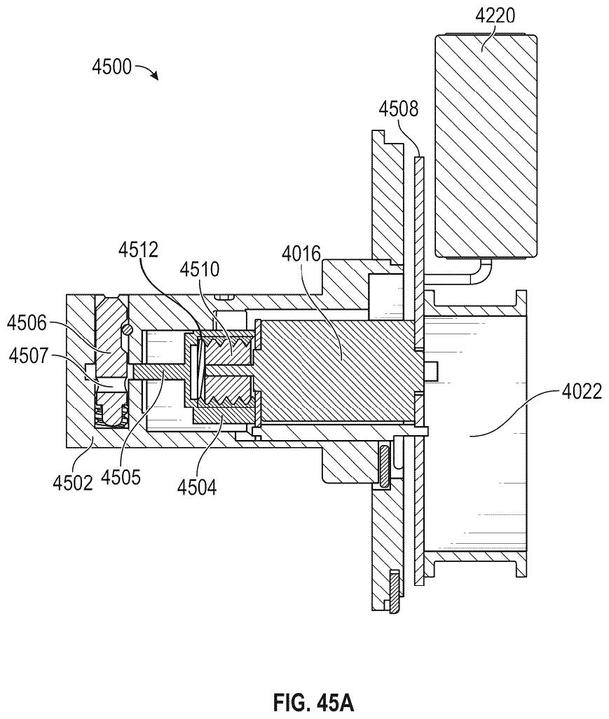

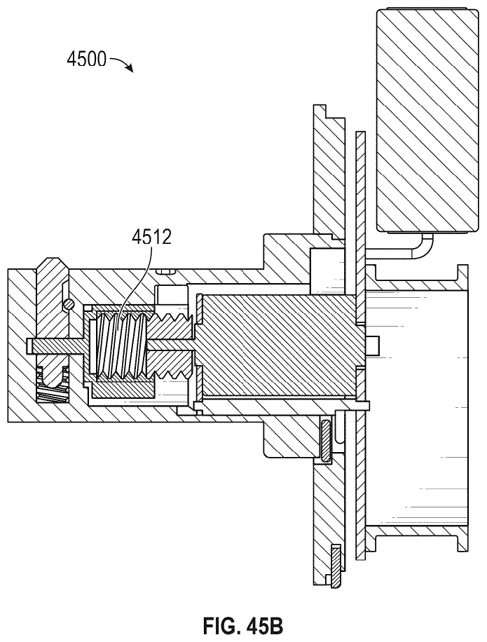

FIG. 45A illustrates a side cross-section view of another FOB cylinder 4500 (also referred to as locking cylinder) configured to control the movement of the pin 4506 using a worm access slider 4504. In some embodiments the FOB cylinder 4500 may comprise one or more features described above with respect to the FOB cylinders 4000, 4100, or 4200. In some cases, the FOB cylinder 4500 may comprise a cylinder body 4502, a spring-loaded pin 4506 disposed in a sub-cavity of the cylinder body 4502, a motor 4016, a threaded gear 4510 connected to the output shaft of the motor 4016, and the worm access slider 4504 movably linked to the threaded gear 4510. In some cases, the motor 4016, the threaded gear 4510, the motor 4016, and the worm access slider 4504, may be disposed within a main cavity of the cylinder body 4502. In some cases, the FOB cylinder 4500 may include a backplate 4508 connected to the motor 4016. In some cases, the motor 4016 can be soldered to the backplate 4508. In some cases, the backplate 4508 may comprise a PCB that includes an electronic control circuit configured to receive power and control signals from an electronic access device via an antenna 4022 (e.g., an NFC antenna such a coil) and control the motor 4016 to move the worm access slider 4504 from a lock position to an unlock position and vice versa. The electronic control circuit may include a capacitor 4220 configured to be charged by power received from the antenna 4222 and release the charge to the motor 4016. In some examples, the backplate 4508 may comprise the backplate 4106 and the antenna 4022. In some cases, the antenna 4022 may comprise a planar antenna (e.g., the planar antenna 4122).

The worm access slider 4504 is configured to be moved by the motor 4016 with respect to the pin 4506 along a linear path substantially perpendicular to a longitudinal axis of the pin 4506. In some examples, the pin 4506 may comprise a notch or hole 4507 (e.g., a through hole) configured to receive the tip 4505 of the worm access slider 4504 to latch the pin 4506 to the worm access slider 4504. The hole 4507 may be aligned along a direction substantially perpendicular to the longitudinal axis of the pin 4506. The sub-cavity of the cylinder body 4502 within which the pin 4506 is disposed may be configured to guide the pin 4506 to move in a direction substantially perpendicular to the output shaft of the motor 4016. The pin 4506 can be movable coupled the sub-cavity via ball bearing. A spring within the sub-cavity may be configured to push the pin 4506 out of the cylinder body 4502. In some cases, the spring may keep pin 4506 in a default position when the tip 4505 is out of the hole 4507.

FIG. 45A illustrates the FOB cylinder 4500 in an Access state where the tip 4505 of worm access slider 4504 is out of the hole 4507 and does not block the movement of the pin 4506. As such, in an access state a user can rotate the FOB cylinder with respect to a frame and thereby move a locking element (e.g., a dead bolt) to unlock (or lock) a door, padlock or any type of lock. In other words, when the tip 4505 is not inside the hole 4507 the user has access to lock or unlock the FOB cylinder 4500 (via a knob).

FIG. 45B illustrates the FOB cylinder 4500 in a no access state where the tip 4505 of worm access slider 4504 has been moved inside the hole 4507 and blocks the movement of the pin 4506. As such, in a no access state the user can rotate the FOB cylinder 4500 with respect to the frame and thereby move the locking element (e.g., a dead bolt) to unlock (or lock) a door. In other words, when the tip 4505 is inside the hole 4507 the user does not have access to a locking state of the FOB cylinder 4500 (via a knob).

In some examples, the FOB cylinder 4500 may comprise one or more position sensors to monitor the position of the worm access slider 4504 with respect to the pin 4506. For example, a first sensor or sensing element near a first end (e.g., away from the tip 4505) of the worm access slider 4504 and a second sensor or sensing element may be disposed near a second end (e.g., near the tip 4505) of the worm access slider 4504 to detect a position of the tip and the worm access slider 4504 with respect to the pin 4506. In some cases, the one or more sensors may comprise an optical sensor, a contact sensor, a magnetic sensor, or other types of sensors. In some cases, the one or more sensors may be mounted directly on one or more boards disposed inside the cylinder body 4502.

In some examples, the worm access slider 4504 may comprise a metal and used to short a circuit when in contact with position contact. In some such examples, the worm access slider 4504 may be part of a sensor circuit configured to generate a sensor signal indicative of the position of worm access slider 4504 with respect to the motor 4016 and/or the pin 4506.

In some cases, a contact or mechanical link between the worm access slider 4504 and the cylinder body 4502 may be configured to minimize friction when the motor moves the worm access slider 4504 with respect to the cylinder body 4502.

In some case, a spring 4512 placed inside the worm access slider 4504 may push the worm access slider 4504 away from threaded gear 4510.

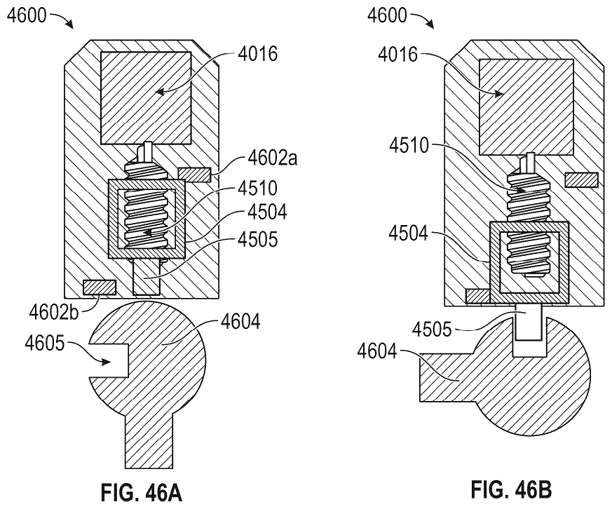

FIGS. 46A and 46B illustrate side cross-sectional views of an FOB worm lock 4600 configured to control the movement of locking element of a lock. In some cases, the FOB worm lock 4600 may lock the knob and/or the locking element without using a pin or a latch. In some cases, the FOB worm lock 4600 may directly block a knob. Similar to the FOB cylinder 4500, the FOB worm lock 4600 may comprise a worm access slider 4504 configured to be controlled by a motor 4016 and to block a movement (e.g., a rotational movement) of a knob or a latch. In some cases, the FOB worm lock 4600 may comprise a motor 4016 that is configured to move worm access slider 4504 with respect to a latch or a knob 4604 (e.g., along a linear path), and two position sensors 4602a and 4602b configured to generate a sensor signal indicative of the position of the worm access slider 4504 with respect to a latch or a knob 4604 (and thereby a locking state of the FOB worm lock 4600). For example, the position sensor 4602a may generate a sensor signal indicating that the worm access slider 4504 is in an unlock position away from the latch or a knob 4604 and the position sensor 4602b may generate a sensor signal indicating that the worm access slider 4504 is in a lock position away from the motor 4016 and close to the latch or a knob 4604. In some cases, the latch or knob 4604 may comprise a notch or slot 4605 configured to receive and to be engaged with a tip 4505 of the worm access slider 4504. In some cases, the latch or knob 4604 can be loaded with a spring (e.g., a torsion spring) configured to put the latch or knob 4604 into a default position or orientation with respect to the tip 4505. In some cases, in the default position or orientation the notch or slot 4605 can be aligned with the tip 4505 such that the motor 4016 can be push the tip 4505 into the slot or notch 4605 by linearly moving the worm access slider 4504 toward the latch or knob 4604 (e.g., via a low friction of near friction free movement). In some cases, the spring may put the knob 4604 back into the default position (e.g., orientation) after a user rotates the knob 4604 to any position (lock or unlock) different from the default position.

In FIG. 46A the FOB worm lock 4600 is in an access state where the tip 4505 of worm access slider 4504 is out of the slot or notch 4605 and does not block the movement of the latch or knob 4604 (that, in this example, rotated away from the default position). As such, in an access state a user can rotate the knob 4604, and thereby a locking element (e.g., a dead bolt), to unlock (or lock) a door. In other words, when the tip 4505 is inside the notch 4605 the user has access and can select a locking state.

In FIG. 46B the FOB worm lock 4600 is in a no access state where the tip 4505 of worm access slider 4504 is inside the slot or notch 4605 and blocks the movement of the latch or knob 4604 when the latch or knob 4604 is at the default position. As such, in a no access state a user cannot rotate the knob 4604, and thereby does not have access (cannot select) a locking state.

In some examples, the worm access slider 4504 of the FOB worm lock 4600 may not include a spring. Advantageously, eliminating the spring the couples the threading gear to the worm access slider can reduce the weight and size of the worm access slider, and increase the friction against the movement of the worm access slider (e.g., by limiting contact with chassis).

In various implementations, a position sensor of a FOB worm lock may generate a sensor signal used for stopping the motor of the FOB worm lock when a barrier or a worm access slider reaches a lock or an unlock position.

### Example Algorithm for Controlling FOB Cylinder

In some embodiments, the FOB cylinders 4000, 4100, 4200, 4500, or FOB worm lock 4600, may be configured to allow a user to have access to a locking element (e.g., a deadbolt) and change the state of a lock, e.g., using a knob or another mechanical user interface. In some examples, the user may use an electronic access device to change the state of a FOB cylinder (e.g., FOB cylinder 4000, 4100, 4200, or 4500,) or the FOB worm lock 4600, from an Access state where the user can move the locking element to lock or unlock a door or lock, to a No Access state where the knob or the locking element is locked in place and cannot be moved by the user. In some cases, when a FOB cylinder is in the No access state the movement of the locking element is mechanically linked to rotation of the FOB cylinder, the FOB cylinder is locked in place by a pin that is engaged with a pin notch in a housing, and the motion of the pin is blocked by a barrier controlled by the electronic access device.

In some cases, in the No Access state the FOB worm lock 4600 may directly block the movement of the locking element using a stopper (e.g., a tip of a worm access slide controlled by the electronic access device) into a notch or slot formed in a knob that is mechanically connected to the locking element.

In some embodiments, a user may change the state of a FOB cylinder or the FOB worm lock 4600 using a tapping action. For example, when the user brings an electronic access device (e.g., a cell phone, Keyfob, or another device) close to the FOB cylinder or the FOB worm lock 4600, e.g., within a range where NFC communication is enabled, the state of the FOB cylinder or the FOB worm lock 4600 may changes to the opposite state (Access to No Access or vice versa). In some cases, FOB cylinder of the FOB worm lock 4600 may comprise one or more position sensors (e.g., a photo-interrupter, a Hall sensor, or a contact sensor) that detect the state (Access or No Access) of the FOB cylinder or the FOB worm lock 4600 and generates sensor signals indicative of the detected state. Subsequently the electronic control circuit of the FOB cylinder or the FOB worm lock wirelessly communicates the detected state with the electronic access device and the electronic access device generates a control signal to change the state of the FOB worm lock to a state opposite to the detected state. In some examples, the tapping access may not require opening or activating an application on the electronic access device. In some cases, the tapping action automatically executes an authentication process followed by a state change process, when the authentication process is successful. In some examples, the one or more sensors may generate a sensor signal indicative of a relative position of a barrier, or a worm access slider with respect to a barrier, a locking element (e.g., a latch), or a knob.

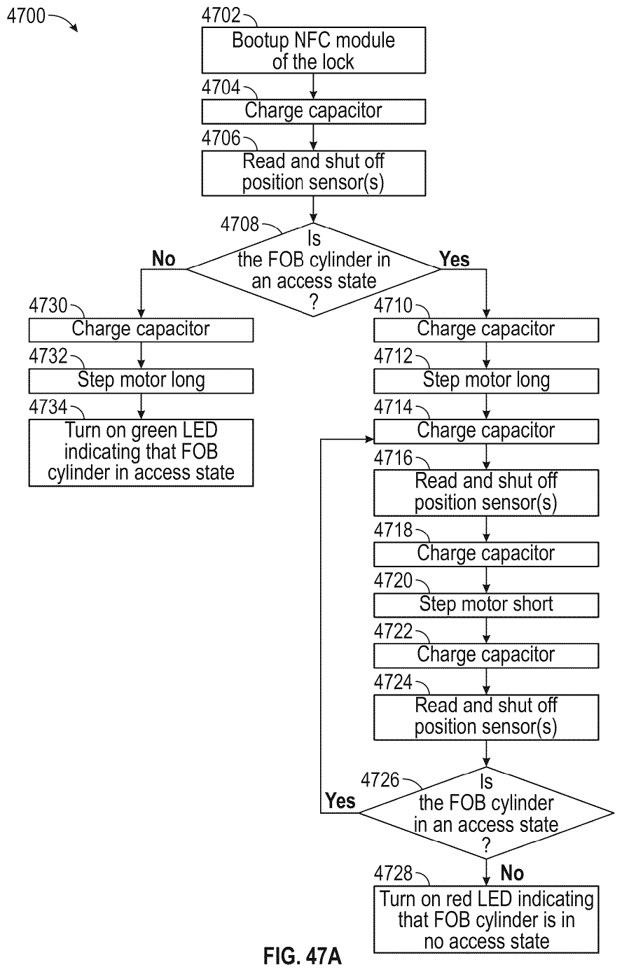

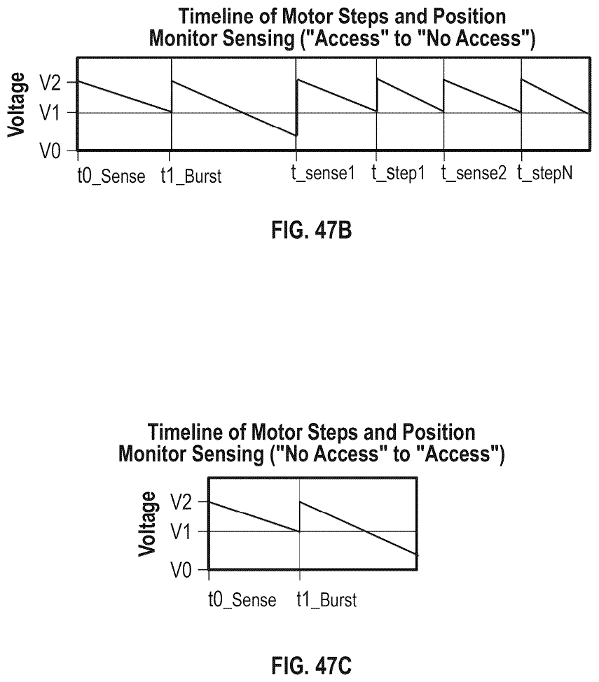

FIG. 47A is a flow diagram illustrating an example process 4700 that may be used by an electronic access device or an electronic control circuit (e.g., a microcontroller) of a smart lock, to change the state of a FOB lock (e.g., FOB cylinders 4000, 4100, 4200, 4500, or FOB worm lock 4600), from Access to No Access and vice versa, e.g., using a tapping action. In some cases, the process 4700 may be performed by a hardware processor (referred to as processor) of the electronic access device or a hardware processor of a FOB lock (e.g., FOB cylinders 4000, 4100, 4200, 4500, or FOB worm lock 4600). For example, the processor can be a hardware processor of the electronic control circuit of the FOB lock. In some cases, the process 4700 may be performed by both a hardware processor of the electronic access device and the electronic control circuit of the FOB lock. For example, when a step is triggered by the electronic access device, the next step may be automatically performed by the electronic control circuit of the FOB lock (e.g., a microcontroller). In some cases, the electronic access device may wirelessly communicate with an electronic control circuit (e.g., a microcontroller) of the FOB lock via NFC, Bluetooth, or Wi-Fi using an antenna of the FOB lock. In some cases, the electronic control circuit of the FOB lock may comprise a NFC module configured to wirelessly communicate with the electronic access device and wirelessly receive electric power from the electronic access device.

The process 4700 begins at block 4702, by bringing the electronic access device close to the FOB lock (the tapping action), and booting up the electronic control circuit (e.g., the NFC module) of the FOB lock. In some cases, a processor (microcontroller of the FOB lock) may receive a wireless signal indicative of the tapping action via the antenna, and in response boot up the electronic control circuit.

at block 4704 the processor a capacitor of the FOB lock by transferring electric, magnetic, or electromagnetic energy to an antenna of the FOB lock that converts the received energy to electric charge stored in the capacitor.

At block 4706 the processor receives a wireless sensor signal from the electronic control device of the FOB lock. In some cases, after the capacitor is charged at block 4704, the electronic control circuit of the FOB lock may activate the position sensor to generate a sensor signal indicative of the state of the FOB lock. In some cases, after the capacitor is charged at block 4704, the electronic access device may send a trigger signal to the control circuit of the FOB lock to activate the position sensor to generate a sensor signal indicative of the state of the FOB lock. In some cases, the electronic control circuit of the FOB lock, or the electronic access device may be configured to activate the position sensor for a position sensing period and shut it off after the position sensing period. In some cases, the position sensing period can be from 10 to 20 microseconds, from 20 to 30 microseconds, from 30 to 40 microseconds, from 40 to 50 microseconds, or any ranges formed by these values.

At the decision block 4708 the processor determines whether the wireless sensor signal received from the FOB lock indicates that the FOB lock is in an Access or in a No Access state. If the wireless sensor signal received from the FOB cylinder indicates the FOB lock is in Access state, the process moves to block 4730 and a process to change the state to No Access state is performed. If the wireless sensor signal received from the FOB lock indicates the FOB lock is in No Access state, the process moves to block 4710 and a process to change the state to Access state is performed.

To change the state to No Access, at block 4710 the processor charges the capacitor of the FOB lock.

At block 4712 the processor causes the motor to perform a long step rotation using the charge provided by the capacitor. In some cases, a long step may comprise providing a burst signal to the motor to rotate a barrier or a worm access slider toward a pin, a knob, or a latch.

At block 4714 the processor charges the capacitor of the FOB lock for another sensor readout.

At block 4716 the processor, may perform another position determination step similar to block 4706 to determine a position of the barrier or worm access slider.

At block 4718 the processor charges the capacitor of the FOB lock for another sensor readout.

At block 4720 the processor causes the motor to perform a short step rotation using the charge provided by the capacitor. In some cases, a short step may comprise providing a step signal to the motor to rotate a barrier or a worm access slider toward a pin, a knob, or a latch to block the pin, the knob, or the latch. In some case, the long step at block 4712 can bring the barrier or a worm access slide close to a lock position, as such the short step rotation may comprise a small movement of the barrier or the worm access slider to block the pin, the knob, or the latch.

At block 4722 the processor charges the capacitor of the FOB lock for another sensor readout.

At block 4724 the processor and/or the electronic control circuit of the FOB lock, may perform another position determination step similar to block 4706 to determine a position of the barrier or worm access slider.

At the decision block 4726 the processor determines whether the wireless sensor signal received from the FOB lock indicates that the FOB lock is in an Access or in a No Access state. If the wireless sensor signal received from the FOB lock indicates the FOB lock is in Access state, the process moves back to block 4718 to further move the barrier or worm access slider and to block the pin, the knob, or the latch.

If the wireless sensor signal received from the FOB lock indicates the FOB lock is in No Access state, the process moves to block 4728 and the electronic control circuit of the FOB lock turns on a red-light emitting diode (LED), e.g., on the FOB lock to indicate that the FOB lock has successfully moved to the No Access position. Alternative or in addition in some cases, at block 4728 a No Access indicator may be displayed on a user interface of the electronic access device to indicate that the FOB lock has successfully moved to the No Access position.

To change the state to Access, at block 4730 the processor charges the capacitor of the FOB lock.

At block 4732 the processor causes the motor to perform a long step rotation using the charge provided by the capacitor. In some cases, a long step may comprise providing a burst signal to the motor to rotate a barrier or a worm access slider away from a pin, a knob, or a latch. In some cases, the burst signal may be configured to move a pin, a knob, or a latch such that the barrier or the worm access slider is completely unblocked.

At block 4734 the electronic control circuit of the FOB lock turns on a green light emitting diode (LED), e.g., on the FOB cylinder to indicate that the FOB lock has successfully moved to the Access position. Alternative or in addition in some cases, at block 4728 an Access indicator may be displayed on a user interface of the electronic access device to indicate that the FOB lock has successfully moved to the Access position.

FIG. 47B is an example temporal variation of the voltage provided to the position sensor and the motor during a locking process where the locking state of the FOB lock (e.g., the FOB cylinder 4000, 4100, 4200, 4500, and FOB worm lock 4600) is changed from Access to No Access. In some cases, the voltage variation shown in FIG. A, can be the capacitor voltage that is selectively provided to the position sensor or the motor by the electronic control circuit of the FOB lock during different periods of the locking process. Please verify. In some examples, the during a first position sensing period from t0 to t1 the capacitor charge is used to activate the position sensor to measure the locking state. Next, after charging the capacitor, at time t1 the capacitor charge is used to provide a burst to the motor to perform a long step during a preliminary moving period. After the preliminary moving period, the capacitor is charged again, and its charge is used to activate the position sensor at time tsens−1 for checking the locking state after the long step. Next, the capacitor is charged again, and its charge is provided to the motor to perform a first short step at time t2. The first short step is followed by charging the capacitor and another position measurement at tsens−2. In some embodiments, the wave form between tsens−1 and tsens−2 is repeated until the outcome of a position measurement indicates that the FOB lock is in a No Access state.

FIG. 47C is an example temporal variation of the voltage provided to the position sensor and the motor during an unlocking process where the locking state of the FOB lock (e.g., the FOB cylinder 4000, 4100, 4200, 4500, and FOB worm lock 4600) is changed from No Access to Access. In some examples, the during a first position sensing period from t0 to t1 the capacitor charge is used to activate the position sensor to measure the locking state. Next, after charging the capacitor, at time t1 the capacitor charge is used to provide a burst to the motor to perform a long step to move the barrier away from a lock position and unlock the FOB lock.

It should be appreciated that the unlocking process may be performed with a single long step rotation of the motor while the locking process further comprises a sequence of position measurement and short step rotations because the barrier blocks the pin in a specific rotational position while as soon as the barrier is rotated away from the specific rotational position, eh FOB lock is unlocked and an accurate angular position is not required for unlocking the FOB lock.

In various embodiments described above, the motor configured to move a barrier or worm access slider between move between a first state associated with a locked position and a second state associated with an unlocked position.

In various implementations described above, the electronic access device can be configured to change the state of a smart lock between a locked state and an unlocked state with or without user interaction with the electronic access device and/or a mobile application running on the electronic access device. In some embodiments, the mobile application can be a separate application that runs on the electronic access device (e.g., something a user can download). In some embodiments, the mobile application can be included as part of the operating systems of the electronic access device (e.g., built-into the OS by an OS developer or phone manufacturer).

In various implementations, the lock clutch cylinder 2802, the padlocks 3500 and 3700, the FOB cylinders 4000, 4100, 4200, 4500, and the FOB worm lock 4600 may include an electronic control circuit that comprises one or more of the features described above with respect to electronic locks 1930, 2030, or 2130. The electronic control device may communicate with and receive power from an electronic access device (also referred to as electronic access apparatus or electronic key) that comprises one or more features described above with respect to electronic access apparatus 1910, 2010, or 2110.

In various implementations, the padlocks 3500 and 3700, a smart lock that uses the lock clutch cylinder 2802, FOB cylinders 4000, 4100, 4200, 4500, or the FOB worm lock 4600 may include an one or more features described above with respect FIG. 19, FIG. 20, FIG. 21, FIG. 22, FIG. 23A-23B, FIG. 24A-24B, FIG. 26B, and FIG. 27.

### Example Embodiments

Various additional example embodiments of the disclosure can be described by the following clauses:

### Group 1

Example 1. A rechargeable electronic key for use with an electronic lock comprising:
a memory device;
a private identifier for the electronic key stored in the memory device, the private identifier being accessible to the electronic lock but not readily accessible to a user of the electronic key;
a key controller configured to electrically connect to a lock controller associated with the electronic lock;
a power management circuit configured to electrically connect to a power source; and
a rechargeable battery;
wherein the power management circuit is configured to supply energy from the rechargeable battery to other components of the electronic key, to supply energy from the rechargeable battery to the electronic lock when the electronic key is engaged with the electronic lock, and to recharge the rechargeable battery when the power management circuit is connected to the power source.

Example 2. The electronic key of Example 1, further comprising:
a power path electrically connected to the rechargeable battery, the power path being configured to electrically connect to a powered bus connector; and
a data path electrically connected to the key controller, the data path being configured to electrically connect to a data bus associated with the electronic lock.

Example 3. The electronic key of Example 2, wherein the power path and the data path share an external connector disposed on the electronic key.

Example 4. The electronic key of Example 3, wherein the external connector comprises a Universal Serial Bus (USB) connector.

Example 5. The electronic key of Example 1, further comprising a detection circuit for determining when the power connector is connected to a powered bus that provides more than a threshold electric potential, wherein the detection circuit outputs a signal that is communicated to the key controller to cause the key controller to enable a battery charger to charge the rechargeable battery when the powered bus provides more than the threshold electric potential.

Example 6. An electronic access control system having switchable power states comprising:
an electronic key comprising:
a key housing;
a first connector disposed on the key housing, the connector having a key power supply pin and a key ground pin, and the first connector being configured to electrically connect to a digital bus associated with the electronic lock;
a microcontroller;
a battery;
a switching device connected between the battery and the power supply pin of the first connector and configured to allow energy to flow from the battery to the power supply pin of the first connector when the electric potential on the first connector side of switching device is less than the electric potential on the battery side of the switching device.

Example 7. The electronic access control system of Example 6, wherein the switching device comprises a diode.

Example 8. The electronic access control system of Example 6, further comprising:
an electronic lock comprising:
a lock chassis;
a lock controller; and
a second connector having a lock ground pin, the lock ground pin being electrically connected to the lock chassis, the second connector being configured to electrically connect to the first connector;
wherein the key ground pin is isolated from ground when the first connector is not connected to the second connector; and
wherein the key ground pin connects to the lock chassis, and the battery of the electronic key supplies electrical energy to the electronic access control system, when the first connector is connected to the second connector.

Example 9. The electronic access control system of Example 6, wherein the first connector comprises a USB connector.

Example 10. An electronic lock that generates electrical energy comprising:
a lock memory;
key access information stored in the lock memory;
a key connector having a power supply pin;
a generator configured to be driven by movement of an electronic key when the electronic key is used in the key connector;
a lock circuit; and
a latch electrically connected to the lock circuit, the latch being configured to actuate between a locked state and an unlocked state when an identifier associated with the electronic key is present in the key access information stored in the lock memory;
wherein the generator is configured to at least partially power at least one of the lock circuit and the electronic key.

Example 11. The electronic lock of Example 10, wherein the generator is linked to a linear gear, wherein insertion of the electronic key into the key connector causes translational movement of the linear gear, and wherein translational movement of the linear gear causes the generator to produce electrical energy.

Example 12. The electronic lock of Example 11, further comprising a spring connected to the linear gear, wherein the spring exerts a force that causes translational movement of the linear gear after the spring is moved out of an equilibrium state.

Example 13. The electronic lock of Example 10, wherein the latch comprises a piezoelectric latch.

Example 14. The electronic lock of Example 10, wherein the key connector comprises an elongate dimension that is situated coaxially with respect to a gear, and wherein a mechanical linkage between the key connector and the gear causes the generator to generate electrical energy when torque is applied to a housing of the electronic key.

Example 15. The electronic lock of Example 10, further comprising a linkage between the key connector and the generator, the linkage being configured such that the generator converts at least portions of both translational movement of the electronic key and rotational movement of the electronic key into electrical energy.

Example 16. An electronic key for use with an electronic lock and for storing digital files comprising:
a key memory;
a private identifier for the electronic key, the private identifier being accessible to the electronic lock but not readily accessible to the user of the electronic key;
a digital bus connector, the digital bus connector being configured to electrically connect to a digital bus associated with the electronic lock, and the digital bus connector being configured to electrically connect to a digital bus associated with a computer system having a microprocessor, a main memory, and an operating system; and
a microcontroller configured to allow the computer system to access the key memory as a mass storage device.

Example 17. The electronic key of Example 16, wherein the microcontroller implements a file system on the key memory selected from the group consisting of FAT, FAT32, NTFS, UFS, Ext2, HFS, and HFS Plus.

Example 18. The electronic key of Example 16, wherein the electronic key is configured to allow the computer system to access the key memory device using the USB Mass Storage Device specification.

Example 19. The electronic key of Example 16, wherein the electronic key comprises a socket for a removable solid state non-volatile memory device.

Example 20. An electronic access control system with a streamlined user interface comprising:
an electronic lock comprising:
a lock memory configured to store key access information;
a lock identifier;
a lock controller comprising program code for comparing a key identifier to the key access information stored in the lock memory; and
a lock bus connector;
a first electronic key comprising:
a first memory device;
a lock configuration file comprising key access information for configuring the electronic lock;
a first private identifier for the first electronic key, the first private identifier being accessible to the lock controller but not readily accessible to a user of the first electronic key;
a first key controller comprising program code for providing key access information to the electronic lock when first predetermined criteria are met, program code for accessing the electronic lock when second predetermined criteria are met, and program code for erasing the electronic lock when third predetermined criteria are met; and
a first digital bus connector configured to electrically connect to the lock bus connector; and
a second electronic key comprising:
a second memory device;
a second private identifier for the second electronic key, the second private identifier being accessible to the lock controller but not readily accessible to a user of the second electronic key;
a second key controller comprising program code for accessing the electronic lock without user input when fourth predetermined criteria are met; and
a second digital bus connector configured to electrically connect to the lock bus connector.

Example 21. The electronic access control system of Example 20, wherein the lock memory and the lock controller are contained on a single integrated circuit.

Example 22. The electronic access control system of Example 20, wherein the first predetermined criteria further comprise at least one of whether a date associated with a lock configuration file stored on the electronic key is more recent than a date associated with the key access information stored in the electronic lock or whether the electronic key has privileges to update locks in a domain of the electronic lock.

Example 23. The electronic access control system of Example 20, wherein the second predetermined criteria comprise whether the key access information stored in the electronic lock includes the private identifier of the electronic key.

Example 24. The electronic access control system of Example 20, wherein the third predetermined criteria comprise at least one of whether the electronic key has privileges to erase the key access information from the electronic lock or whether the key access information in the lock configuration file shows that no keys have access privileges for the electronic lock.

Example 25. The electronic access control system of Example 20, wherein the fourth predetermined criteria comprise whether the key access information stored in the electronic lock includes the private identifier of the electronic key.

### Group 2

Example 1. An electronic key configured to access an electronic lock, the electronic key comprising:
a key controller connected to a lock connection interface, wherein the lock connection interface implements an electronic serial data communications interface, wherein the electronic serial data communications interface is connectable to an external computing system and to the electronic lock;
a power source comprising a battery connected to the key controller; and
a storage device configured to implement a file system compatible with an operating system of the external computing system, wherein the file system comprises file system attributes including a volume name;
wherein the storage device stores a private key identifier, instructions executable by the key controller, and a public key identifier comprising the volume name, wherein the instructions, when executed, cause the key controller to transmit the public key identifier to the electronic lock when the electronic key is used to access the electronic lock.

Example 2. The electronic key of Example 1, wherein storage device is formatted to support the file system.

Example 3. The electronic key of Example 1, wherein the public key identifier is modifiable.

Example 4. The electronic key of Example 1, wherein a modified public key identifier does not prevent the electronic key from accessing an electronic lock.

Example 5. The electronic key of Example 1, wherein upon modification of the public key identifier of the electronic key:
a lock configuration file associated with the electronic lock is updated based at least in part on the relationship between the public key identifier and a modified public key identifier, wherein the lock configuration comprises a key access information comprising a list of electronic keys having access for the electronic lock; and
an updated lock configuration file grants the electronic key an access to the electronic lock. The electronic key of Example 1, wherein the public key identifier and the private key identifier are stored at specific location of the storage device of the electronic key.

Example 6. The electronic key of Example 5, wherein the public key identifier and the private key identifier comprise a location identifier configured to identify location of the public key identifier and the private key identifier.

Example 7. The electronic key of Example 1, wherein the private key identifier is a unique identifier that is not modifiable.

Example 8. The electronic key of Example 1, wherein a shared secret is generated based at least in part on the private key identifier.

Example 9. The electronic key of Example 1, wherein the shared secret is generated based at least in part on the private key identifier and the public key identifier of the electronic key.

Example 10. The electronic key of Example 1, wherein the instructions further cause the key controller to generate a shared secret based at least in part on the private key identifier.

Example 11. The electronic key of Example 10, wherein the shared secret is generated based at least in part on the public key identifier.

Example 12. The electronic key of Example 10, wherein the shared secret is a private identifier of the electronic lock and the electronic key.

Example 13. The electronic key of Example 1, wherein the electronic lock stores a public lock identifier and a private lock identifier.

Example 14. The electronic key of Example 1, wherein the public key identifier of the electronic key is wirelessly transmitted to the electronic lock.

Example 15. The electronic key of Example 1, wherein the battery is a rechargeable battery.

Example 16. The electronic key of Example 1, wherein the electronic key is configured to couple with the electronic lock.

Example 17. The electronic key of Example 16, wherein the coupling between the electronic key and the electronic lock causes the electronic lock to recharge the battery of the electronic key.

Example 18. The electronic key of Example 1, wherein the lock connection interface comprises a wireless communication module configured to establish a wireless communication between the electronic key and the electronic lock.

Example 19. The electronic key of Example 1, wherein the shared secret is shared between the electronic key and the electronic lock without the shared secret transmitted between the electronic key and the electronic lock.

Example 20. The electronic key of Example 1, wherein the shared secret is used to generate an encrypted identifier, wherein the encrypted identifier is transmitted to the electronic lock to authenticate the electronic key.

Example 21. The electronic key of Example 1, wherein the storage device further stores a lock configuration file.

Example 22. The electronic key of Example 21, wherein the lock configuration file comprises at least one of: a lock alias, a lock identifier, key access information, a public key identifier, key type information, or a key alias.

Example 23. The electronic key of Example 21, wherein the lock configuration file is a text file readable by text editing software, an application, an applet, or an executable file.

Example 24. The electronic key of Example 1, wherein the instructions, when executed, further cause the key controller to:
determine that the electronic lock is not initialized;
generate a lock configuration file; and
associate the lock configuration file with the electronic lock.

Example 25. The electronic key of Example 24, wherein the electronic key is configured as a master key for the electronic lock.

Example 26. The electronic key of Example 1, wherein the instructions, when executed, further cause the key controller to share the shared secret with the electronic lock without communicating the private key identifier between the electronic key and the electronic lock.

Example 27. The electronic key of Example 1, wherein the lock connection interface comprises one or more rails and one or more notches, wherein the one or more rails allow the lock connection interface to be inserted into an opening of the electronic lock, and wherein the one or more notches prevent decoupling of the lock connection interface from the electronic lock.

Example 28. The electronic key of Example 1, wherein the lock connection interface is configured to be inserted into the opening of the electronic lock when in a first orientation, and wherein the lock connection interface is prevented from decoupling from the electronic lock when in a second orientation.

Example 29. An electronic lock configured to provide access to an electronic key, the electronic lock comprising:
a lock controller connected to a key connection interface, wherein the key connection interface implements an electronic serial data communication interface, wherein the electronic serial data communications interface is connectable to an external computing system and to the electronic key; and
a storage device that stores instructions executable by the lock controller, a private lock identifier, and a public lock identifier, and wherein the instructions, when executed by the lock controller, cause the lock controller to:
receive a public key identifier from the electronic key when the electronic key is coupled to the electronic lock via the electronic serial data communication interface; and
generate a shared secret using the private key identifier, wherein the shared secret is shared between the electronic key and the electronic lock without communicating the private key identifier between the electronic key and the electronic lock.

Example 30. The electronic lock of Example 29, wherein the electronic lock comprises a lock configuration file, wherein the lock configuration file comprises a key access information comprising a list of electronic keys having access to the electronic lock.

Example 31. The electronic lock of Example 30, wherein upon modification of the public key identifier of the electronic key:
the lock configuration file is updated based at least in part on a relationship between the public key identifier and modified public key identifier; and
the electronic lock grants access the electronic key based at least in part on the updated lock configuration file.

Example 32. A method of accessing an electronic lock with an electronic key, the method comprising:
establishing a connection between an electronic key and an electronic lock, wherein the electronic key comprises a storage device storing a private key identifier and a public key identifier;
transmitting the public key identifier from the electronic key to the electronic lock;
generating a shared secret based at least in part on the private key identifier;
sharing the shared secret between the electronic key and the electronic lock; and
authenticating the electronic key based at least in part on the shared secret.

Example 33. An electronic key comprising:
a gripping portion comprising a housing, the housing comprising a processor and an electronic storage unit;
a data transfer portion connected to the gripping portion and comprising:
an electronic data communications interface;
one or more rails; and
one or more notches formed and positioned between a pair of rails of the one or more rails;
wherein the data transfer portion is configured to move between a first orientation and a second orientation;
wherein, when the data transfer portion is in the first configuration, the one or more rails allow the data transfer portion to be inserted into the opening of the electronic lock; and
wherein, when the data transfer portion is in the second configuration, the one or more notches prevent decoupling of the data transfer portion from the electronic lock.

### Group 3

Example 1. A rechargeable electronic apparatus for use with an electronic lock, the apparatus comprising:
a housing comprising:
a processor configured to communicate with a lock microcontroller associated with the electronic lock;
a memory device storing a key identifier;
a rechargeable battery, configured to supply energy to components of the apparatus;
an electromagnetic radiation source configured to
transmit a wireless digital data signal to an electromagnetic radiation receiver,
transmit a wireless power signal to the electronic lock to provide power to the electronic lock sufficient to actuate a lock mechanism within the electronic lock, and
wherein the electromagnetic radiation source is configured to transmit the key identifier to the lock microcontroller via the digital data signal,
wherein the apparatus is capable of actuating the electronic lock without any electrical conductor power connection to the electronic lock,
wherein the apparatus and/or optical light incident on the electronic lock are the only sources of electric power for the electronic lock.

Example 2. The apparatus of Example 1, wherein the electromagnetic radiation source is an optical light source.

Example 3. The apparatus of Example 2, wherein the electromagnetic radiation source is configured to transmit power via the optical light source.

Example 4. The apparatus of Example 2, wherein the electromagnetic radiation source is configured to transmit the digital data signal via the optical light source.

Example 5. The apparatus of Example 1, wherein the housing comprises a display, the display having a user interface having a visual indication of a status of the electronic lock, and one or more control elements configured to control the operation of the electronic lock.

Example 6. The apparatus of Example 1, wherein the apparatus is a mobile phone.

Example 7. The apparatus of Example 1, wherein the apparatus is an electronic key.

Example 8. The apparatus of Example 1, wherein the apparatus does not have a mechanical configuration that is configured to match a mating mechanical configuration of the electronic lock.

Example 9. The apparatus of Example 1, wherein the electromagnetic radiation source configured to transmit the wireless digital data signal and the wireless power signal is the same.

Example 10. The apparatus of Example 1, wherein the electromagnetic radiation source comprises an antenna configured to transmit radio frequency signals.

Example 11. The apparatus of Example 10, wherein the antenna is configured to transmit the digital data signal and the power signal to the electronic lock.

Example 12. The apparatus of Example 11, wherein the antenna is configured to transmit the power signal to the electronic lock via contactless inductive coupling.

Example 13. An electronic lock capable of being locked and unlocked with a handheld electronic apparatus, the electronic lock comprising:
a lock housing;
a lock mechanism electrically connected to the lock controller, the lock mechanism configured to actuate between a locked state and an unlocked state;
an electromagnetic radiation receiver configured to
receive an electromagnetic wireless digital data signal from the handheld electronic apparatus, and
receive an electromagnetic wireless power signal from the electronic apparatus;
a memory device storing key access information;
a lock microcontroller configured to control operation of the lock mechanism based on the digital data signal from the electronic apparatus; and
a power management module configured to actuate the lock mechanism based on input received from the lock microcontroller and an electrical energy level of the electronic lock;
wherein the lock mechanism is capable of actuating between the locked state and the unlocked state without any electrical conductor power connection to the electronic lock, and
wherein the apparatus and/or optical light incident on the electromagnetic radiation receiver are the only sources of electric power for the electronic lock.

Example 14. The electronic lock of Example 13, wherein the digital data signal comprises a key identifier, and wherein lock microcontroller is further configured to determine whether the key identifier matches the key access information stored in the memory device.

Example 15. The electronic lock of Example 13, wherein the lock mechanism is capable of actuating between the locked state and the unlocked state with less than or equal to about 10 milliwatts and the electronic apparatus can be greater than 0.5 centimeters from the electronic lock when providing power.

Example 16. The electronic lock of Example 13, wherein the electronic lock does not have a mechanical configuration that is configured to match a mating mechanical configuration of the electronic apparatus.

Example 17. The electronic lock of Example 13, wherein the power management module is configured to actuate the lock after the electrical energy level of the electronic lock reaches an electrical energy level threshold.

Example 18. The electronic lock of Example 17, wherein the power management module is configured to increase the voltage to actuate the lock.

Example 19. The electronic lock of Example 18, wherein the power management module comprises a voltage conversion circuit that is configured to increase a voltage value that is not greater than 2.7 volts to a voltage value between 3.6 volts and 6.8 volts.

Example 20. The electronic lock of Example 13, wherein the electromagnetic radiation receiver comprises a photovoltaic cell configured to convert electromagnetic radiation to energy to power the lock microcontroller.

Example 21. The electronic lock of Example 13, wherein the electromagnetic radiation receiver comprises an electromagnetic radiation sensor and a signal processing circuit, wherein the signal processing circuit is configured to process digital data signal received from the electronic apparatus.

Example 22. The electronic lock of Example 13, wherein the electromagnetic radiation receiver comprises an antenna configured to receive radio frequency signals.

Example 23. The electronic lock of Example 22, wherein the antenna is configured to receive the digital data signal and the power signal from the electronic apparatus.

Example 24. The electronic lock of Example 23, wherein the antenna is configured to receive the power signal from the electronic apparatus via contactless inductive coupling.

Example 25. The electronic lock of Example 13, wherein the lock mechanism is configured to toggle between the locked state and the unlocked state based on a lock instruction received from the electronic apparatus.

Example 26. The electronic lock of Example 13, wherein the lock mechanism is configured to actuate from the locked state to the unlocked state for a defined time period before returning to the locked state.

Example 27. The electronic lock of Example 13, wherein the electromagnetic radiation receiver is not a photovoltaic cell.

Example 28. An method of locking or unlocking an electronic lock using a handheld electronic apparatus, the method comprising:
receiving, by an electromagnetic radiation receiver, electromagnetic radiation from the handheld electronic apparatus, wherein the electromagnetic radiation comprises a power signal configured to provide electric power to the electronic lock;
booting a lock microcontroller after an electrical energy level satisfies an electrical energy level threshold;
receiving, by the electromagnetic radiation receiver, electromagnetic radiation comprising a digital data signal from the electronic apparatus, the digital data signal comprising a key identifier;
determining, by the lock controller, whether the key identifier matches key access information stored in memory in the electronic lock;
storing power received from the electronic apparatus in an electric circuit in the electronic lock;
if the key identifier matches the key access information, actuating a lock mechanism when the stored power reaches an energy level threshold,
wherein the lock mechanism is configured to actuate between a locked state and an unlocked state.

Example 29. The method of Example 28, wherein the key access information is stored in memory in the electronic lock.

Example 30. The method of Example 28, wherein the electronic lock is capable of actuating the lock mechanism without the handheld electronic apparatus physically contacting the electronic lock.

### Group 4

Example 1. A smart lock comprising a lock clutch cylinder configured to be wirelessly controlled and wirelessly powered by an electronic access device, the lock clutch cylinder comprising:
a clutch rotatably coupled to a first knob;
a pin movably coupled to the first knob and configured to translate a rotational motion of the first knob in a first rotational direction to a rotational motion of the clutch in the first rotational direction, when maintained at an unlock position;
a barrier configured to move between a first position and a second position with respect to the pin and maintain the pin at the unlock position when moved to the second position;
an electric motor disposed inside the clutch and configured to control a position of the barrier with respect to the pin; and
an electronic control circuit configured to receive an unlocking wireless signal from electronic access device and in response to receiving the unlocking wireless signal, activate the electric motor to move the barrier from the first position to the second position;
wherein the electronic control circuit in configured to be wirelessly powered by an electronic access device; and
wherein the rotational motion of the clutch in the first rotational direction is decoupled from the rotational motion of the first knob in the first rotational direction, when the barrier is in the first position.

Example 2. The smart lock of Example 1, wherein the barrier is configured to maintain the pin at the unlock position by blocking a linear radial motion of the pin with respect to the lock clutch cylinder.

Example 3. The smart lock of Example 1, wherein the barrier is disposed inside the clutch and is connected to an output shaft of the electric motor.

Example 4. The smart lock of Example 1, wherein moving the barrier to the second position mechanically couples the first knob to the clutch so that the first knob rotates the clutch in the first rotational direction.

Example 5. The smart lock of Example 1, an electronic control circuit is configured to receive a locking wireless signal from the electronic access device and in response to receiving the locking wireless signal, activate the electric motor to move the barrier from the second position to the first position.

Example 6. The smart lock of Example 5, wherein moving the barrier to the first position decouples the rotational motion of the first knob from the clutch by allowing the pin to move in a radial direction with respect the lock clutch cylinder and slip under the clutch when the first knob is rotated in the first rotational direction.

Example 7. The smart lock of Example 1, wherein the clutch is connected to a clutch bar configured to move a locking element such that rotation of the clutch moves the locking element.

Example 8. The smart lock of Example 7, wherein the locking element comprises a deadbolt.

Example 9. The smart lock of Example 7, wherein the clutch is connected to a second knob by the clutch bar, wherein the second knob is configured to move the clutch between a locked position and unlocked position independent of a position of the barrier.

Example 10. The smart lock of Example 9, wherein the second knob is further configured to change a locking state of the lock clutch cylinder by moving the barrier between the first position and the second position.

Example 11. The smart lock of Example 1, wherein the clutch comprises a pin slot configured to allow coupling between a rotational motion of the pin and the rotational motion of the clutch.

Example 12. The smart lock of Example 11, wherein the pin slot comprises a circular slot having a first end having a right-angle end and a second end having a sloped end.

Example 13. The smart lock of Example 12, wherein the sloped end is configured to allow the rotational motion of the pin to be coupled to the rotational motion of the clutch in a first rotational direction when the barrier is at the second position, and prevent coupling between the rotational motion of the pin and the rotational motion of the clutch in a second direction opposite to the first rotational direction when the barrier is at the first position.

Example 14. The smart lock of Example 13, wherein the right-angle end is configured to allow rotational motion of the pin and to be coupled to the rotational motion of the clutch in the second direction independent of a position of the barrier.

Example 15. The smart lock of Example 1, wherein the electric motor is located inside the clutch.

Example 16. The smart lock of Example 1, wherein the smart lock is wirelessly powered using a near field communication (NFC) link.

Example 17. The smart lock of Example 1, further comprising a capacitor configured to be wirelessly charged by an electronic access device via NFC.

Example 18. The smart lock of Example 17, wherein the electronic control circuit receives electric power from the capacitor.

Example 19. The smart lock of Example 1, wherein the electronic control circuit is configured to communicate with the electronic access device via NFC, blue tooth or Wi-Fi.

Example 20. The smart lock of Example 1, wherein transmission of the unlocking wireless signal comprises a tapping action.

Example 21. The smart lock of Example 20, wherein the tapping action comprises moving the electronic access device closer than threshold distance from the lock clutch cylinder without opening an application or pressing a button on the electronic access device.

Example 22. The smart lock of Example 1, wherein the smart lock comprises a door lock, or a cabinet lock.

Example 23. The smart lock of Example 1, wherein the barrier comprises a curved protrusion configured to align the pin when the pin is in the second position.

Example 24. The smart lock of Example 1, wherein the barrier is positioned inside a barrier slot formed in a cylindrical portion the first knob, wherein the barrier slot is configured to allow movement of the barrier between the first position and the second position.

Example 25. The smart lock of Example 1, further comprising a button configured, where in a linear motion of the button rotates the clutch.

Example 26. The smart lock of Example 1, further comprising an antenna configured to receive the unlocking wireless signal form the electronic access device and wirelessly receive electric power from the electronic access device.

Example 27. The smart lock of Example 26, wherein the antenna comprises a coil.

Example 28. The smart lock of Example 26, wherein the antenna comprises a planar antenna.

Example 29. The smart lock of Example 28, wherein the planar antenna comprises a PCB antenna.

Example 30. The smart lock of Example 1, further comprising at least one conductive contact point configured to allow the electronic control circuit to receive power from the electronic access device.

Example 31. A padlock configured to be wirelessly powered and wirelessly controlled by an electronic access device, the padlock comprising:
a housing;
a shackle movably coupled to the housing, the shackle having a first end and a second end;
a latching element movably coupled to the housing, the latching element configured to be latched to the shackle to prevent an outward movement of the shackle with respect to the housing, when maintained at a lock position;
a barrier configured to move between a first position and a second position with respect to the latching element and maintain the latching element at the lock position when moved to the second position;
a motor configured to control a position of the barrier; and
an electronic control circuit configured to receive an unlocking wireless signal and in response to receiving the unlocking wireless signal, activate the motor to move the barrier from the second position to the first position;
wherein the electronic control circuit is configured to be wirelessly powered by the electronic access device; and
wherein an inward movement of the shackle toward the housing, latches the shackle to the latching element and moves the barrier from the first position to the second position.

Example 32. The padlock of Example 31, wherein the latching element is rotatably coupled to the housing and is configured to rotate between the lock position and an unlock position.

Example 33. The padlock of Example 32, wherein the latching element comprises a blocking section configured to be latched to the first end of the shackle when the latching element is rotated to the lock position.

Example 34. The padlock of Example 33, wherein barrier comprises a notch configured to block a rotational motion of the latching element when the barrier is at the second position.

Example 35. The padlock of Example 32, wherein the barrier comprises a return pin configured to be coupled to the second end of the shackle to rotate the barrier from the first position to the second position in response to the inward movement of the shackle toward the housing.

Example 36. The padlock of Example 31, wherein the barrier is configured to maintain the latching element at the lock position by blocking a rotation the latching element.

Example 37. The padlock of Example 32, wherein the motor is movably coupled to the housing to allow the motor to move with respect to the housing in response to a force exerted on the barrier by the latching element when the barrier is at the second position.

Example 38. The padlock of Example 31, wherein the latching element comprises a latching pin configured to linearly move with respect to the housing between an unlock position and the lock position.

Example 39. The padlock of Example 38, wherein the latching pin comprises a first end configured to be latched to the first end of the shackle when the latching pin is maintained in the lock position.

Example 40. The padlock of Example 38, wherein barrier comprises a blocking lever configured to block a second end of the latching pin, when rotated to the second position.

Example 41. The padlock of Example 40, wherein the blocking lever is configured to maintain the latching pin at the lock position by blocking a linear movement of the latching pin.

Example 42. The padlock of Example 40, further comprising a barrier return pin configured to be coupled to the second end of the shackle to rotate the blocking lever from the first position to the second position in response to the inward movement of the shackle toward the housing.

Example 43. The padlock of Example 38, wherein the motor is movably coupled to the housing to allow the motor to move along its shaft in response to a force exerted on the barrier by the latching pin when the barrier is at the second position.

Example 44. The padlock of Example 31, wherein the inward movement of the shackle toward the housing, comprises exerting mechanical force on the shackle by a user.

Example 45. The padlock of Example 31, wherein the shackle comprises a U-shape component.

Example 46. The padlock of Example 31, further comprising an antenna configured to receive wireless signals from the electronic access device and wirelessly receive electric power from the electronic access device.

Example 47. The padlock of Example 46, wherein the housing comprises an antenna housing configured to electromagnetically isolate the antenna from an electrically conductive portion of the housing, and wherein the antenna is disposed in the antenna housing.

Example 48. The padlock of Example 31, further comprising a capacitor configured to store power received from the electronic access device as charge.

Example 49. The padlock of Example 31, wherein the electronic control circuit is configured to be wirelessly powered by the electronic access device via a near filed communication (NFC) link.

Example 50. The padlock of Example 31, wherein the electronic control circuit is configured to communicate with the electronic access device via NFC, blue tooth or Wi-Fi.

Example 51. The padlock of Example 31, wherein the electronic control circuit is configured to be wirelessly powered and activate the motor in response to a tapping action performed by a user of the electronic access device.

Example 52. The padlock of Example 51, wherein the tapping action comprises moving the electronic access device closer than threshold distance from the padlock without opening an application or pressing a button on the electronic access device.

Example 53. A method of changing a locking state of a smart lock from an access state to a no access state, the smart lock comprising a motor, a barrier rotationally controlled by the motor, a locking pin configured to prevent access when maintained at a no access position, and a position sensor configured detect a position of the barrier with respect to the locking pin, the method comprising, by a processor of the smart lock:
receiving a wireless locking signal from an electronic access device;
in response to receiving the wireless locking signal, activating the position sensor to determine a first position of the barrier;
in response to determining that at the first position the barrier is not blocking the locking pin:
   rotating, using the motor, the barrier toward the locking pin by an initial rotation step;
   activating the position sensor to determine a second position of the barrier after the initial rotation step;
   in response to determining that at the second position the barrier is not blocking the locking pin, rotating, using the motor, the barrier toward the locking pin by at least one small rotation step;
   activating the position sensor to determine a third position of the barrier; and
   in response to determining that at the third position the barrier blocks the locking pin, turning on an LED or transmitting a lock indicator wireless signal to the electronic access device.

Example 54. The method of Example 53, wherein the initial rotation step is larger than the small rotation step.

Example 55. The method of Example 53, wherein activating the position sensor to determine the first, second, or third position of the barrier comprises:
receiving electric power from the electronic access device via a wireless power link to charge a capacitor;
using charge stored in the capacitor to activate the position sensor to generate a sensor signal;
determining a position of the barrier based on the sensor signal; and
deactivating the position sensor after determining the position of the barrier.

Example 56. the method of Example 53, wherein rotating, using the motor, the barrier toward the locking pin by an initial or small rotation step comprises:
receiving electric power from the electronic access device via a wireless power link to charge a capacitor; and
using charge stored on the capacitor to activate the motor to rotate the barrier toward the locking pin by the initial or small rotation step.

Example 57. A method of changing a locking state of a smart lock from an access state to a no access state, the smart lock comprising a motor, a worm access slider transitionally controlled by the motor, the worm access slider configured to prevent access when maintained at a no access position, and a position sensor configured detect a position of the worm access slider with respect to a locking element, the method comprising, by a processor of the smart lock:
receiving a wireless locking signal from an electronic access device;
in response to receiving the wireless locking signal, activating the position sensor to determine a first position of the worm access slider;
in response to determining that at the first position the worm access slider is not blocking the locking element:
   moving, using the motor, worm access slider toward the locking element by an initial translation step;
   activating the position sensor to determine a second position of worm access slider after the initial translation step;
   in response to determining that at the second position the worm access slider is not blocking the locking element, moving, using the motor, the worm access slider toward the locking element by at least one small translation step;
   activating the position sensor to determine a third position of the worm access slider; and
   in response to determining that at the third position the worm access slider blocks the locking element, turning on an LED or transmitting a lock indicator wireless signal to the electronic access device.

Example 58. The method of Example 57, wherein the initial translation step is larger than the small translation step.

Example 59. The method of Example 57, wherein activating the position sensor to determine the first, second, or the third position of the worm access slider comprises:
receiving electric power from the electronic access device via a wireless power link to charge a capacitor;
using charge stored in the capacitor to activate the position sensor to generate a sensor signal;
determining a position of the worm access slider based on the sensor signal; and
deactivating the position sensor after determining the position of the worm access slider.

Example 60. the method of Example 57, wherein moving, using the motor, the worm access slider toward the locking element by an initial or small translation step comprises:
receiving electric power from the electronic access device via a wireless power link to charge a capacitor; and
using charge stored on the capacitor to activate the motor to translate the worm access slider toward the locking element by the initial or small translation step.

Example 61. A smart lock comprising a locking cylinder configured to be wirelessly controlled and wirelessly powered by an electronic access device, the locking cylinder comprising:
a pin movably coupled to the locking cylinder and configured to prevent rotation of the locking cylinder with respect to a frame when maintained at a no access position;
a barrier rotatably coupled to the locking cylinder, the barrier configured to maintain a, when moved to a second position;
an electric motor placed inside the locking cylinder and configured to move the barrier between a first position and the second position to change a locking state of the locking cylinder between a no access state and an access state, respectively; and
an electronic control circuit configured to receive a wireless control signal from an electronic access device and activate the electric motor in response to receiving the wireless control signal to change the locking state of the locking cylinder;
wherein the electronic control circuit in configured to be wirelessly powered by the electronic access device.

Example 62. The smart lock of Example 61, wherein the barrier is configured to maintain the pin at the no access position by preventing radial motion of the pin with respect to the locking cylinder.

Example 63. The smart lock of Example 61, wherein at the locking cylinder is mechanically coupled to a knob configured to allow a user to rotate the locking cylinder with respect to the frame when the barrier is at the first position.

Example 64. The smart lock of Example 61, wherein the locking cylinder comprises a pin sub-cavity configured to allow the pin to move radially with respect to the locking cylinder and rotate in sync with the locking cylinder.

Example 65. The smart lock of Example 64, wherein pin hole the locking cylinder comprises a pin sub-cavity allow the pin to move radially with respect to the locking cylinder and rotate in sync with the locking cylinder.

Example 66. The smart lock of Example 61, wherein the locking cylinder is mechanically coupled to a locking element such that rotating the locking cylinder moves a locking element.

Example 67. The smart lock of Example 66, wherein the locking element comprises a deadbolt.

Example 68. The smart lock of Example 61, wherein the smart lock is wirelessly powered using a near field communication (NFC) link.

Example 69. The smart lock of Example 61, further comprising a capacitor configured to be wirelessly charged by an electronic access device via NFC.

Example 70. The smart lock of Example 69, wherein the electronic control circuit receives electric power from the capacitor.

Example 71. The smart lock of Example 61, wherein the electronic control circuit is configured to communicate with the electronic access device via NFC, blue tooth or Wi-Fi.

Example 72. The smart lock of Example 61, wherein receiving the wireless control signal comprises a tapping action.

Example 73. The smart lock of Example 72, wherein the tapping action comprises moving the electronic access device closer than threshold distance to the locking cylinder without opening an application or pressing a button on the electronic access device.

Example 74. The smart lock of Example 61, wherein the smart lock comprises a door lock, or a cabinet lock.

Example 75. The smart lock of Example 61, wherein the electric motor is coupled to the locking cylinder via at least one spring.

Example 76. The smart lock of Example 61, wherein the electric motor is coupled to the locking cylinder via at least one spring.

Example 77. The smart lock of Example 76, wherein the at least one spring comprises a spring leaf.

Example 78. The smart lock of Example 61, wherein the barrier is positioned inside a barrier slot formed inside the locking cylinder, wherein the barrier slot is configured to allow movement of the barrier between the first and second positions.

Example 79. The smart lock of Example 61, further comprising a button configured, where a linear motion of the button rotates the locking cylinder.

Example 80. The smart lock of Example 61, further comprising an antenna configured to receive the wireless control signal form the electronic access device and wirelessly receive electric power from the electronic access device.

Example 81. The smart lock of Example 80, wherein the antenna comprises a coil.

Example 82. The smart lock of Example 80, wherein the antenna comprises a planar antenna.

Example 83. The smart lock of Example 82, wherein the planar antenna comprises a PCB antenna.

Example 84. The smart lock of Example 61, further comprising a position sensor configured to generate a sensor signal indicative off a position of the barrier with respect to the pin.

Example 85. The smart lock of Example 84, wherein the electronic control circuit is configured to activate the electric motor based at least in part on the sensor signal.

Example 86. The smart lock of Example 85, wherein the position sensor comprises an opto-interrupter, a Hall sensor, or a contact sensor.

Example 87. The smart lock of Example 61, further comprising at least one conductive contact point configured to allow the electronic control circuit to receive power from the electronic access device.

Example 88. A smart lock comprising a locking cylinder configured to be wirelessly controlled and wirelessly powered by an electronic access device, the locking cylinder comprising:
a worm access slider configured to prevent motion of a locking element, when moved to a no access position;
an electric motor placed inside the locking cylinder and configured to move the worm access slider between a no access position and an access position to change a locking state of the locking cylinder between a no access state and an access state, respectively; and
an electronic control circuit configured to receive a wireless control signal from an electronic access device and activate the electric motor in response to receiving the wireless control signal to change the locking state of the locking cylinder;
wherein the electronic control circuit in configured to be wirelessly powered by an electronic access device.

Example 89. The smart lock of Example 88, further comprising an intermediate element configured to block the locking element when worm access slider is in the no access position.

Example 90. The smart lock of Example 89, wherein the intermediate element comprises a notch or slot configured to mate with a pin section of the worm access slider to block the locking element.

Example 91. The smart lock of Example 90, wherein the locking element can be moved by rotating the locking cylinder.

Example 92. The smart lock of Example 91, wherein the intermediate element comprises a locking pin movably coupled to the locking cylinder, the locking pin configured to prevent rotation of the locking cylinder with respect to a frame when maintained at first position.

Example 93. The smart lock of Example 92, wherein the pin section of the worm access slider is configured to maintain the locking pin at the first position when the worm access slider is at the no access position.

Example 94. The smart lock of Example 93, wherein the pin section of the worm access slider maintains the locking pin at the first position by preventing its radial movement with respect to the locking cylinder.

Example 95. The smart lock of Example 90, wherein the intermediate element comprises a knob connected to the locking element.

Example 96. The smart lock of Example 88, wherein the locking element comprises a deadbolt.

Example 97. The smart lock of Example 88, wherein the smart lock is wirelessly powered using a near field communication (NFC) link.

Example 98. The smart lock of Example 88, further comprising a capacitor configured to be wirelessly charged by an electronic access device via NFC.

Example 99. The smart lock of Example 98, wherein the electronic control circuit receives electric power from the capacitor.

Example 100. The smart lock of Example 88, wherein the electronic control circuit is configured to communicate with the electronic access device via NFC, blue tooth or Wi-Fi.

Example 101. The smart lock of Example 88, wherein receiving the wireless control signal comprises a tapping action.

Example 102. The smart lock of Example 101, wherein the tapping action comprises moving the electronic access device closer than threshold distance to the locking cylinder without opening an application or pressing a button on the electronic access device.

Example 103. The smart lock of Example 88, wherein the smart lock comprises a door lock, or a cabinet lock.

Example 104. The smart lock of Example 88, wherein the electric motor is coupled to the locking cylinder via at least one spring.

Example 105. The smart lock of Example 88, wherein the electric motor is coupled to the locking cylinder via at least one spring.

Example 106. The smart lock of Example 105, wherein the at least one spring comprises a spring leaf.

Example 107. The smart lock of Example 88, further comprising an antenna configured to receive the wireless control signal form the electronic access device and wirelessly receive electric power from the electronic access device.

Example 108. The smart lock of Example 107, wherein the antenna comprises a coil.

Example 109. The smart lock of Example 107, wherein the antenna comprises a planar antenna.

Example 110. The smart lock of Example 109, wherein the planar antenna comprises a PCB antenna.

Example 111. The smart lock of Example 88, further comprising at least one position sensor configured to generate a sensor signal indicative of a position of the worm access slider with respect to the electric motor.

Example 112. The smart lock of Example 111, wherein the electronic control circuit is configured to activate the electric motor based at least in part on the sensor signal.

Example 113. The smart lock of Example 106, comprising two position sensors configured to generate two sensor signals indicating that the worm access slider at the no access position or at the access position.

Example 114. The smart lock of Example 113, wherein the electronic control circuit is configured to activate the electric motor based at least in part on the two sensor signals.

Example 115. The smart lock of Example 111, wherein the at least one position sensor comprises an opto-interrupter, a Hall sensor, or a contact sensor.

Example 116. The smart lock of Example 113, wherein the two position sensors comprise an opto-interrupter, a Hall sensor, or a contact sensor.

### Terminology

The following description is merely illustrative in nature and is in no way intended to limit the disclosure, its application, or uses. For purposes of clarity, the same reference numbers will be used in the drawings to identify similar elements. It should be understood that operations within a method may be executed in a different order, or at least partially in parallel, without altering the principles of the present disclosure.

It is recognized that the term “module” may include software that is independently executable or standalone. A module can also include program code that is not independently executable. For example, a program code module may form at least a portion of an application program, at least a portion of a linked library, at least a portion of a software component, or at least a portion of a software service. Thus, a module may not be standalone but may depend on external program code or data in the course of typical operation.

Conditional language used herein, such as, among others, “can,” “might,” “may,” “for example,” and the like, unless specifically stated otherwise, or otherwise understood within the context as used, is generally intended to convey that certain embodiments include, while other embodiments do not include, certain features, elements or states. Thus, such conditional language is not generally intended to imply that features, elements or states are in any way required for one or more embodiments or that one or more embodiments necessarily include logic for deciding, with or without author input or prompting, whether these features, elements or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Although systems and methods of electronic access control are disclosed with reference to few various examples, other embodiments will be apparent to those of ordinary skill in the art from the disclosure herein. Moreover, the described embodiments have been presented by way of example only, and are not intended to limit the scope of the inventions. Rather, a skilled artisan will recognize from the disclosure herein a wide number of alternatives for the exact ordering of operations within disclosed processes, how an electronic key is implemented, how an electronic lock is implemented, or how an admin application is implemented. Other arrangements, configurations, and combinations of the embodiments disclosed herein will be apparent to a skilled artisan in view of the disclosure herein and are within the spirit and scope of the inventions as defined by the claims and their equivalents.

Additionally, other combinations, omissions, substitutions and modifications will be apparent to the skilled artisan in view of the disclosure herein. Accordingly, the present disclosure is not intended to be limited by the examples, but is to be defined by reference to the appended claims.

Additionally, all publications, patents, and patent applications mentioned in this specification are herein incorporated by reference to the same extent as if each individual publication, patent, or patent application was specifically and individually indicated to be incorporated by reference.

What is claimed is

1.-30. (canceled)

31. A padlock configured to be wirelessly controlled by an electronic access device, the padlock comprising:
a housing;
a shackle movably coupled to the housing, the shackle having a first end and a second end;
a latching element movably coupled to the housing, the latching element configured to be latched to the shackle to prevent an outward movement of the shackle with respect to the housing, when maintained at a lock position;
a barrier configured to move between a first position and a second position with respect to the latching element and maintain the latching element at the lock position when moved to the second position;
a motor configured to control a position of the barrier; and
an electronic control circuit configured to receive an unlocking wireless signal and in response to receiving the unlocking wireless signal, activate the motor to move the barrier from the second position to the first position;
and
wherein an inward movement of the shackle toward the housing or outward movement away from the housing, latches the shackle to the latching element and moves the barrier from the first position to the second position.

32. The padlock of claim 31, wherein the latching element is rotatably coupled to the housing and is configured to rotate between the lock position and an unlock position.

33. The padlock of claim 32, wherein the latching element comprises a blocking section configured to be latched to the first end of the shackle when the latching element is rotated to the lock position.

34. The padlock of claim 31, wherein the barrier comprises a notch configured to block a rotational motion of the latching element when the barrier is at the second position.

35. The padlock of claim 32, wherein the barrier comprises a return pin configured to be coupled to the second end of the shackle to rotate the barrier from the first position to the second position in response to the inward movement of the shackle toward the housing.

36. The padlock of claim 31, wherein the barrier is configured to maintain the latching element at the lock position by blocking a rotation the latching element.

37. (canceled)

38. The padlock of claim 31, wherein the latching element comprises a latching pin configured to linearly move with respect to the housing between an unlock position and the lock position.

39. The padlock of claim 38, wherein the latching pin comprises a first end configured to be latched to the first end of the shackle when the latching pin is maintained in the lock position.

40. The padlock of claim 38, wherein barrier comprises a blocking lever configured to block a second end of the latching pin, when rotated to the second position.

41. The padlock of claim 40, wherein the blocking lever is configured to maintain the latching pin at the lock position by blocking a linear movement of the latching pin.

42. The padlock of claim 40, further comprising a barrier return pin configured to be coupled to the second end of the shackle to rotate the blocking lever from the first position to the second position in response to the inward movement of the shackle toward the housing.

43. (canceled)

44. The padlock of claim 31, wherein the inward movement or the outward movement of the shackle, comprises exerting mechanical force on the shackle by a user.

45. (canceled)

46. The padlock of claim 31, further comprising an antenna configured to receive wireless signals from the electronic access device and wirelessly receive electric power from the electronic access device, wherein the electronic control circuit is configured to be wirelessly powered by the electronic access device.

47. (canceled)

48. The padlock of claim 31, further comprising a capacitor configured to store power received from the electronic access device as charge.

49. The padlock of claim 46, wherein the electronic control circuit is configured to be wirelessly powered by the electronic access device via a near filed communication (NFC) link.

50. The padlock of claim 31, wherein the electronic control circuit is configured to communicate with the electronic access device via NFC, blue tooth or Wi-Fi.

51. The padlock of claim 46, wherein the electronic control circuit is configured to be wirelessly powered and activate the motor in response to a tapping action performed by a user of the electronic access device.

52-116. (canceled)

117. The padlock of claim 32, wherein the barrier comprises a return pin configured to be coupled to the shackle to rotate the barrier from the first position to the second position in response to the outward movement of the shackle away the housing.
